(19) United States
(12) Patent Application Publication
(10) Pub. No.: US 2026/0116587 A1
(43) Pub. Date: Apr. 30, 2026

(54) GROUND CONDITION MONITORING AND ROUTE GENERATING SYSTEM

(71) Applicant: Oshkosh Corporation, Oshkosh, WI (US)

(72) Inventor: Prabhu Shankar, Oshkosh, WI (US)

(73) Assignee: Oshkosh Corporation, Oshkosh, WI (US)

(21) Appl. No.: 19/087,409

(22) Filed: Mar. 21, 2025

Related U.S. Application Data
(60) Provisional application No. 63/712,596, filed on Oct. 28, 2024.
(60) Provisional application No. 63/712,583, filed on Oct. 28, 2024.
(60) Provisional application No. 63/712,576, filed on Oct. 28, 2024.
(60) Provisional application No. 63/741,606, filed on Jan. 3, 2025.
(60) Provisional application No. 63/741,538, filed on Jan. 3, 2025.

(51) Int. Cl. B64U 10/10; B64U 101/31; G01C 21/34; G01C 21/36

(52) U.S. Cl. CPC B64U 10/10; G01C 21/3461; G01C 21/3647; B64U 2101/31; B64U 2201/202

(57) ABSTRACT

A system includes one or more processing circuits comprising one or more memory devices coupled to one or more processors. The one or more memory devices configured to store instructions thereon that, when executed by the one or more processors, cause the one or more processors to receive an input from a camera, the camera configured to facilitate surveying a work site, receive an external input indicating a desired location of a work machine on the work site, determine ground conditions of the work site based on at least the input from the camera, the ground conditions indicating at least one of a surface condition or an obstacle, determine a vehicle route from a current location of the work machine to the desired location based on the ground conditions, and generate a route map of the vehicle route defining the vehicle route and the ground conditions.

### CROSS-REFERENCE TO RELATED PATENT APPLICATION

This application claims the benefit of and priority to (a) U.S. Provisional Patent Application 63/712,583, filed on Oct. 28, 2024, (b) U.S. Provisional Patent Application 63/712,576, filed on Oct. 28, 2024, (c) U.S. Provisional Patent Application 63/712,596, filed on Oct. 28, 2024, (d) U.S. Provisional Patent Application 63/741,538, filed on Jan. 3, 2025, and (e) U.S. Provisional Patent Application 63/741,606, filed on Jan. 3, 2025, each of which is incorporated herein by reference in its entirety.

### BACKGROUND

The present disclosure relates generally to vehicles. More specifically, the present disclosure relates to vehicles that may be utilized at a jobsite or vocational vehicles.

Vehicles are utilized to transport personnel and equipment between different areas. Vehicles may utilize a drivetrain that consumes power from an onboard energy storage device to operate one or more tractive elements to propel the vehicle. The vehicles may include one or more sensors that facilitate navigation or other operation of the vehicles.

The present disclosure also relates generally to work machines. More specifically, the present disclosure relates to an interface between the work machine and an end effector supported by a work machine. End effectors my include various implements, such as tools (e.g., paint sprayers, pressure washers, welders, etc.), lift interfaces (e.g., hooks, forks, buckets, etc.), or other implements.

### SUMMARY

At least one embodiment relates to a system including one or more processing circuits comprising one or more memory devices coupled to one or more processors. The one or more memory devices configured to store instructions thereon that, when executed by the one or more processors, cause the one or more processors to receive an input from a camera, the camera configured to facilitate surveying a work site, receive an external input indicating a desired location of a work machine on the work site, determine ground conditions of the work site based on at least the input from the camera, the ground conditions indicating at least one of a surface condition or an obstacle, determine a vehicle route from a current location of the work machine to the desired location based on the ground conditions, and generate a route map of the vehicle route defining the vehicle route and the ground conditions

Another embodiment relates to a work machine including a chassis, a prime mover coupled to the chassis, an implement coupled to the chassis and driven by the prime mover, a sensor array structured to provide information indicative of operating conditions of a work machine, and a user interface including a display and one or more processing circuits comprising one or more memory devices coupled to one or more processors. The one or more memory devices configured to store instructions thereon that, when executed by the one or more processors, cause the one or more processors to receive an input from a camera, the camera configured to facilitate surveying a work site, receive an external input indicating a desired location of the work machine on the work site, determine ground conditions of the work site based on at least the input from the camera, the ground conditions indicating at least one of a surface condition or an obstacle, determine a vehicle route from a current location of the work machine to the desired location based on the ground conditions, and generate a route map of the vehicle route defining the vehicle route and the ground conditions.

Another embodiment relates to a work machine including a chassis, a prime mover coupled to the chassis, an implement coupled to the chassis and driven by the prime mover, a sensor array structured to provide information indicative of operating conditions of a work machine, at least one camera coupled to one of the chassis or a drone, and a user interface including a display and one or more processing circuits comprising one or more memory devices coupled to one or more processors. The one or more memory devices configured to store instructions thereon that, when executed by the one or more processors, cause the one or more processors to receive an input from the at least one camera, the at least one camera configured to facilitate surveying a work site, receive an external input indicating a desired location of the work machine on the work site, receive a sensor input from the sensor array, determine ground conditions of the work site based on at least one of the input from the at least one camera and the sensor input from the sensor array, the ground conditions indicating at least one of a surface condition or an obstacle, determine a vehicle route from a current location of the work machine to the desired location based on the ground conditions, and generate a route map of the vehicle route defining the vehicle route and the ground conditions.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a vehicle, according to an exemplary embodiment.

FIG. 2 is a block diagram of a system including the vehicle of FIG. 1, according to an exemplary embodiment.

FIG. 3 is a first top view of an area including the vehicles of FIG. 1 navigable between operating positions and chargers, according to an exemplary embodiment.

FIG. 4 is a second top view of an area including the vehicles of FIG. 1 navigable between operating positions and chargers, according to an exemplary embodiment.

FIG. 5 is a block diagram of a vehicle support module, according to an exemplary embodiment.

FIG. 6 is a top view of the vehicle of FIG. 1 supporting a plurality of the vehicle support modules of FIG. 5, according to an exemplary embodiment.

FIG. 7 is a side view of the vehicle of FIG. 1 supporting a plurality of the vehicle support modules of FIG. 5, according to an exemplary embodiment.

FIG. 8 is a top view of an area including the vehicles of FIG. 1 navigable around the area, according to an exemplary embodiment.

FIG. 9 is perspective view of a vehicle including a monitoring and route generating system according to an exemplary embodiment.

FIG. 10 is perspective view of the vehicle of FIG. 3 according to an exemplary embodiment.

FIG. 11 is an articulating boom lift including a monitoring and route generating system, according to some embodiments.

FIG. 12 is a telescoping boom lift including a monitoring and route generating system, according to some embodiments.

FIG. 13 is a compact crawler boom lift including a monitoring and route generating system, according to an exemplary embodiment.

FIG. 14 is a telehandler including a monitoring and route generating system, according to an exemplary embodiment.

FIG. 15 is a scissor lift including a monitoring and route generating system, according to an exemplary embodiment.

FIG. 16 is a toucan mast boom lift including a monitoring and route generating system, according to an exemplary embodiment.

FIG. 17 is an illustration of a user interface incorporated in any one of the vehicles of FIGS. 1-2 and 9-16, according to an exemplary embodiment.

FIG. 18 is a bock diagram of a controller incorporated in any one of the vehicles of FIGS. 1-2 and 9-16, according to an exemplary embodiment.

FIG. 19 is a flow chart of a method of using the monitoring and route generating system as shown in FIGS. 1-2 and 9-16, according to an exemplary embodiment.

FIG. 20 is flow chart of another method of using the monitoring and route generating system as shown in FIGS. 1-2 and 9-16, according to an exemplary embodiment.

FIG. 21 is an illustration of a route map generated by the monitoring and route generating system as shown in FIGS. 1-2 and 9-16, according to an exemplary embodiment.

FIG. 22 is a block diagram of a lift device, according to an exemplary embodiment.

FIG. 23 is a perspective view of the lift device of FIG. 22 configured as a boom lift, according to an exemplary embodiment.

FIG. 24 is a side view of an implement assembly and an implement interface of the lift device of FIG. 22, according to an exemplary embodiment.

FIG. 25 is a front view of the implement interface of FIG. 24.

FIG. 26 is a rear view of the implement assembly of FIG. 24.

FIG. 27 is a block diagram of a method of operating a lift device, according to an exemplary embodiment.

FIG. 28 is a side view of operating ranges of the lift device of FIG. 22.

FIG. 29 is a block diagram of a method of operating a lift device, according to an exemplary embodiment.

FIG. 30 is a diagram of an autonomous jobsite control system, according to an exemplary embodiment.

FIG. 31 is a diagram of a storage area for autonomous mobile robots, materials, end effectors, tools, and supplies of the autonomous jobsite control system of FIG. 30, according to an exemplary embodiment.

FIG. 32 is a block diagram of the autonomous jobsite control system of FIG. 30, according to an exemplary embodiment.

FIG. 33 is a flow diagram of a method for autonomously managing and preparing worksites using autonomous mobile robots, according to an exemplary embodiment.

FIG. 34 is a diagram of a worksite including scannable visual indicators physically positioned at various locations at the worksite, according to an exemplary embodiment.

FIG. 35 is a flow diagram of a method for autonomously managing and preparing worksites using autonomous mobile robots and scannable visual indicators, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle

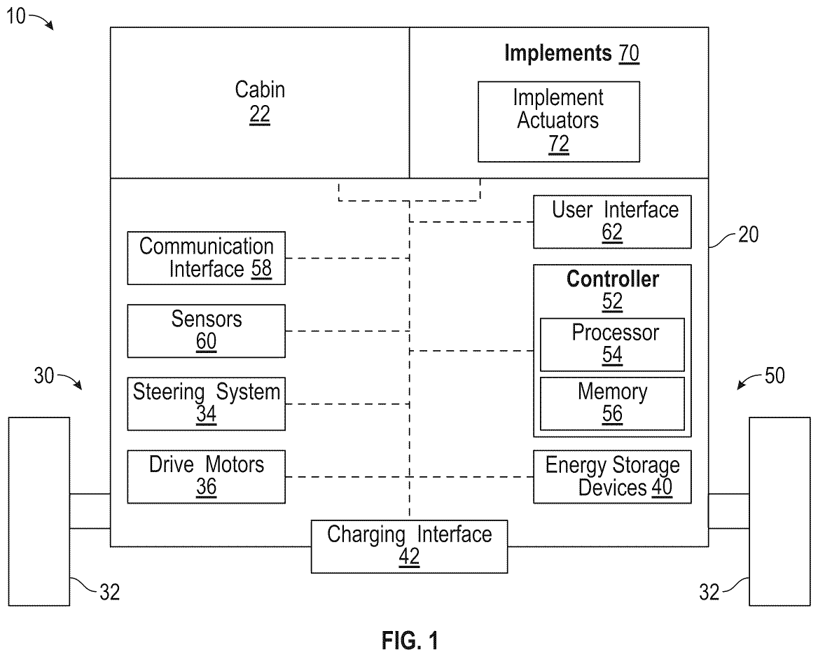

Referring to FIG. 1, a vehicle (e.g., a vocational vehicle, a work machine, etc.), is shown as vehicle 10 according to an exemplary embodiment. By way of example, the vehicle 10 may be a lift device, such as a boom lift, a telehandler, an aerial work platform, a scissor lift, a vertical lift, a compact crawler boom, a forklift, a crane, a bucket truck, or another type of lift device. In other embodiments, the vehicle 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, a robot, or another type of vehicle or work machine.

The vehicle 10 includes a frame assembly, housing, or chassis, shown as chassis 20, that supports the other components of the vehicle 10. The chassis 20 may include one or more components (e.g., frame members, housings, etc.) coupled to one another to form the chassis 20. The chassis 20 supports an enclosure, shown as cabin 22, that is configured to house one or more operators of the vehicle 10. The cabin may include one or more doors to facilitate access to the cabin 22.

The vehicle 10 further includes drivetrain or propulsion system, shown as a drivetrain 30, that is configured to propel the vehicle 10. The drivetrain 30 includes one or more tractive elements (e.g., wheel and tire assemblies, tracked assemblies, etc.), shown as wheels 32, rotatably coupled to the chassis 20. The wheels 32 are configured to engage a support surface (e.g., the ground) to support the vehicle 10. The vehicle 10 further includes one or more steering assemblies, shown as steering system 34, coupled to the chassis 20. The steering system 34 is configured to steer or otherwise control a direction of motion of the vehicle 10 (e.g., in response to a command from an operator of the vehicle 10). By way of example, the steering system 34 may include an actuator that pivots one or more of the wheels 32 relative to the chassis 20.

The drivetrain 30 includes one or more actuators, drive motors, or prime movers, shown as drive motors 36, coupled to the chassis 20. In some embodiments, the drive motors 36 include one or more electric motors (e.g., AC motors, DC motors, etc.). In some embodiments, the drive motors 36 include one or more internal combustion engines (e.g., gasoline engines, diesel engines, etc.). In some embodiments, the drive motors 36 include one or more internal combustion engines and one or more electric motors (e.g., forming a hybrid drivetrain). The drive motors 36 are configured to drive one or more of the wheels 32 to propel the vehicle 10. The drive motors 36 may be directly coupled to the wheels 32 and/or indirectly coupled to the wheels 32 (e.g., through a geared transmission, through a hydrostatic transmission, etc.).

The vehicle 10 further includes one or more energy storage devices (e.g., batteries, fuel tanks, etc.), shown as energy storage devices 40, coupled to the chassis 20. The energy storage devices 40 may store energy to power the systems of the vehicle 10 (e.g., the drive motors 36).

The energy storage devices 40 may include batteries, fuel cells, fuel tanks, or other types of energy storage devices 40.

The vehicle 10 further includes an energy transfer interface, shown as charging interface 42, coupled to the chassis 20. The charging interface 42 is configured to transfer electrical energy into and/or out of the vehicle 10 (e.g., between the vehicle 10 and an electrical grid, a generator, etc.). The charging interface 42 may supply electrical energy to charge the energy storage devices 40. In some embodiments, the charging interface 42 transfers energy wirelessly. In such embodiments, the charging interface 42 may include a wireless energy transfer coil to transfer energy through induction. In some embodiments, the charging interface 42 is configured to transfer electrical energy through a wired connection. In such embodiments, the charging interface 42 may include a set of electrical contacts positioned to engage a set of external electrical contacts. In other embodiments, the charging interface 42 is omitted. In some embodiments, the charging interface 42 is additionally or alternatively configured to receive a fluid (e.g., water, hydraulic oil, fuel, etc.) and/or mechanical energy (e.g., torque from a spinning shaft).

The vehicle 10 further includes a control system 50 including a controller 3052 that controls operation of the vehicle 10. The controller 3052 includes a processing circuit, shown as processor 54, and a memory device, shown as memory 56. The memory 56 may contain one or more instructions that, when executed by the processor 54, cause the controller 3052 to perform the processes described herein. While some processes may be described as being performed by the controller 3052, it should be understood that those processes may be performed by any other controller of the system 100 or distributed across multiple controllers of the system 100. The controller 3052 may control the drive motors 36 and the steering system 34 to navigate the vehicle 10. In some embodiments, the controller 3052 navigates in response to commands from an operator. In some embodiments, the controller 3052 navigates the vehicle 10 autonomously (e.g., without any directional control by an operator).

The control system 50 further includes a network interface, shown as communication interface 58, operatively coupled to the controller 3052. The communication interface 58 is configured to transfer data between the vehicle 10 and other components of the system 100 (e.g., other vehicles 10, the user devices 102, the servers 104, the network 110, etc.). The communication interface 58 may facilitate wired and/or wireless communication.

The control system 50 further includes one or more sensors 60 operatively coupled to the controller 3052. The sensors 60 may include one or more location or environment sensors such as one or more accelerometers, gyroscopes, compasses, position sensors (e.g., global positioning system (GPS) sensors, etc.), inertial measurement units (“IMU”), suspension sensors, wheel sensors, audio sensors or microphones, cameras, optical sensors, proximity detection sensors, and/or other sensors to facilitate acquiring vehicle information or vehicle data regarding operation of the vehicle 10 and/or the location thereof. In some embodiments, the sensors 60 provide sensor data relating to the vehicle 10 (e.g., a current status of the vehicle 10) and the components thereof. In some embodiments, the sensors 60 provide sensor data relating to the surroundings of the vehicle 10 (e.g., detecting nearby objects, detecting a slope of the support surface, etc.). The data acquired by the sensors 60 may be used (e.g., by the control system 50) to facilitate autonomous or semi-autonomous operation of the vehicle 10 (e.g., autonomous or semi-autonomous navigation and driving) and the components thereof (e.g., autonomous or semi-autonomous operation of the drivetrain 30, the energy storage devices 40, the implements 70, etc.).

The control system 50 further includes a user interface or operator interface, shown as user interface 62, operatively coupled to the controller 3052. The user interface 62 may include one or more output devices (e.g., displays, speakers, haptic feedback devices, lights, projectors, etc.). In some embodiments, the user interface 62 includes one or more input devices (e.g., buttons, touch screens, microphones, knobs, levers, etc.). The user interface 62 may extend within the cabin 22 to facilitate control over the vehicle 10 by an operator positioned within the cabin 22.

The vehicle 10 further includes one or more implement assemblies or end effectors, shown as implements 70. The implements 70 may be utilized by the vehicle 10 interact with the surrounding environment. By way of example, an implement 70 may include a lift assembly such as a boom or a scissor lift. By way of another example, an implement 70 may include lift forks or a grabber to engage or otherwise support an object from the surrounding environment.

The implements 70 may include one or more actuators, shown as implement actuators 72, that facilitate movement of the implements 70. By way of example, the implement actuators 72 may include rotary actuators, such as electric motors or hydraulic motors. By way of another example, the implement actuators 72 may include linear actuators such as hydraulic cylinders or electric linear actuators. The implement actuators 72 may be operatively coupled to the controller 3052 to permit the controller 3052 to control operation of the implements 70 by moving the implement actuators 72.

### Vehicle System

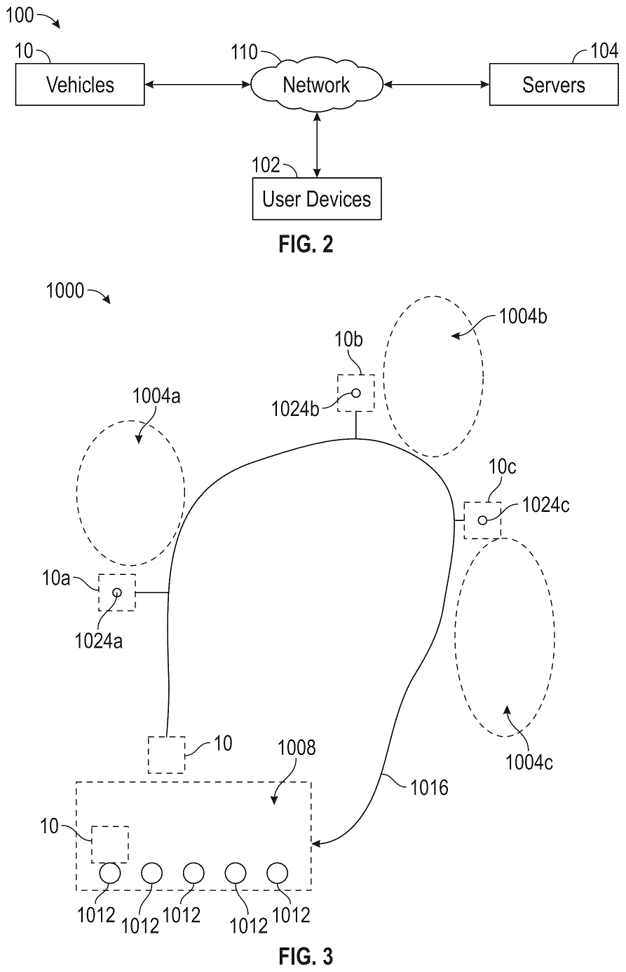

Referring to FIG. 2, the vehicle 10 is part of a vehicle system, work machine system, or jobsite system, shown as system 100, according to an exemplary embodiment. The system 100 may include one or more of the vehicles 10. As shown, the system 100 further includes one or more user interfaces or user devices (e.g., smartphones, tables, laptop computers, desktop computers, pagers, smart speakers, AI assistants, etc.), shown as user devices 102. The user devices 102 facilitate communication between one or more users and the system 100. By way of example, a user may provide a command, such as a command for the vehicle 10 to move to a specific location, through the user device 102. By way of another example, the system 100 may communicate the current location of a vehicle 10 to a user through the user devices 102.

The system 100 further includes one or more cloud devices, storage devices, databases, or vehicle managers, shown as servers 104 (e.g., cloud servers, cloud devices, cloud controllers, etc.). The servers 104 may store and/or process data to facilitate operation of the system 100. The servers 104 may store data and manage the flow of information throughout the system 100. By way of example, the servers 104 may track (e.g., retrieve and store) the current locations of the vehicles 10, the current statuses of the vehicles 10, information regarding authorized users of the system 100, or other information.

The components of the system 100 (e.g., the vehicles 10, the user devices 102, and/or the servers 104) may communicate with one another directly and/or across a network 110 (e.g., a cellular network, the Internet, etc.). In some embodiments, the components of the system 100 communicate wirelessly. By way of example, the system 100 may utilize a cellular network, Bluetooth, near field communication (NFC), infrared communication, radio, or other types of wireless communication. In other embodiments, the system 100 utilizes wired communication.

### Autonomous Navigation to Operating Position

Referring generally to the figures, a plurality of vehicles are configured to operate around an area such as a construction site to perform a variety of tasks. The area may include one or more sub-zones such as operation zones where the vehicles are configured to perform the tasks and staging areas where the vehicles may be stored or parked. The staging area may include chargers configured to supply electrical energy to the vehicles to charge energy storage devices onboard the vehicles. Each of the vehicles may be associated with an operating position (e.g., a location and an orientation). The operating position may include information regarding the location and orientation of the vehicle prior to the end of the day (e.g., end of the hours of operation, end of the work day, end of a shift, etc.) or the start of a break. By way of example, at the end of the day, the operator controlling the vehicle may shutdown the vehicle, and the operating position may be the last operating location and orientation of the vehicle prior to the vehicle shutting down. The vehicle is configured to autonomously or semi-autonomously travel along a route between a first, starting position (e.g., the location of the vehicle while being charged by the charger at the staging area) and a second, ending position (e.g., the operating position). In some embodiments, the vehicles navigate between the starting position and the operating position in a leader-follower manner, such that follower vehicles are organized behind a leader operator or a leader vehicle. As the leader operator or leader vehicle navigates along the rout throughout the area, the follower vehicles follow, and when the operator presses a button or the follower vehicles sense their respective operating positions, they leave queue and navigate to their respective operating positions. In some embodiments, the vehicles autonomously navigate to their respective operating positions prior to the start of the day or the end of the break without following the leader operator or leader vehicle. In yet other embodiments, an operator at the area or remote from the area can request (e.g., via a user device) a vehicle. The request may include the type of vehicle, capabilities of the vehicle, a requested time of arrival, etc. In response to receiving the request, a vehicle matching (e.g., satisfying) the request navigates to a location associated with the request (e.g., to a location of the user device making the request, to a location input into the user device, etc.). By navigating between the operating position and the staging area, the system of the present disclosure facilitates ensuring that the vehicles are charged at the beginning of the day (e.g., at the start of the shift) and are positioned at the same operating position as when the operator left the vehicle.

It should be understood that any of the functions or processes described herein with respect to the system 100 may be performed by the control system 50 and/or the servers 104. By way of example, data collection may be performed by the control system 50 and data analytics may be performed by the servers 104. By way of another example, data collection may be performed by the control system 50, a first portion of data analytics may be performed by the control system 50, and a second portion of data analytics may be performed by the servers 104. By way of still another example, a first portion of data collection may be performed by the control system 50, a second portion of data collection may be performed by the servers 104, and data analytics may be performed by the control system 50 and/or the servers 104.

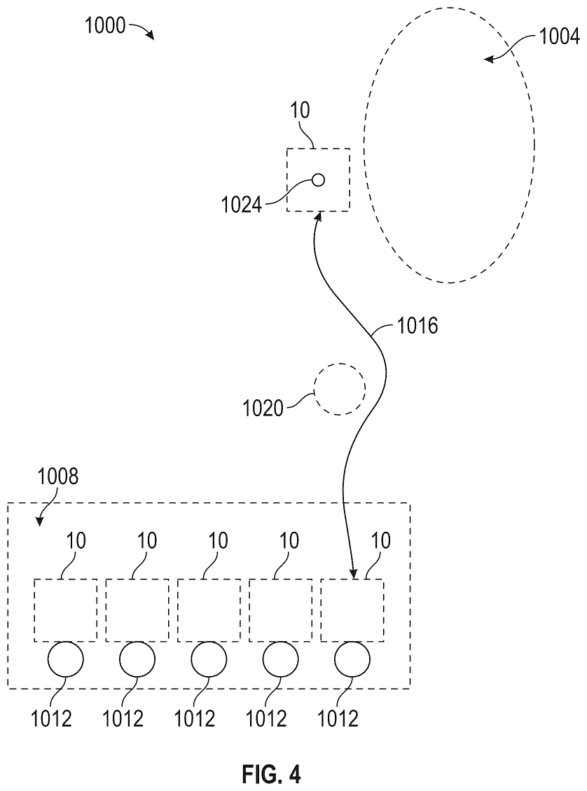

As shown in FIGS. 3 and 4, the vehicles 10 are configured to be driven around an operation zone, shown as area 1000. The vehicles 10 may be driven by an operator (e.g., a construction worker), semi-autonomously, or autonomously within and/or around the area 1000 to be used to perform one or more tasks and to be stored or parked (e.g., for charging or refueling, for maintenance, etc.). The area 1000 includes a work site, a construction site, a production area, etc., including a first sub-zone, shown as operation zone 1004, and a second sub-zone, shown as staging area 1008. The operation zone 1004 may include an excavation zone, a loading/unloading zone, a waste disposal area, an assembly zone, a demolition area, among other areas where the vehicles 10 typically operate at to perform a task. As shown in FIG. 3, the area 1000 includes a first operation zone 1004a, a second operation zone 1004b, and a third operation zone 1004c. While shown as including the first operation zone 1004a, the second operation zone 1004b, and the third operation zone 1004c, it should be understood that any number of operation zones 1004 may be variously located throughout the area 1000. The staging area 1008 may include a space for storing or parking the vehicles 10 while they are not in operation (e.g., outside of hours of operation for the area 1000, during charging operations, etc.). In some embodiments, the staging area 1008 includes an area to store materials (e.g., lumbar, concrete, pipes, beams, prefabricated components, etc.), establish a field office (e.g., a temporary building for administrative tasks), and/or establish quarters (e.g., a rest area for workers at the area 1000). In some embodiments, the staging area 1008 is remote from the area 1000. By way of example, the staging area 1008 may include a rental area (e.g., from where the vehicles 10 are rented). In some embodiments, the staging area 1008 includes an area where the vehicles 10 are initially delivered to the area 1000. While shown as including a single the staging area 1008, it should be understood that any number of staging areas 1008 may be variously located throughout the area 1000.

As shown in FIGS. 3 and 4, the staging area 1008 includes one or more charging stations, shown as chargers 1012, configured to charge the vehicles 10. In some embodiments, the chargers 1012 are otherwise variously located or positioned throughout the area 1000. The chargers 1012 may include an external power source, such as a battery bank, a generator, or a connection to a power grid. The charging interface 42 is configured to communicate with the charger 1012 (e.g., via a wireless connection or via a wired connection) to transfer electrical energy between the vehicle 10 and the charger 1012. The charger 1012 may transfer electrical energy from the external power source to the vehicle 10 (e.g., to charge the energy storage devices 40, to power one or more functions of the vehicle 10, etc.).

According to an exemplary embodiment, the vehicles 10 are configured to start (e.g., at the start of the work day, at the beginning of the hours of operation, etc.) at the staging area 1008 (or other locations where the chargers 1012 are located), navigate to one or more operation zones 1004 to perform one or more tasks, and return to the staging area 1008 (or other locations where the chargers 1012 are located) at the end of the day (e.g., at the end of the work day, at the end of the hours of operation, etc.) to be charged by the chargers 1012. The chargers 1012 may transfer electrical energy to the vehicles 10 (e.g., via the charging interfaces 42) to charge the energy storage devices 40 (e.g., to full charging capacity) before the start of the work day. In some embodiments, the vehicles 10 are configured to navigate to the staging area 1008 prior to the end of the day to be charged by the chargers 1012 (e.g., if the energy storage devices 40 have a low or depleted charge, if the operator goes on a break, etc.).

As shown in FIGS. 3 and 4, the vehicles 10 are configured to navigate between the operation zone 1004 (e.g., between the first operation zone 1004a, the second operation zone 1004b, and the third operation zone 1004c) and the staging area 1008 along a pathway (e.g., common route, main route, track, line, etc.), shown as route 1016. The vehicles 10 may be configured to follow or otherwise drive along the route 1016. In embodiments where the vehicle 10 is manually controlled by the operator, the operator provides an input to the steering system 34 to steer the vehicles 10 to follow the route 1016. By way of example, the route 1016 may be displayed on the user interface 62 and/or the user devices 102 (e.g., overlayed on a map of the area 1000) for the operator to view the route 1016. In other embodiments, the vehicle 10 is configured to autonomously follow or drive along the route 1016.

The route 1016 may extend throughout the area 1000 between the staging area 1008 and the operation zone 1004. By way of example, the route 1016 may extend from the staging area 1008 (e.g., the route 1016 may start at an exit of the staging area 1008, at the one or more chargers 1012, etc.), past (e.g., around, adjacent to, etc.) each operation zone 1004, and return to (e.g., terminate at) the staging area 1008 (e.g., an entrance of the staging area 1008, the one or more chargers 1012, etc.). In other words, the route 1016 may entirely encircle, partially encircle, define a portion along a front, back, and/or side of, etc. the operation zone 1004, the staging area 1008, and/or any other portion of the area 1000. The route 1016 may be established based on the nature of the area 1000. By way of example, the route 1016 may be established based on the number of operation zones 1004, the location of the operation zones 1004 (e.g., such that the route 1016 is established adjacent to each operation zone 1004), the location of the chargers 1012 (e.g., such that the route 1016 is established adjacent to or terminates at a respective charger 1012), the location of the staging area 1008, an operating position (e.g., the operating position 1024, a location and orientation of the vehicle 10 at the end of the day or start of a break, etc.) of the vehicle 10, among other factors among other factors or characteristics of the area 1000. The route 1016 may be stored by the memory 56 and/or the servers 104 and a signal associated with the route 1016 may be transmitted to the vehicles 10.

In some embodiments, the route 1016 is selected from a plurality of predetermined routes. By way of example, the operator may select one of the predetermined routes. By way of another example, the controller 3052 may automatically select a predetermined route based on one or more aspects of the area 1000. The predetermined route may be a route previously used by one of the vehicles 10 or provided to a vehicle 10 from another vehicle 10. The plurality of predetermined routes may include routes of different shapes, lengths, travel times, allowable vehicle dimensions, driving surfaces, different types (i.e., emergency site, construction site, etc.), for different types of vehicle 10 (e.g., boom lift, telehandler, firefighting vehicle, refuse truck, etc.) or other routes.

In some embodiments, the route 1016 is established based on the information acquired by the sensors 60. By way of example, the controller 3052 may utilize location data collected by the sensors 60 to establish the route 1016 based on GPS coordinates, geographical landmarks, or any other location data. By way of another example, the controller 3052 may use environment data collected by the sensors 60 to establish the route 1016 based on detected obstacles (e.g., pedestrians, workers, equipment, hazards, etc.), the detected location of the operation zones 1004, the detected location of the staging areas 1008 and the chargers 1012, the topography of the area 1000, markings in the area 1000 (e.g., boundaries painted on the ground), or any other environment data.

As shown in FIG. 4, the area 1000 includes areas or objects that should not be driven on, in, or around by the vehicles 10. By way of example, these areas may include active construction zones, holes, trenches, private property, etc., and these objects may include pedestrians, workers, equipment, hazards (e.g., water hazards), trees, bushes, other vehicles 10 (e.g., vehicles 10 being charged by the chargers 1012, disabled or parked vehicles 10, etc.), etc. Driving on, in, or around these areas and objects by the vehicle 10 may damage the vehicle 10, damage the area 1000, be dangerous for an operator of the vehicle 10, be illegal (e.g., trespassing on private property), etc. Collectively, these areas and objects are hereinafter referred to as hazards 1020. The controller 3052 may be configured to analyze data acquired by the sensors 60 to determine a travel path (e.g., dynamically adjust the route 1016) and transmit commands based on the data to avoid collisions with the hazard 1020. In some embodiments, the controller 3052 is configured to transmit a command to the user interface 62 and/or the user devices 102 to display or otherwise provide an indication of the hazard 1020 (e.g., a location of the hazard 1020) such that the operator controlling the vehicle 10 can steer the vehicle 10 to avoid the hazard 1020.

In some embodiments, the route 1016 is manually created (e.g., established, defined, drawn, mapped, determined, set, programmed, etc.) by the operator. By way of example, the operator may provide an input to the user interface 62 or the user devices 102 of a desired path along which the vehicles 10 are configured to navigate (e.g., autonomously navigate). By way of another example, the operator may provide an input indicating the locations of the chargers 1012, the staging area 1008, and the operation zone 1004, and the route 1016 may be automatically generated based on these locations. By way of yet another example, the operator may drive a first vehicle 10 (e.g., a leader vehicle) along a desired route, and the sensors 60 may record the location of the vehicle 10 to establish the route 1016. By way of still another example, the operator may walk with a user device 102 along a desired route and provide inputs to the user device 102 that records a present (e.g., real-time) location of the user device 102 to establish the route 1016. The route 1016 may be stored as a series of waypoints or a continuous route (e.g., by the memory 56 and/or the servers 104) and transmitted to one or more second vehicles 10 (e.g., autonomous follower vehicles) to follow autonomously. The operator defined route 1016 may be a unique path, along which the vehicles 10 navigate, that is established (e.g., mapped) to adjacent to the operation zones 1004. In other embodiments, the route 1016 is manually selected from a plurality of predetermined preexisting routes by the operator.

As shown in FIG. 3, the vehicles 10 are configured to navigate along the route 1016 and leave the route 1016 to navigate to a respective position (e.g., leave the common route and navigate to the respective location, shown as operating position 1024, along or adjacent to the route 1016. By way of example, the vehicles 10 may navigate along a common route and leave the common route to navigate along a respective sub-route (e.g., a route extending off of the common route, a route extending at least partially along the common route, an offshoot route, a secondary route, etc.) to a respective operating position 1024. The operating position 1024 may include or be indicative of (i) information relating to the location of the vehicle 10 (e.g., GPS coordinates) relative to a respective operation zone 1004 and (ii) information relating to the orientation of the vehicle 10 (e.g., a heading of the vehicle 10) and/or the components thereof (e.g., a length of extension/retraction of the implement actuators 72, a position of the implements 70, an orientation of the chassis 20, etc.). In some embodiments, the operating position 1024 includes a pitch or angle of the vehicle 10 relative to the ground surface. The operating position 1024 may be determined by the controller 52 and/or the servers 104 based on data acquired by the sensors 60 and stored by the memory 56 and/or the servers 104. The operating position 1024 may be located adjacent to and outside of the operation zone 1004 or located within the operation zone 1004. In some embodiments, the operating position 1024 is the last operating position and orientation of the vehicle 10 prior to the vehicle 10 shutting down (e.g., at the time of the vehicle 10 being shutdown). By way of example, at the end of the day or the start of a break, the operator may shutdown the vehicle 10 and the memory 56 and/or the servers 104 may store the position and orientation of the vehicle 10 at the time of the shutdown and store the information as the operating position 1024. In such an example, when the vehicle 10 powers back on (e.g., at the start of the next day, after a break, etc.), the vehicle 10 may return (e.g., autonomously) to the operating position 1024 such that, when the operator returns to the vehicle 10, the vehicle 10 is in the same position and orientation as when the operator shut the vehicle 10 down (e.g., the forks of a forklift are in the same position and orientation, the platform of a scissor lift is at the same height, etc.).

As shown in FIG. 3, the route 1016 is established adjacent to the first operation zone 1004a, the second operation zone 1004b, and the third operation zone 1004c. In embodiments where the area 1000 includes more operation zones 1004 than the first operation zone 1004a, the second operation zone 1004b, and the third operation zone 1004c, the route 1016 is established adjacent to the additional operation zones 1004. As shown in FIG. 3, a first vehicle 10a is associated with and positioned and oriented at a first operating position 1024a adjacent to the first operation zone 1004a, a second vehicle 10b is associated with and positioned and oriented at a second operating position 1024b adjacent to the second operation zone 1004b, and a third vehicle 10c is associated with and positioned and oriented at a third operating position 1024c adjacent to the third operation zone 1004c.

In some embodiments, the vehicles 10 (e.g., the first vehicle 10a, the second vehicle 10b, and the third vehicle 10c, etc.) are configured to navigate along the route 1016 to their respective operating positions 1024 associated therewith in a leader-follower manner. As shown in FIG. 3, a leader vehicle 10 is leaving the staging area 1008 and traveling along the route 1016. The leader vehicle 10 may be autonomously driven along the route 1016 or manually driven by an operator. As the leader vehicle 10 navigates along the route 1016, the first vehicle 10a, the second vehicle 10b, and the third vehicle 10c are configured to follow (e.g., autonomously follow) the leader vehicle 10. The vehicles 10 configured to follow the leader vehicle 10 (e.g., the first vehicle 10a, the second vehicle 10b, and the third vehicle 10c following the leader vehicle 10) may be hereinafter referred to as the follower vehicles 10.

The follower vehicles 10 may follow the leader vehicle 10 in a queue (e.g., in a line) behind the leader vehicle 10 as the leader vehicle 10 navigates along the route 1016. In some embodiments, the leader vehicle 10 communicates the real-time position, speed, and trajectory thereof to the follower vehicles 10 such that the follower vehicles 10 follow the leader vehicle 10. In various embodiments, a mesh network of vehicles 10 (e.g., the leader vehicle 10 and the follower vehicles 10) communicates messages using one of various routing techniques where data, information, or commands are propagated through the mesh network, such as a unicast method (message propagated to a single, specific vehicle 10), a multicast method (message propagated to a subset of the vehicles 10), a broadcast method (message propagated to all of the vehicles 10), or an anycast method (message propagated to the nearest vehicle 10). Communicating in the mesh network arrangement, the vehicles 10 are configured to send and receive one or more signals associated with various commands, data, or information relating to the coordination of the vehicles 10 (e.g., navigation coordination of the leader vehicle 10 and the follower vehicles 10) along the route 1016. In such embodiments, the leader vehicle 10 can transmit a signal to any one or more follower vehicles 10 and any one or more follower vehicles 10 can transmit a signal to any other one or more follower vehicles 10 to coordinate movement along the route 1016 (e.g., to avoid the vehicles 10 colliding into each other). By way of example, the follower vehicles 10 may maintain a substantially fixed distance between other follower vehicles 10 and the leader vehicle 10 as the vehicles 10 navigate along the route 1016. In such examples, the controller 3052 of the follower vehicles 10 may control (e.g., autonomously in real time) operation of the follower vehicles 10 to correspondingly accelerate, decelerate, change directions, etc., as the leader vehicle 10 accelerates, decelerates, or changes directions. By way of another example, the controller 3052 may control operation of the follower vehicles 10 to deviate from the route 1016 (e.g., deviate from following the follower vehicle 10) in response to detecting a hazard 1020 along the route 1016 to avoid the hazard 1020 (e.g., even if the leader vehicle 10 did not encounter the hazard 1020). In various embodiments, the mesh network includes the vehicle 10, the user devices 102, the servers 104, and/or other vehicles or assets. In some embodiments, the follower vehicles 10 use data associated with the route 1016 to follow along the route 1016 (e.g., in addition to or as an alternative to detecting and following the movements of the leader vehicle 10).

According to an exemplary embodiment, as the leader vehicle 10 navigates along the route 1016 and navigates by (e.g., adjacent to, past, etc.) the operating positions 1024 associated with the follower vehicles 10, the follower vehicles 10 leave the queue (e.g., stop following the leader vehicle 10, leave the route 1016, leave the common route, etc.) and navigate to the respective operating positions 1024 thereof (e.g., along the sub-route). As shown in FIG. 3, the leader vehicle 10 leaves the staging area 1008 (e.g., from charging at the charger 1012) and navigates along the route 1016. The first vehicle 10a, the second vehicle 10b, and the third vehicle 10c (e.g., located at the staging area 1008, charging at the chargers 1012, etc.) are configured to follow the leader vehicle 10 responsive to a command (e.g., based on detecting via the sensors 60 that the leader vehicle 10 has left the staging area 1008, based on an input by the operator of the leader vehicle 10, etc.). As the leader vehicle 10 and the follower vehicles 10 navigate along the route 1016, the follower vehicles 10 leave the route 1016 and navigate to their respective operating positions 1024. In some embodiments, the follower vehicles 10 are configured to detect respective operating positions 1024 associated therewith based on data acquire from the sensors 60. In other embodiments, the follower vehicles 10 are configured to navigate to respective operating positions 1024 associated therewith responsive to the operator of the leader vehicle 10 providing an input commanding a respective follower vehicle 10 to navigate to a respective operating position 1024. By way of example, as the leader vehicle 10 navigates past (i) the first operating position 1024a, the first vehicle 10a navigates to the first operating position 1024a, (ii) the second operating position 1024b, the second vehicle 10b navigates to the second operating position 1024b, and (iii) the third operating position 1024c, the third vehicle 10c navigates to the third operating position 1024c.

In some embodiments, the third vehicle 10c (e.g., the vehicle 10 associated with the last operating position 1024 along the route 1016, the vehicle 10 associated with the farthest operating position 1024 from the starting location along the route 1016, etc.) is the leader vehicle 10 such that that first vehicle 10a and the second vehicle 10b follow the third vehicle 10c. In such embodiments, the third operating position 1024c is, sequentially, the last operating position 1024 of a group of operating positions 1024 including the first operating position 1024a, the second operating position 1024b, and the third operating position 1024c along the route 1016. In some embodiments, an operator walks along the route 1016 with a user device 102 and the follower vehicles 10 are configured to follow the user device 102 and navigate to their respective operating positions 1024 as the operator and the user device 102 navigate past the respective operating positions 1024.

The process discussed above with respect to deploying the vehicles 10 to their respective operating positions 1024 may be performed in reverse to return the vehicles 10 to the staging area 1008 to be charged by the chargers 1012 (e.g., at the end of the day, at the start of a break, etc.) or to load the vehicles 10 onto a trailer (e.g., to be transported off of the area 1000). The leader vehicle 10 may navigate along the route 1016 (driving past the operation zones 1004 and the vehicles 10 positioned at the operating position 1024) and the follower vehicles 10 may leave the operating positions 1024 to follow the leader vehicle 10 along the route 1016. In some embodiments, the follower vehicles 10 are configured to leave the operating positions 1024 to follow the leader vehicle 10 (i) based on detecting via the sensors 60 that the leader vehicle 10 is navigating past the follower vehicles 10 and/or (ii) based on an input by the operator of the leader vehicle 10 commanding the follower vehicles 10 to follow the leader vehicle 10.

In some embodiments, the vehicles 10 are configured to autonomously navigate to the operating positions 1024 associated therewith without following a leader vehicle 10. By way of example, the vehicles 10 may automatically (e.g., without an input from an operator, at the end of the work day, etc.) (i) record its operating position 1024, (ii) navigate to the staging area 1008 to charge at the chargers 1012, and (iii) after charging, return to the recorded operating position 1024 automatically (e.g., without an input from an operator, at the beginning of the work day, etc.). In such examples, from the perspective of the operator, the vehicle 10 they were controlling is in the same position and orientation as when they left the vehicle 10 (but has been charged or otherwise refueled). In some embodiments, one or more of the vehicles 10 travels along a different route 1016 to navigate between the chargers 1012 and the respective operating positions 1024. By way of example, a first vehicle 10 may travel along a first route 1016 in a first direction (e.g., to navigate between the chargers 1012 and the respective operating positions 1024) and a second vehicle 10 may travel along a second route 1016 in a second direction different than the first direction. By way of another example, the vehicles 10 may travel along a route 1016 that is the shortest distance (e.g., a straight line, the shortest distance without colliding with or entering the hazard 1020, etc.) between a first, starting location (e.g., the staging area 1008, the chargers 1012, a home location, etc.) and a second, ending location (e.g., the operating position 1024).

According to an exemplary embodiment, a first vehicle 10 associated with a respective operating position 1024 leaves the respective operating position 1024 to navigate to the staging area 1008 to charge after the end of the day or at the start of a break, for example. In such an embodiment, a second vehicle 10 of the same type or having the same or similar functionality (e.g., similar capabilities) as the first vehicle 10 is configured navigate to the respective operating position 1024 (e.g., prior to the start of the next day, prior to the end of the break, etc.). By way of example, a first boom lift may leave the respective operating position 1024 at the end of the day and a second boom lift may navigate to the respective operating position 1024 prior to the start of the next day such that an operator can use the second boom lift in a similar manner (e.g., to perform the same task) as the operator used the first boom lift.

According to an exemplary embodiment, the vehicles 10 (e.g., the first vehicle 10a, the second vehicle 10b, and the third vehicle 10c, etc.) are configured to navigate (e.g., autonomously navigate) along the route 1016 to respective (e.g., desired, programmed, commanded, intended, etc.) operating positions 1024 associated therewith responsive to receiving a signal (e.g., a command from the controller 52, from the servers 104, etc.) to navigate to the respective operating positions 1024. In some embodiments, an operator provides an input to the user device 102 to provide a request for a vehicle 10. By way of example, the request may include (e.g., specify) a type of vehicle such as a lift device, such as a boom lift, a telehandler, an aerial work platform, a scissor lift, a vertical lift, a compact crawler boom, a forklift, a crane, a bucket truck, or another type of lift device, a military vehicle, a cement truck, a refuse vehicle, a fire apparatus, a tow truck, a robot, or another type of vehicle or work machine. By way of another example, the request may include vehicle capabilities such as lifting capabilities (e.g., capable of being performed by a lift device), emergency response capabilities (e.g., capable of being performed by a fire apparatus, an emergency response vehicle, etc.), towing capabilities (e.g., a vehicle 10 having a specified tow capacity, etc.), among other vehicle capabilities. In response to receiving a signal indicative of the request, a vehicle 10 matching the request (e.g., a vehicle 10 matching a type of vehicle specified in the request, a vehicle 10 matching the capabilities of the capabilities specified in the request, etc.) may navigate to a location (e.g., an operating position 1024) associated with the request. In some embodiments, the location includes a real-time location of the user device 102 that provided the request such that the vehicle 10 navigates to the location of the user device 102. In other embodiments, the user inputs a location (e.g., inputs a specific operation zone 1004, staging area 1008, charger 1012, operating position 1024, inputs GPS coordinates, etc.) with the request such that the vehicle 10 navigates to the location specified by the user. By way of example, the user may provide a request for a vehicle 10 with lifting capabilities at the second operation zone 1004b, and, responsive to receiving the request, a vehicle 10 with lifting capabilities may navigate to the second operation zone 1004b (e.g., to a specified operating position 1024 at the second operation zone 1004b). In some embodiments, the request includes a time (e.g., a desired time) for the vehicle 10 to arrive at the location associated with the request. By way of example, the request may specify that the vehicle 10 arrive at the location associated with the request at noon. By way of another example, the operator may generate a schedule including time slots during which a vehicle 10 is commanded to arrive at the location associated with the request. By way of example, the operator may schedule a bucket truck to arrive at the third operation zone 1004c at 8:00 AM for loading and to depart by 9:00 AM (e.g., return to the staging area 1008 by 9:00 AM).

### Autonomous Power Delivery Systems

Referring generally to the figures, a plurality of vehicles are configured to operate around an area such as a construction site to perform a variety of tasks. The area may include one or more sub-zones such as operation zones where the vehicles are configured to perform the tasks and staging areas where the vehicles may be stored or parked. The staging area may include chargers configured to supply electrical energy to the vehicles to charge energy storage devices or supply fuel to refuel energy storage devices onboard the vehicles. The vehicles may include a transport vehicle configured to support one or more vehicle support modules and transport the vehicle support modules throughout the area. The vehicle support modules may be portable (e.g., by the transport vehicle by drivelines of the charging modules, etc.) and configured to electrically, fluidly, and/or mechanically couple with the vehicles (e.g., such as a work vehicle) to charge, refuel, or supply fluid or mechanical power to the work vehicle. The transport vehicles may include an implement configured to engage with the vehicle support module to move the vehicle support module to a position and orientation relative to the work vehicle. In some embodiments, the vehicle support module is configured to autonomously navigate to the position and orientation adjacent to the work vehicle. The vehicle support module may be delivered (e.g., autonomously, by the transport vehicle, etc.) to the position and orientation such that the vehicle support module is within a range (e.g., a wireless range, a range of a wired connection, etc.) of the work vehicle to charge the work vehicle. In this manner, the vehicle support modules are configured to charge the work vehicles while the work vehicles are not in operation (e.g., after the operator controlling the work vehicle has left the area for the day or for a break) without having to navigate the work vehicles to an area (e.g., a staging area including a charger) to be charged.

### Vehicle Support System

It should be understood that any of the functions or processes described herein with respect to the vehicle control system 100 may be performed by the control system 50 and/or the servers 104. By way of example, data collection may be performed by the control system 50 and data analytics may be performed by the servers 104. By way of another example, data collection may be performed by the control system 50, a first portion of data analytics may be performed by the control system 50, and a second portion of data analytics may be performed by the servers 104. By way of still another example, a first portion of data collection may be performed by the control system 50, a second portion of data collection may be performed by the servers 104, and data analytics may be performed by the control system 50 and/or the servers 104.

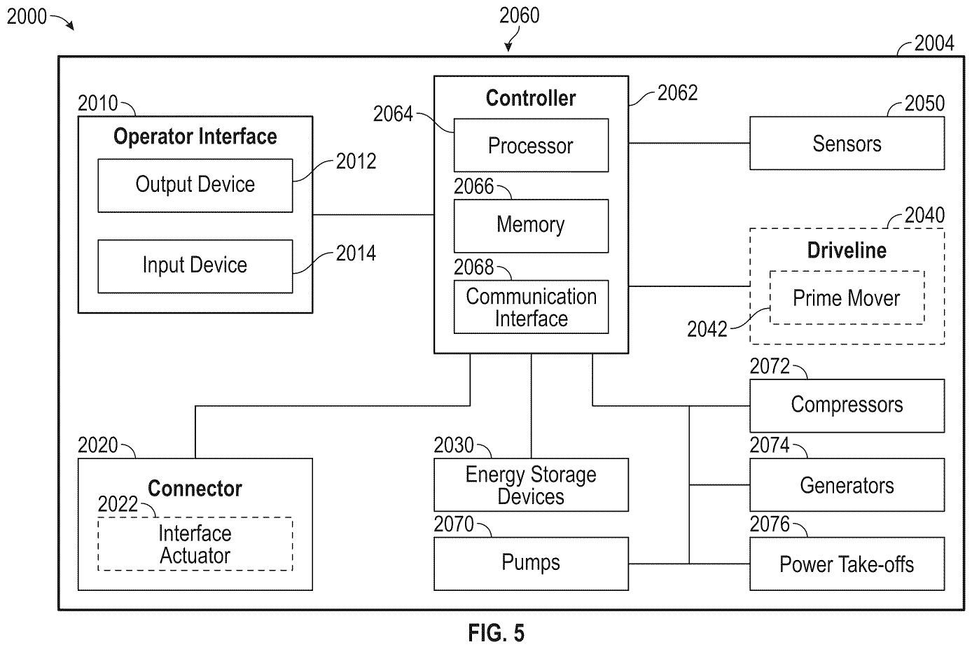

Referring to FIG. 5, a charger (e.g., charging banks, batteries, fuel cells, generators, etc.), energy supply module, charging module, auxiliary power unit, refueler, external pump, support vehicle, or power take-off module, is shown as vehicle support module 2000. The vehicle support module 2000 includes a housing (e.g., chassis, frame, casing, etc.), shown as body 2004; operator input and output devices, shown as operator interface 2010; an energy transfer interface, charging interface, connector, or connection, shown as connector 2020; one or more energy storage devices (e.g., batteries, fuel tanks, fuel cells, etc.), shown as energy storage devices 2030; a drivetrain, shown as driveline 2040; one or more sensors 2050; and a control system, shown as control system 2060, coupled with the operator interface 2010, the connector 2020, the energy storage devices 2030, the driveline 2040, and the sensors 2050. The vehicle support module 2000 may include one or more pumps 2070 (e.g., hydraulic oil pumps, water pumps, etc.), compressors 2072, generators 2074, and/or power take-offs 2076 (e.g., output shafts). In some embodiments, the vehicle support module 2000 omits the driveline 2040. In some embodiments, the vehicle support module 2000 includes more or fewer components.

According to an exemplary embodiment, the vehicle support modules 2000 are configured to electrically, fluidly, and/or mechanically couple (e.g., via a connection between the connector 2020 and the charging interface 42 or another part of the vehicle 10) with one or more vehicles 10 (e.g., work machines operating at a jobsite). The vehicle support module 2000 may supply electrical energy or fuel to power the vehicles 10 (e.g., to charge the energy storage devices 40 thereof), may provide a flow of a fluid (e.g., hydraulic oil, water, compressed air, etc.) to the vehicles 10, and/or may provide a mechanical power take-off to the vehicles 10.

The operator interface 2010 may be configured to provide an operator with the ability to control one or more functions of and/or provide commands to the vehicle support module 2000 and the components thereof (e.g., turn on, turn off, engage various operating modes, actuate an implement, etc.). As shown in FIG. 5, the operator interface 2010 includes one or more output devices 2012 and one or more input devices 2014. The output devices 2012 may include one or more displays such as a touchscreen, a LCD display, a LED display, gauges, warning lights, etc. The input devices 2014 may be or include buttons, switches, knobs, levers, dials, etc.

The connector 2020 may be configured to transfer energy (e.g., electrical energy, fluid power, rotational mechanical energy, etc.) into and/or out of the vehicle support module 2000 (e.g., between the vehicle support module 2000 and an electrical grid, a generator, a vehicle 10, etc.). The connector 2020 may receive electrical energy from an outside source and supply the electrical energy to charge the energy storage devices 2030. Additionally or alternatively, the connector 2020 may supply electrical energy (e.g., from the energy storage devices 2030 and/or the generators 2074) to the vehicles 10. In some embodiments, the connector 2020 transfers energy wirelessly. In such embodiments, the connector 2020 may include a wireless energy transfer coil to transfer energy through induction. In some embodiments, the connector 2020 is configured to transfer electrical energy through a wired connection. In such embodiments, the connector 2020 may include a set of electrical contacts positioned to engage a set of external electrical contacts (e.g., the charging interface 42). The connector 2020 may provide a fluid coupling and transfer fluid (e.g., hydraulic oil, water, fuel, compressed air, etc.) between the vehicle support module 2000 (e.g., the pumps 2070 and the compressors 2072) and the vehicles 10. The connector 2020 may provide a mechanical coupling and transfer mechanical energy (e.g., rotation of a shaft) between the vehicle support module 2000 and the vehicles 10.

As shown in FIG. 5, the connector 2020 includes one or more actuators, shown as interface actuator 2022, that facilitate movement of the connector 2020. By way of example, the interface actuator 2022 may include rotary actuators, such as electric motors or hydraulic motors. By way of another example, the interface actuator 2022 may include linear actuators such as hydraulic cylinders or electric linear actuators. By way of example, the interface actuator 2022 may function as a robotic arm that permits adjustment of the position and the orientation of the connector 2020 relative to the body 2004. The interface actuator 2022 may be operatively coupled to the control system 2060 to permit the control system 2060 to control operation of the connector 2020 by moving the interface actuator 2022. In some embodiments, the vehicle support module 2000 omits the interface actuator 2022.

The energy storage devices 2030 may store energy to power the systems of the vehicle support module 2000 and the vehicles 10. The energy storage devices 2030 may store and supply electrical energy. By way of example, the energy storage devices 2030 may include batteries, capacitors, or fuel cells. The energy storage devices 2030 may include one or more fuel tanks that store fuel (e.g., gasoline, diesel fuel, hydrogen, kerosene, etc.) that is consumed (e.g., in an engine) to provide other types of energy. The fuel may be consumed within the vehicle support module 2000 (e.g., by the driveline 2040, the generators 2074, and/or the power take-offs 2076), or the fuel may be supplied from the energy storage devices 2030 to a vehicle 10 to refuel the vehicle 10.

According to an exemplary embodiment, the driveline 2040 is configured to propel the vehicle support module 2000. The driveline 2040 includes one or more tractive elements (e.g., wheel and tire assemblies, tracked assemblies, etc.) rotatably coupled to the body 2004. The tractive elements are configured to engage a support surface (e.g., the ground) to support the vehicle support module 2000. The vehicle support module 2000 further includes one or more steering assemblies configured to steer or otherwise control a direction of motion of the charging module. By way of example, the steering assembly may include an actuator that pivots one or more of the tractive elements relative to the body 2004.

The driveline 2040 includes one or more actuators, drive motors, or prime movers, shown as prime movers 2042, coupled to the body 2004. In some embodiments, the prime movers 2042 include one or more electric motors (e.g., AC motors, DC motors, etc.). In some embodiments, the prime movers 2042 include one or more internal combustion engines (e.g., gasoline engines, diesel engines, etc.). In some embodiments, the prime movers 2042 include one or more internal combustion engines and one or more electric motors (e.g., forming a hybrid drivetrain). The prime movers 2042 are configured to drive one or more of the tractive elements to propel the vehicle support module 2000. The prime movers 2042 may be directly coupled to the tractive elements and/or indirectly coupled to the tractive elements (e.g., through a geared transmission, through a hydrostatic transmission, etc. In some embodiments, the vehicle support module 2000 omits the driveline 2040.

The sensors 2050 may include one or more location or environment sensors such as one or more accelerometers, gyroscopes, compasses, position sensors (e.g., global positioning system (GPS) sensors, etc.), inertial measurement units (“IMU”), suspension sensors, wheel sensors, audio sensors or microphones, cameras, optical sensors, proximity detection sensors, and/or other sensors to facilitate acquiring information or data regarding operation of the vehicle support module 2000 and/or the location thereof. In some embodiments, the sensors 60 provide sensor data relating to the vehicle support module 2000 (e.g., a current status of the vehicle support module 2000, a charge level of the vehicle support module 2000, etc.) and the components thereof. In some embodiments, the sensors 60 provide sensor data relating to the vehicle 10 (e.g., a charge level of the vehicle 10, etc.). In some embodiments, the sensors 60 provide sensor data relating to the surroundings of the vehicle support module 2000 (e.g., detecting nearby objects, detecting a slope of the support surface, etc.). The data acquired by the sensors 60 may be used (e.g., by the control system 2060) to facilitate autonomous or semi-autonomous operation of the vehicle support module 2000 (e.g., autonomous or semi-autonomous navigation and driving) and the components thereof (e.g., autonomous or semi-autonomous operation of the interface actuator 2022, the energy storage devices 2030, the driveline 2040, etc.).

According to an exemplary embodiments, the control system 2060 includes a controller 2062 that controls operation of the vehicle support module 2000. The controller 2062 includes a processing circuit, shown as processor 2064, and a memory device, shown as memory 2066. The memory 2066 may contain one or more instructions that, when executed by the processor 2064, cause the controller 2062 to perform the processes described herein. While some processes may be described as being performed by the controller 2062, it should be understood that those processes may be performed by any other controller of the system 100 and/or the control system 2060 or distributed across multiple controllers of the system 100 and/or the control system 2060. The controller 2062 may control the operator interface 2010, the connector 2020, the energy storage devices 2030, the driveline 2040 to navigate the vehicle support module 2000 autonomously (e.g., without any directional control by an operator).

The control system 2060 further includes a network interface, shown as communication interface 2068, operatively coupled to the controller 2062. The communication interface 2068 is configured to transfer data between the vehicle support module 2000 and other components of the system 100 (e.g., other vehicle support modules 2000, other vehicles 10, the user devices 102, the servers 104, the network 110, etc.). The communication interface 2068 may facilitate wired and/or wireless communication.

Referring still to FIG. 5, the pumps 2070 may provide a flow of pressurized fluid. The pumps 2070 may supply water, fuel, hydraulic oil, or other liquids. By way of example, a pump 2070 may include an electric motor to drive the pump 2070. The pumps 2070 may provide fluid flow within the vehicle support module 2000 (e.g., to supply liquid fuel to a generator 2074). Additionally or alternatively, the pumps 2070 may provide fluid flow to a vehicle 10. By way of example, the pumps 2070 may supply a flow of pressurized water that is discharged by a nozzle of a vehicle 10. By way of another example, the pumps 2070 may provide a flow of pressurized hydraulic oil that powers one or more actuators of a vehicle 10. By way of another example, the pumps 2070 may provide a flow of pressurized fuel to transfer the fuel to a vehicle 10.

The compressors 2072 may provide a flow of pressurized fluid. The compressors 2072 may supply compressed air, hydrogen, or other gases. By way of example, a compressor 2072 may include an electric motor to drive the compressor 2072. The compressors 2072 may provide fluid flow within the vehicle support module 2000 (e.g., to supply gaseous fuel to a generator 2074). Additionally or alternatively, the compressors 2072 may provide fluid flow to a vehicle 10. By way of example, the compressors 2072 may supply a flow of compressed air that is discharged by a nozzle of a vehicle 10 or that powers one or more actuators of a vehicle 10.

The generators 2074 may convert rotational mechanical energy to electrical energy. By way of example, a generator 2074 may include an internal combustion engine that receives fuel from the energy storage devices 2030. The engine may consume the fuel to drive the generator 2074 and provide the electrical energy. By way of another example, a generator 2074 may be driven by the driveline 2040 or by a power take-off 2076.

The power take-offs 2076 may transfer mechanical energy (e.g., rotational mechanical energy) between the vehicle support module 2000 and a vehicle 10. By way of example, a power take-off may include a shaft that rotates and transfers torque to a vehicle 10. The power take-offs may be driven by engines, electric motors, hydraulic motors, or other systems of the vehicle support module 2000. Beneficially, the power take-offs 2076 may be used to drive one or more components (e.g., an implement) of the vehicles 10.

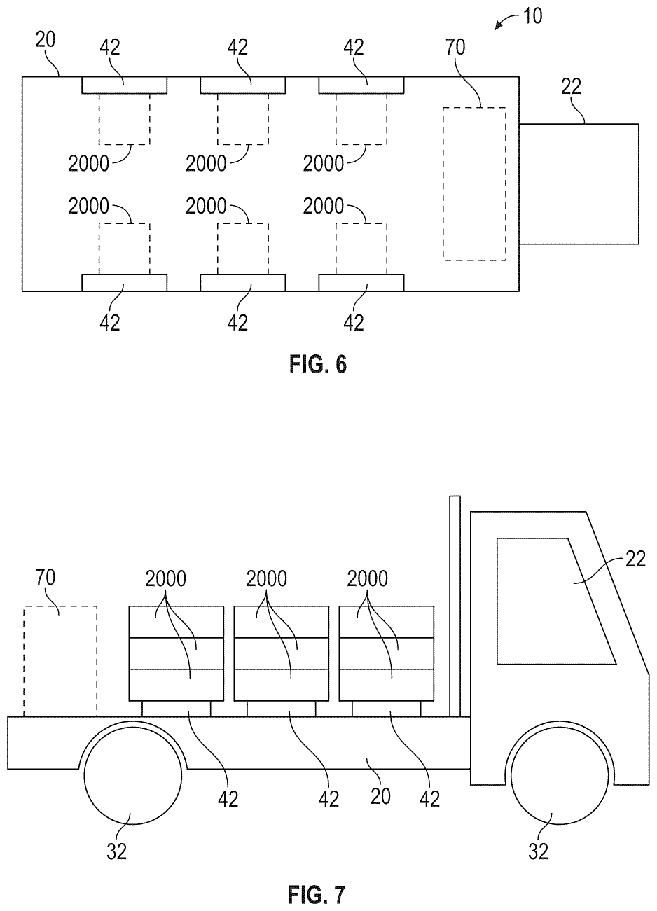

As shown in FIGS. 6 and 7, a vehicle 10 is configured to support and transport one or more vehicle support modules 2000 (e.g., in embodiments where the vehicle support modules 2000 do not include the driveline 2040). The vehicle support modules 2000 are configured to electrically couple (e.g., via the charging interface 42) with one or more vehicles 10 (e.g., work machines operating at a jobsite) and supply electrical energy to the vehicles 10 to charge the energy storage devices 40 thereof. In some embodiments, the vehicle support modules 2000 transfer energy wirelessly. In such embodiments, the vehicle support modules 2000 may include a wireless energy transfer coil to transfer energy through induction. In some embodiments, the vehicle support modules 2000 are configured to transfer electrical energy through a wired connection. In such embodiments, the vehicle support modules 2000 may include a set of electrical contacts positioned to engage a set of external electrical contacts. The vehicle support modules 2000 are configured to store electrical energy (e.g., using the energy storage devices 2030, in a battery, in a fuel cell, etc.) and/or generate electrical energy (e.g., without a connection to an external power source) such that the vehicle support modules 2000 are portable (e.g., by the vehicle 10) and repositionable. The connectors 2020 of the vehicle support modules 2000 may additionally or alternatively transfer pressurized fluid (e.g., hydraulic oil, pressurized water, compressed air, etc.), fuel, and/or rotational mechanical energy between the vehicle support modules 2000 and the vehicles 10. The vehicle 10 configured to support and transport the one or more vehicle support modules 2000 may hereinafter be referred to as the transport vehicle 10, and the one or more vehicles 10 (e.g., work machines operating at a jobsite) configured to be charged by the vehicle support modules 2000 may hereinafter be referred to as the work vehicles 10.

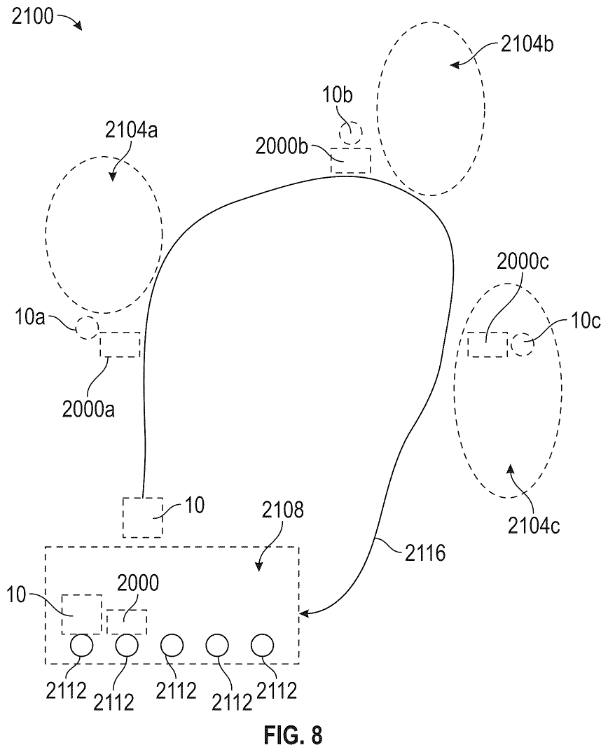

As shown in FIGS. 6 and 7, the transport vehicle 10 is configured as a truck, such as a flatbed truck, capable of transporting a plurality of vehicle support modules 2000. In some embodiments, the transport vehicle 10 is coupled with a trailer configured to support one or more of the vehicle support modules 2000. In other embodiments, the transport vehicle 10 is another type of vehicle capable of transporting a plurality of vehicle support modules 2000. As shown in FIG. 8, the vehicle support modules 2000 are supported by the chassis 20 (e.g., by a support surface coupled with the chassis 20) and positioned adjacent to other vehicle support modules 2000. In some embodiments, the transport vehicle 10 is configured to support and transport more or fewer vehicle support modules 2000 than shown in FIG. 8. As shown in FIG. 7, the vehicle support modules 2000 are stacked on top of each other and supported by the transport vehicle 10. The transport vehicle 10 may be configured to support and transport more than one stack of vehicle support modules 2000. In some embodiments, the stacks of vehicle support modules 2000 include more or fewer vehicle support modules 2000 than shown in FIG. 7. In some embodiments, the transport vehicle 10 is configured to support and transport more or fewer stacks of vehicle support modules 2000 than shown in FIG. 7.

As shown in FIGS. 6 and 7, the charging interfaces 42 of the transport vehicle 10 are configured to supply electrical energy to the vehicle support modules 2000 to charge the vehicle support modules 2000. In some embodiments, the charging interfaces 42 electrically couple with the connectors 2020 of the vehicle support modules 2000 and are configured to transfer energy wirelessly. In some embodiments, the charging interfaces 42 electrically couple with the vehicle support modules 2000 and are configured to transfer electrical energy through a wired connection. In some embodiments, the transport vehicle 10 distributes electrical energy stored in the energy storage devices 40 thereof or generated by the drive motors 36 to the vehicle support modules 2000 as the transport vehicle 10 navigates around a jobsite. In some embodiments, the transport vehicle 10 is configured to electrically couple with an external power source (e.g., the chargers 2112, battery bank, generator, a connection to a power grid, etc.) to receive electrically energy therefrom and distribute the electrical energy to the vehicle support modules 2000 electrically coupled with the transport vehicle 10 to charge the vehicle support modules 2000. In some embodiments, the vehicle support modules 2000 are configured to electrically couple with other vehicle support modules 2000 to supply electrically energy thereto (e.g., redistribute electrical energy received from the transport vehicle 10). By way of example, a first vehicle support module 2000 stacked on top of and electrically coupled with a second vehicle support module 2000 may receive electrical energy from the second vehicle support module 2000. Additionally or alternatively, the connectors 2020 of the vehicle support modules 2000 may transfer pressurized fluid (e.g., hydraulic oil, pressurized water, compressed air, etc.), fuel, and/or rotational mechanical energy between the vehicle support modules 2000 and the vehicles 10.

As shown in FIGS. 1, 6, and 7, the vehicles 10 include one or more implement assemblies or end effectors, shown as implements 70. The implements 70 may be utilized by the vehicle 10 interact with the vehicle support modules 2000. The implements 70 may be configured to engage with the vehicle support modules 2000 to facilitate moving and repositioning the vehicle support modules 2000 relative to the vehicle 10. In some embodiments, the implements 70 are configured to engage with the vehicle support modules 2000 to load and/or unload the vehicle support modules 2000 onto and/or from the transport vehicle 10. In some embodiments, the implements 70 are configured to engage with the vehicle support modules 2000 to position the vehicle support modules 2000 adjacent to the work vehicles 10. In some embodiments, the implements 70 are configured to adjust an orientation of the vehicle support modules 2000 (e.g., relative to the charging interfaces 42, relative to the chassis 20, relative to other vehicle support modules 2000 supported by the transport vehicle 10, etc.). By way of example, the implements 70 may include lift forks, grabber arms, rotating clamps, a crane, a winch, etc. configured to engage, move, reposition, reorientate, or otherwise support the vehicle support modules 2000. By way of another example, the implements 70 may include a conveyor system, rollers, turntables, etc. configured to engage, move, reposition, reorientate, or otherwise support the vehicle support modules 2000. As shown in FIGS. 6 and 7, the implements 70 are supported by the chassis 20 proximate a rear end of the transport vehicle 10 or a front end of the transport vehicle 10. In some embodiments, the implements 70 are otherwise variously positioned about the transport vehicle 10.

The implements 70 may include one or more actuators, shown as implement actuators 72, that facilitate movement of the implements 70. By way of example, the implement actuators 72 may include rotary actuators, such as electric motors or hydraulic motors. By way of another example, the implement actuators 72 may include linear actuators such as hydraulic cylinders or electric linear actuators. The implement actuators 72 may be operatively coupled to the controller 3052 to permit the controller 3052 to control operation of the implements 70 by moving the implement actuators 72. In some embodiments, the implements 70 include a first implement actuator 72 configured to actuate the implements 70 to engage with the vehicle support modules 2000 and a second implement actuator configured to actuate the implements 70 to reposition and reorient the implements 70 and the vehicle support modules 2000 engaged therewith relative to the vehicles 10.

As shown in FIG. 8, the vehicles 10 (e.g., the work vehicles 10 and the transport vehicle 10) are configured to be driven around an operation zone, shown as area 2100. The vehicles 10 may be driven by an operator (e.g., a construction worker), semi-autonomously, or autonomously within and/or around the area 2100 to be used to perform one or more tasks and to be stored or parked (e.g., for charging or refueling, for maintenance, etc.). The area 2100 includes a work site, a construction site, a production area, etc., including a first sub-zone, shown as operation zone 2104, and a second sub-zone, shown as staging area 2108. The operation zone 2104 may include an excavation zone, a loading/unloading zone, a waste disposal area, an assembly zone, a demolition area, among other areas where the vehicles 10 (e.g., the work vehicles 10) typically operate at to perform a task. As shown in FIG. 8, the area 2100 includes a first operation zone 2104a, a second operation zones 2104b, and a third operation zone 2104c. While shown as including the first operation zone 2104a, the second operation zones 2104b, and the third operation zone 2104c, it should be understood that any number of operation zones 2104 may be variously located throughout the area 2100. The staging area 2108 may include a space for storing or parking the vehicles 10 and/or the vehicle support modules 2000 while they are not in operation (e.g., outside of hours of operation for the area 2100, during charging operations, etc.). In some embodiments, the staging area 2108 may include an area to store materials (e.g., lumbar, concrete, pipes, beams, prefabricated components, etc.), establish a field office (e.g., a temporary building for administrative tasks), and/or establish quarters (e.g., a rest area for workers at the area 2100). In some embodiments, the staging area 2108 is remote from the area 2100. By way of example, the staging area 2108 may include a rental area (e.g., from where the vehicles 10 are rented). In some embodiments, the staging area 2108 includes an area where the vehicles 10 and/or the vehicle support modules 2000 are initially delivered to the area 2100. While shown as including a single the staging area 2108, it should be understood that any number of staging areas 2108 may be variously located throughout the area 2100.

As shown in FIG. 8, the staging area 2108 includes one or more charging stations, shown as chargers 2112, configured to charge the vehicles 10 and/or the vehicle support modules 2000. In some embodiments, the chargers 2112 are otherwise variously located or positioned throughout the area 2100. The chargers 2112 may include an external power source, such as a battery bank, a generator, or a connection to a power grid. The charging interface 42 is configured to communicate with the charger 2112 (e.g., via a wireless connection or via a wired connection) to transfer electrical energy between the vehicle 10 and the charger 2112. Similarly, the connector 2020 of the vehicle support modules 2000 is configured to communicate with the charger 2112 (e.g., via a wireless connection or via a wired connection) to transfer electrical energy between the vehicle support module 2000 and the charger 2112. The charger 2112 may transfer electrical energy from the external power source to the vehicle 10 (e.g., to charge the energy storage devices 40, to power one or more functions of the vehicle 10, etc.) and/or the vehicle support modules 2000 (e.g., to charge the energy storage devices 2030, to power one or more components of the vehicle support modules 2000, etc.). In some embodiments, the transport vehicle 10 is configured to receive electrical energy from the chargers 2112 and distribute the electrical energy to the vehicle support modules 2000 (e.g., the vehicle support modules 2000 supported by the transport vehicle 10). In some embodiments, the chargers 2112 are additionally or alternatively configured to transfer pressurized fluid (e.g., hydraulic oil, pressurized water, compressed air, etc.), fuel, and/or rotational mechanical energy to the vehicle support module 2000 and the vehicle 10 (e.g., for refueling).

According to an exemplary embodiment, the transport vehicle 10 is configured to start (e.g., at the end of the work day, at the end of the hours of operation, etc.) at the staging area 2108, navigate to one or more work vehicles 10 at the operation zones 2104, and position one or more vehicle support modules 2000 adjacent to or on one or more of the one or more work vehicles 10. After the one or more vehicle support modules 2000 are positioned proximate the work vehicles 10, the one or more vehicle support modules 2000 may autonomously (e.g., actuate the connector 2020 autonomously to couple with the work vehicles 10) or manually electrically couple with the work vehicles 10 to charge the energy storage devices 40. In such an embodiment, the transport vehicle 10 is configured to return to the one or more vehicle support modules 2000 to load the one or more vehicle support modules 2000 onto the transport vehicle 10 and charge the one or more vehicle support modules 2000 (e.g., as discussed in greater detail above) prior to or at the start of the day (e.g., at the start of the work day, at the beginning of the hours of operation, etc.). The vehicle support modules 2000 may transfer electrical energy to the work vehicles 10 (e.g., via the charging interfaces 42) to charge the energy storage devices 40 (e.g., to full charging capacity) before the start of the work day. In some embodiments, the transport vehicles 10 are configured to deliver the vehicle support modules 2000 to the location of the work vehicles 10 prior to the end of the day to be charged by the vehicle support modules 2000 (e.g., if the energy storage devices 40 have a low or depleted charge, if the operator goes on a break, etc.). The energy storage devices 2030 of the vehicle support modules 2000 may be sized such that they are sufficient to charge a single vehicle only. In some embodiments, there are a plurality of vehicle support modules 2000 of a plurality of different capacities, and the transport vehicle 10 determines a size (e.g., charging need, battery capacity, etc.) of a given work vehicle 10 and selects a vehicle support module 2000 from the plurality of vehicle support modules 2000 with a capacity equal to or greater than the size of the work vehicle 10.

As shown in FIGS. 6 and 7, the transport vehicle 10 is configured to support the vehicle support modules 2000 and navigate between the operation zone 2104 (e.g., between the first operation zone 2104a, the second operation zone 2104b, and the third operation zone 2104c) and the staging area 2108 along a pathway (e.g., track, line, etc.), shown as route 2116. The transport vehicle 10 may be configured to follow or otherwise drive along the route 2116. In embodiments where the transport vehicle 10 is manually controlled by the operator, the operator provides an input to the steering system 34 to steer the transport vehicle 10 to follow the route 2116. By way of example, the route 2116 may be displayed on the user interface 62 and/or the user devices 102 (e.g., overlayed on a map of the area 2100) for the operator to view the route 2116. In other embodiments, the transport vehicle 10 is configured to autonomously follow or drive along the route 2116.

The route 2116 may extend throughout the area 2100 between the staging area 2108 and the operation zone 2104. By way of example, the route 2116 may extend from the staging area 2108 (e.g., the route 2116 may start at an exit of the staging area 2108, at the one or more chargers 2112, etc.), past (e.g., around, adjacent to, etc.) each operation zone 2104, and return to (e.g., terminate at) the staging area 2108 (e.g., an entrance of the staging area 2108, the one or more chargers 2112, etc.). In other words, the route 2116 may entirely encircle, partially encircle, define a portion along a front, back, and/or side of, etc. the operation zone 2104, the staging area 2108, and/or any other portion of the area 2100. The route 2116 may be established based on the nature of the area 2100. By way of example, the route 2116 may be established based on the number of operation zones 2104, the location of the operation zones 2104 (e.g., such that the route 2116 is established adjacent to each operation zone 2104), the location of the chargers 2112 (e.g., such that the route 2116 is established adjacent to or terminates at a respective charger 2112), the location of the staging area 2108, an operating position (e.g., a location and orientation of the work vehicle 10 at the end of the day or start of a break, etc.) of the work vehicle 10, among other factors. The route 2116 may be stored by the memory 56 and/or the servers 104 and a signal associated with the route 2116 may be transmitted to the transport vehicle 10.

In some embodiments, the route 2116 is selected from a plurality of predetermined routes. By way of example, the operator may select one of the predetermined routes. By way of another example, the controller 3052 may automatically select a predetermined route based on one or more aspects of the area 2100. The predetermined route may be a route previously used by one of the work vehicles 10 (e.g., to navigate to a respective operating position) or provided to the transport vehicle 10 from another vehicle 10. The plurality of predetermined routes may include routes of different shapes, lengths, travel times, allowable vehicle dimensions, driving surfaces, different types (i.e., emergency site, construction site, etc.), for different types of vehicles 10 (e.g., boom lifts, telehandlers, firefighting vehicles, refuse trucks, etc.) or other routes.

In some embodiments, the route 2116 is established based on the information acquired by the sensors 60. By way of example, the controller 3052 may utilize location data collected by the sensors 60 to establish the route 2116 based on GPS coordinates, geographical landmarks, or any other location data. By way of another example, the controller 3052 may use environment data collected by the sensors 60 to establish the route 2116 based on detected obstacles (e.g., pedestrians, workers, equipment, hazards, etc.), the detected location of the operation zones 2104, the detected location of a work vehicle 10, the detected location of the staging areas 2108 and the chargers 2112, the topography of the area 2100, markings in the area 2100 (e.g., boundaries painted on the ground), or any other environment data.

The area 2100 may include areas or objects that should not be driven on, in, or around by the transport vehicle 10. By way of example, these areas may include active construction zones, holes, trenches, private property, etc., and these objects may include pedestrians, workers, equipment, hazards (e.g., water hazards), trees, bushes, vehicle support modules 2000 charging the work vehicles 10, other vehicles 10 (e.g., vehicles 10 being charged by the chargers 2112, disabled or parked vehicles 10, etc.), etc. Driving on, in, or around these areas and objects by the transport vehicle 10 may damage the transport vehicle 10, damage the area 2100, be dangerous for an operator of the transport vehicle 10, be illegal (e.g., trespassing on private property), etc. Collectively, these areas and objects are hereinafter referred to as hazards. The controller 3052 may be configured to analyze data acquired by the sensors 60 to determine a travel path (e.g., dynamically adjust the route 2116) and transmit commands based on the data to avoid collisions with the hazards. In some embodiments, the controller 3052 is configured to transmit a command to the user interface 62 and/or the user devices 102 to display or otherwise provide an indication of the hazards (e.g., a location of a hazard) such that the operator controlling the transport vehicle 10 can steer the transport vehicle 10 to avoid the hazards.

In some embodiments, the route 2116 is manually created (e.g., established, defined, drawn, mapped, determined, set, programmed, etc.) by the operator. By way of example, the operator may provide an input to the user interface 62 or the user devices 102 of a desired path along which the transport vehicle 10 is configured to navigate (e.g., autonomously navigate). By way of another example, the operator may provide an input indicating the locations of the work vehicles 10, the chargers 2112, the staging area 2108, and the operation zone 2104, and the route 2116 may be automatically generated based on these locations. By way of yet another example, the operator may drive a first vehicle 10 (e.g., a leader vehicle) along a desired route, and the sensors 60 may record the location of the vehicle 10 to establish the route 2116. By way of still another example, the operator may walk with a user device 102 along a desired route and provide inputs to the user device 102 that records a present (e.g., real-time) location of the user device 102 to establish the route 2116. The route 2116 may be stored as a series of waypoints or a continuous route (e.g., by the memory 56 and/or the servers 104) and transmitted to one or more second vehicles 10 (e.g., autonomous follower vehicles, autonomous follower vehicle support modules 2000) to follow autonomously. The operator defined route 2116 may be a unique path, along which the transport vehicle 10 navigates, that is established (e.g., mapped) to adjacent to the operation zones 2104 and the work vehicles 10 located thereat. In other embodiments, the route 2116 is manually selected from a plurality of predetermined preexisting routes by the operator.

As shown in FIG. 8, the transport vehicle 10 is configured to transport the vehicle support modules 2000, navigate along the route 2116, and position a vehicle support module 2000 adjacent to or on a work vehicle 10. In this manner, the vehicle support modules 2000 are delivered to the work vehicles 10 to charge the work vehicles 10 without having to move the work vehicles 10 (e.g., without having to navigate the work vehicles 10 to a charger 2112). As shown in FIG. 8, the route 2116 is established adjacent to a first work vehicle 10a at the first operation zone 2104a, a second work vehicle 10b at the second operation zone 2104b, and a third work vehicle 10c at the third operation zone 2104c. In embodiments where the area 2100 includes more operation zones 2104 than the first operation zone 2104a, the second operation zone 2104b, and the third operation zone 2104c, the route 2116 is established adjacent to the additional operation zones 2104. Similarly, in embodiments where more than one work vehicle 10 is located at or in the first operation zone 2104a, the second operation zone 2104b, and the third operation zone 2104c, the route 2116 is established adjacent to the additional work vehicles 10. As shown in FIG. 7, the transport vehicle 10 is configured to deliver a first vehicle support module 2000a adjacent to the first work vehicle 10a, a second vehicle support module 2000b adjacent to the second work vehicle 10b, and a third vehicle support module 2000c adjacent to the third work vehicle 10c.

According to an exemplary embodiment, after navigating along the route 2116 adjacent to a work vehicle 10 (e.g., a vehicle 10 to be charged), the implement 70 is configured to engage with a vehicle support module 2000 to unload the vehicle support module 2000 from the transport vehicle 10 and position the vehicle support module 2000 adjacent or on to the work vehicle 10 (at which point the charging module 2000 may electrically connect with the work vehicle 10 to charge the energy storage devices 40). By way of example, responsive to navigating to a work vehicle 10, the first implement actuator 72 may actuate the implement 70 to engage a vehicle support module 2000, the second implement actuator 72 may actuate the implement 70 to move the vehicle support module 2000 engaged therewith to a position and orientation adjacent to the work vehicle 10 such that the vehicle support module 2000 is capable of electrically coupling with work vehicle 10, and the first implement actuator 72 may disengage from the vehicle support module 2000. In such an example, the implement 70 may move the vehicle support module 2000 to a position and orientation where the vehicle support module 2000 can wirelessly charge the work vehicle 10 (e.g., within range to wirelessly charge the work vehicle 10). Alternatively, the implement 70 may move the vehicle support module 2000 to a position and orientation where the vehicle support module 2000 can charge the work vehicle 10 via a wired connection (e.g., such that a charging cable of the vehicle support module 2000 or the work vehicle 10 can reach the other of the vehicle support module 2000 or the work vehicle 10). In some embodiments, the transport vehicle 10 is configured to position and orient the vehicle support modules 2000 adjacent to the charging interface 42 of the work vehicle 10.

In some embodiments, the implements 70 are manually controlled by the operator of the transport vehicle 10 to deliver (e.g., load/unload, position, orient, etc.) the vehicle support modules 2000. By way of example, the system 100 may determine a position and orientation to place the vehicle support modules 2000 and provide an indication of the position and orientation (e.g., audibly via a speaker, display the position and orientation on a display of the user interface 62 and/or user device 102, etc.). In other embodiments, the implements 70 are autonomously controlled by the system 100. By way of example, the system 100 may determine, based on data acquired from the sensors 60, a location of the charging interface 42 of the work vehicle 10 and control operation of the implement actuators 72 to position and orient the charging module 2000 adjacent to the charging interface 42.

In embodiments where the vehicle support modules 2000 include the driveline 2040, the vehicle support modules 2000 are configured to autonomously navigate along the route 2116 using data collected from the sensors 2050. By way of example, the control system 2060 may control operation of the driveline 2040 to navigate the vehicle support module 2000 to a position and orientation adjacent to the work vehicle 10 such that the vehicle support module 2000 is capable of electrically coupling with work vehicle 10. In such an example, the driveline 2040 may navigate the vehicle support module 2000 to a position and orientation where the vehicle support module 2000 can wirelessly charge the work vehicle 10 (e.g., within range to wirelessly charge the work vehicle 10). Alternatively, the driveline 2040 may navigate the vehicle support module 2000 to a position and orientation where the vehicle support module 2000 can charge the work vehicle 10 via a wired connection (e.g., such that a charging cable of the vehicle support module 2000 or the work vehicle 10 can reach the other of the vehicle support module 2000 or the work vehicle 10). In some embodiments, the transport vehicle 10 transports the vehicle support module 2000 to the work vehicle 10 and the vehicle support module 2000 autonomously navigates off of the transport vehicle 10 and adjacent to the work vehicle 10 (e.g., without being engaged or positioned by the implements 70).

After the transport vehicle 10 delivers the vehicle support module 2000 to the work vehicle 10 or the vehicle support module 2000 autonomously navigates to the work vehicle 10 (e.g., after positioning and orienting the vehicle support module 2000 relative to the work vehicle 10), the vehicle support module 2000 may electrically couple with the work vehicle 10 via a connection between the charging interface 42 and the connector 2020 to charge the energy storage devices 40. In some embodiments, the connector 2020 is manually moved by an operator to an engagement with the charging interface 42. In some embodiments, the charging interface 42 is manually moved by an operator to an engagement with the connector 2020. In some embodiments, the interface actuator 2022 autonomously (e.g., based on data acquired from the sensors 2050) actuates the connector 2020 to align and couple the connector 2020 with the charging interface 42. In some embodiments, the work vehicle 10 includes an actuator configured to move the charging interface 42 to autonomously align and couple the charging interface 42 with the connector 2020.

In some embodiments, the transport vehicle 10 is configured to transport the vehicle support modules 2000, navigate along the route 2116, and position a vehicle support module 2000 adjacent to a work vehicle 10 at the end of the day or the start of a break to charge the work vehicles 10 without having to move the work vehicles 10. In some embodiments, the vehicle support modules 2000 are configured to autonomously navigate along the route 2116 to a position adjacent to a work vehicle 10 at the end of the day or the start of a break to charge the work vehicles 10 without having to move the work vehicles 10. In this manner, the vehicle support modules 2000 are configured to charge the work vehicles 10 while the work vehicles 10 are not in operation (e.g., after the operator controlling the work vehicle 10 has left the area 2100 for the day or for a break) without having to navigate the work vehicles 10 to a charger 2112. The process discussed above with respect to deploying the vehicle support modules 2000 to a position and orientation adjacent to the work vehicles 10 may be performed in reverse to return the vehicle support modules 2000 to the staging area 2108 to be charged by the chargers 2112 (e.g., at the start of the day, at the end of a break, etc.) or to load the vehicle support modules 2000 onto the transport vehicle 10 to be charged thereby.

According to an exemplary embodiment, the transport vehicle 10 is configured to transport the vehicle support modules 2000 and/or the vehicle support modules 2000 are configured to autonomously navigate to a position and orientation adjacent to a work vehicle 10 responsive to receiving a signal (e.g., a command from the controller 3052, from the servers 104, etc.) to navigate to the respective position and orientation. In some embodiments, an operator provides an input to the user device 102 to provide a request for a vehicle support module 2000. By way of example, the request may include a vehicle support module 2000 having a desired charging capacity for a particular type of vehicle such as a lift device, such as a boom lift, a telehandler, an aerial work platform, a scissor lift, a vertical lift, a compact crawler boom, a forklift, a crane, a bucket truck, or another type of lift device, a military vehicle, a cement truck, a refuse vehicle, a fire apparatus, a tow truck, a robot, or another type of vehicle or work machine. In response to receiving a signal indicative of the request, a vehicle support module 2000 matching the request (e.g., a vehicle support module 2000 matching the capabilities of the capabilities specified in the request), the transport vehicle 10 may deliver the vehicle support modules 2000 and/or the vehicle support modules 2000 may navigate to a position and orientation associated with the request. In some embodiments, the position and orientation includes a real-time location of the user device 102 that provided the request such that the vehicle support module 2000 is delivered (e.g., by the transport vehicle 10 and/or by autonomous navigation) to the location of the user device 102. In other embodiments, the user inputs a position and orientation (e.g., inputs a specific operation zone 2104, staging area 2108, charger 2112, work vehicle 10, inputs GPS coordinates, etc.) with the request such that the vehicle support module 2000 is delivered to the position and orientation specified by the user. By way of example, the user may provide a request for a vehicle support module 2000 at the second operation zone 2104b, and, responsive to receiving the request, a vehicle support module 2000 may be delivered to the second operation zone 2104b (e.g., to a specified position and orientation at the second operation zone 2104b). In some embodiments, the request includes a time (e.g., a desired time) for the vehicle support module 2000 to arrive at the location associated with the request. By way of example, the request may specify that the vehicle support module 2000 arrive at the location associated with the request at noon. By way of another example, the operator may generate a schedule including time slots during which a vehicle support module 2000 is commanded to arrive at the location associated with the request.

### Monitoring and Route Generating System

Referring generally to the figures, the various exemplary embodiments disclosed herein relate to systems, apparatuses, and method for generating a route map for a vehicle based on ground conditions of a work site. In some embodiments, the ground conditions of the work site are determined based on images received from a camera that can be mounted to the vehicle. The route map can be communicated to a machine operator via a user interface. In some embodiments, the route map is displayed on the user interface and includes a real time map, showing a current machine location, the vehicle route, and the ground conditions, and other information. In some embodiments, the user interface includes a color coded warning indicator, a speaker that produces an audible alarm, or another indicator structured to communicate to the machine operator that the work machine is approaching an obstacle, such as a boulder, or a pothole, or a surface conditions, such as mud, or gravel.

### Boom Lift

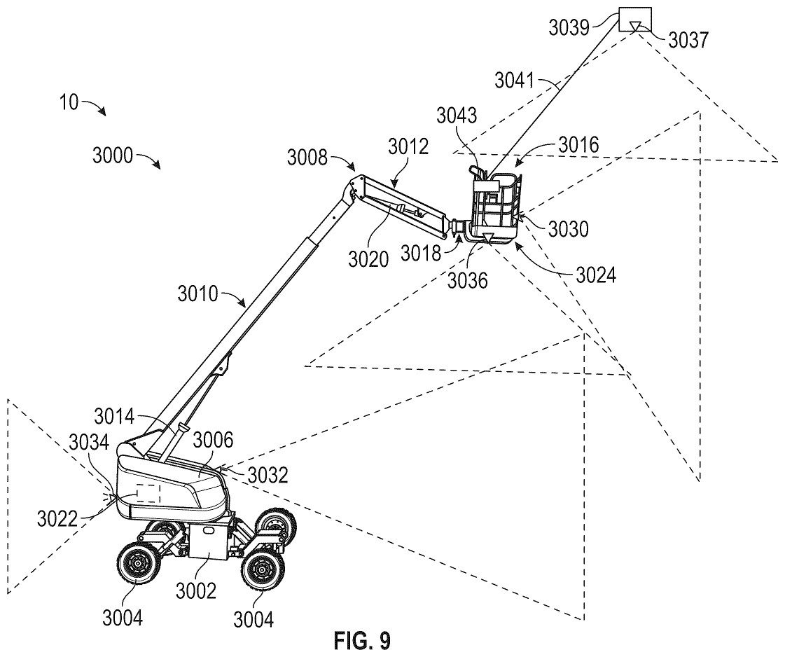

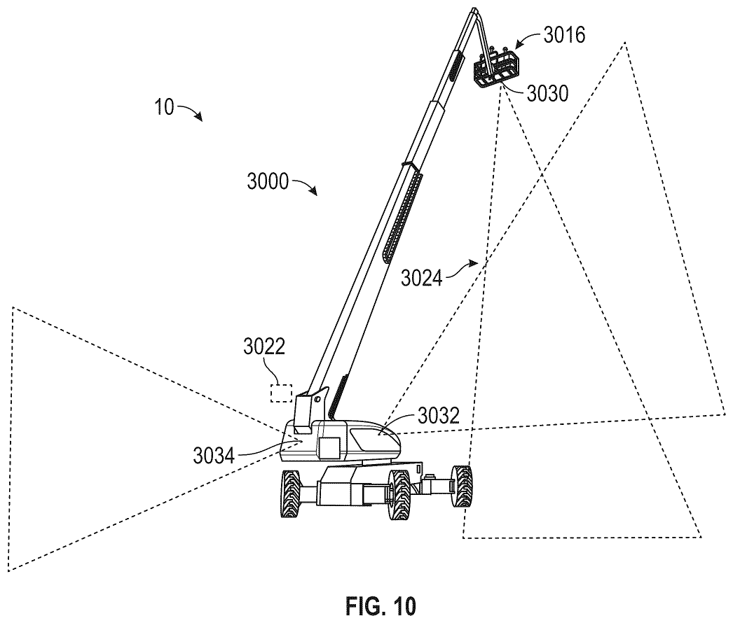

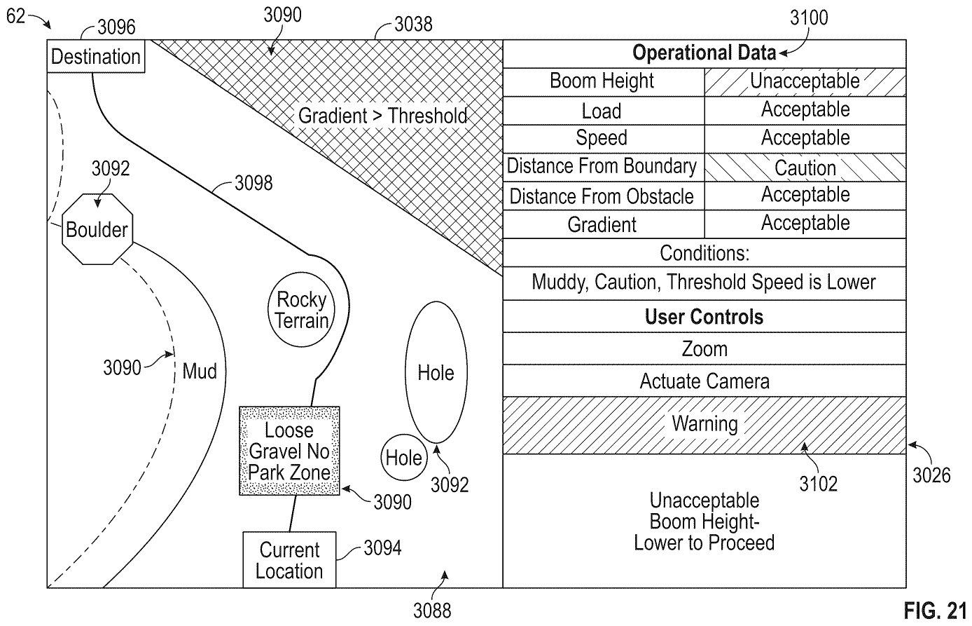

As shown in FIG. 9-10, a boom lift 3000 includes a chassis, shown as frame 3002, and a plurality of tractive elements, shown as wheel and tire assemblies 3004. In other embodiments, the tractive elements include track elements. According to the exemplary embodiment shown in FIG. 21, the boom lift 3000 is configured as a lift device or machine. As shown in FIG. 21, the lift device or machine is configured as a boom lift. In other embodiments, the lift device or machine is configured as a skid-loader, a telehandler, a scissor lift, a forklift, and/or still another lift device or machine. As shown in FIG. 21, the frame 3002 supports a rotatable structure, shown as turntable 3006, and a boom assembly, shown as boom 3008. According to an exemplary embodiment, the turntable 3006 is rotatable relative to the frame 3002. According to an exemplary embodiment, the turntable 3006 includes a counterweight positioned at a rear of the turntable 3006. In other embodiments, the counterweight is otherwise positioned and/or at least a portion of the weight thereof is otherwise distributed throughout the vehicle 3000 (e.g., on the frame 3002, on a portion of the boom 3008, etc.).

As shown in FIG. 9-10, the boom 3008 includes a first boom section, shown as lower boom 3010, and a second boom section, shown as upper boom 3012. In other embodiments, the boom 3008 includes a different number and/or arrangement of boom sections (e.g., one, three, etc.). According to an exemplary embodiment, the boom 3008 is an articulating boom assembly. In one embodiment, the upper boom 3012 is shorter in length than lower boom 3010. In other embodiments, the upper boom 3012 is longer in length than the lower boom 3010. According to another exemplary embodiment, the boom 3008 is a telescopic, articulating boom assembly. By way of example, the upper boom 3012 and/or the lower boom 3010 may include a plurality of telescoping boom sections that are configured to extend and retract along a longitudinal centerline thereof to selectively increase and decrease a length of the boom 3008.

As shown in FIG. 9-10, the lower boom 3010 has a lower end pivotally coupled (e.g., pinned, etc.) to the turntable 3006 at a joint or lower boom pivot point. The boom 3008 includes a first actuator (e.g., pneumatic cylinder, electric actuator, hydraulic cylinder, etc.), shown as lower lift cylinder 3014. The lower lift cylinder 3014 has a first end coupled to the turntable 3006 and an opposing second end coupled to the lower boom 3010. According to an exemplary embodiment, the lower lift cylinder 3014 is positioned to raise and lower the lower boom 3010 relative to the turntable 3006 about the lower boom pivot point.

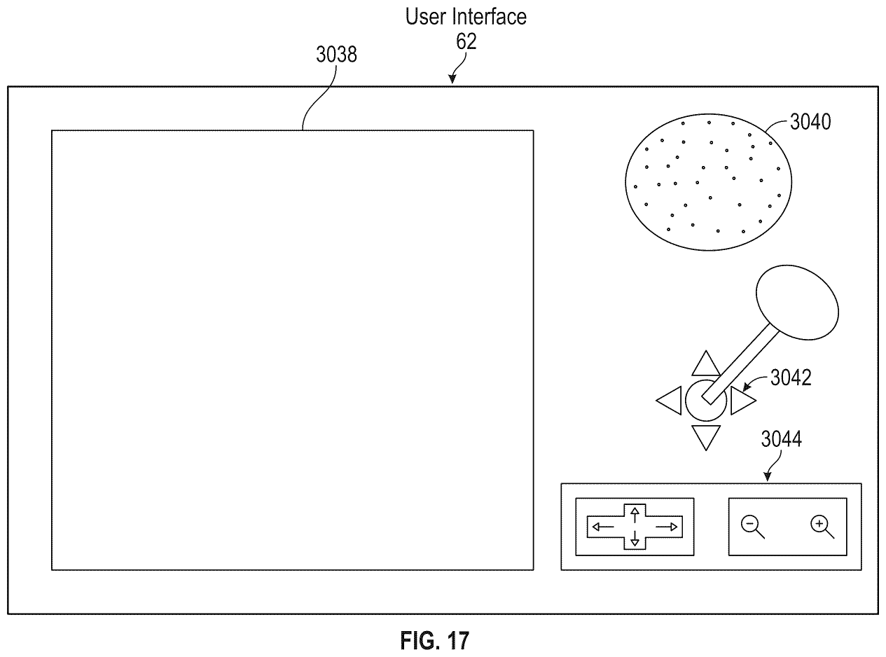

As shown in FIG. 9, the upper boom 3012 has a lower end pivotally coupled (e.g., pinned, etc.) to an upper end of the lower boom 3010 at a joint or upper boom pivot point. The boom 3008 includes an implement, shown as platform assembly 3016, coupled to an upper end of the upper boom 3012 with an extension arm, shown as jib arm 3018. In some embodiments, the jib arm 3018 is configured to facilitate pivoting the platform assembly 3016 about a lateral axis (e.g., pivot the platform assembly 3016 up and down, etc.). In some embodiments, the jib arm 3018 is configured to facilitate pivoting the platform assembly 3016 about a vertical axis (e.g., pivot the platform assembly 3016 left and right, etc.). In some embodiments, the jib arm 3018 is configured to facilitate extending and retracting the platform assembly 3016 relative to the upper boom 3012. As shown in FIG. 17, the boom 3008 includes a second actuator (e.g., pneumatic cylinder, electric actuator, hydraulic cylinder, etc.), shown as upper lift cylinder 3020. According to an exemplary embodiment, the upper lift cylinder 3020 is positioned to actuate (e.g., lift, rotate, elevate, etc.) the upper boom 3012 and the platform assembly 3016 relative to the lower boom 3010 about the upper boom pivot point.

According to the exemplary embodiment of FIGS. 9-10, the platform assembly 3016 is a structure that is particularly configured to support one or more workers. In some embodiments, the platform assembly 3016 includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly 3016 includes a control panel (e.g., a user interface, a removable or detachable control panel, etc.) to control operation of the vehicle 3000 (e.g., the turntable 3006, the boom 3008, etc.) from the platform assembly 3016 and/or remotely therefrom. In some embodiments, the control panel is additionally or alternatively coupled (e.g., detachably coupled, etc.) to the frame 3002 and/or the turntable 3006. In other embodiments, the platform assembly 3016 includes or is replaced with an accessory and/or tool (e.g., forklift forks, etc.).

### Monitoring and Route Generating System

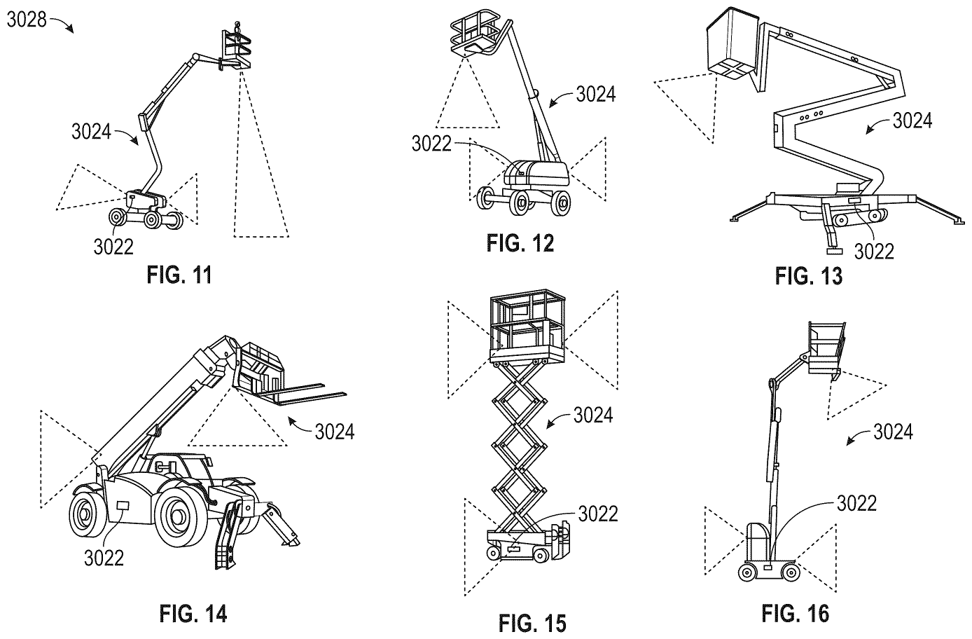

As shown in FIG. 9-12, the boom lift 3000 is equipped with a ground monitoring and route generating system, shown as monitoring and route generation system 3022. The monitoring and route generation system 3022 may be a part of the controller 3052 of the vehicle 10, and therefore include or have access to a communication system or interface, such as communication interface 58, a plurality of sensors, such as sensors 60, a plurality of cameras of a camera system 3024, an alert system 3026, and a communication interface that communicates with the operator, such as user interface 62 and communication interface 58. In some embodiments, the monitoring and route generation system 3022 may included in one or more user device 102, service 104, etc. and is communicably coupled to the controller 3052 of the vehicle including the sensors 60, camera system 3024, etc. The monitoring and route generation system 3022 is configured to at least (1) identify or determine surface conditions, objects and/or obstacles in the worksite, and (2) determine a route based on a desired location, input from an operator or user (e.g., a remote user, etc.), and the determined surface conditions and objects/obstacles. The monitoring and route generation system 3022 may be integrated into the memory 56 of the controller 3052.

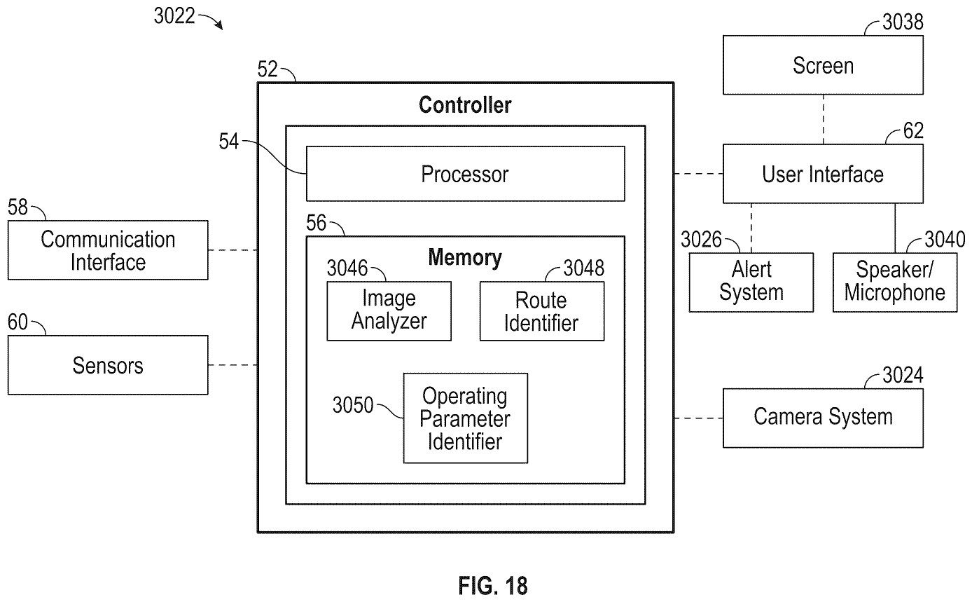

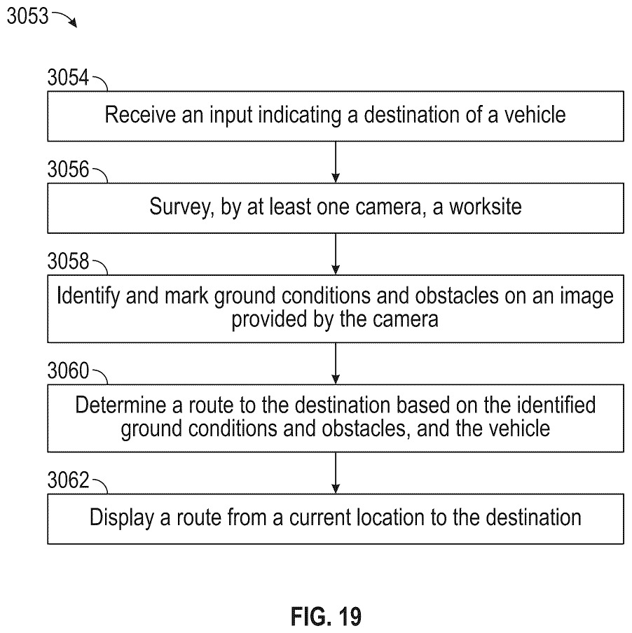

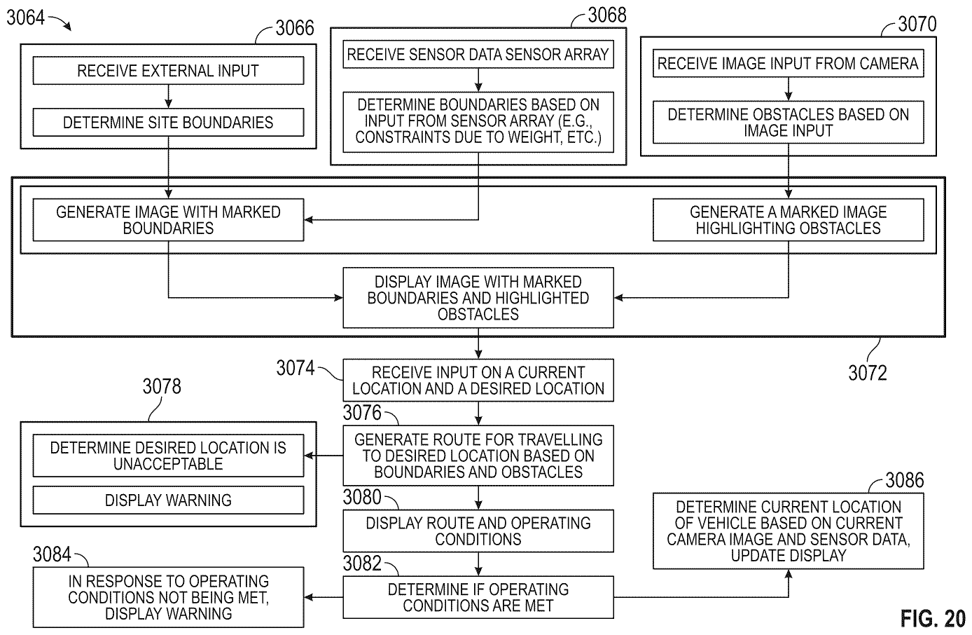

As shown in FIG. 9-18, the monitoring and route generation system 3022 and methods of using the monitoring and route generation system 3022 as described in more detail below may be implemented using various work machines 3028 such as an articulating boom lift as shown in FIG. 19, a telescoping boom lift as shown in FIG. 20, a compact crawler boom lift as shown in FIG. 21, a telehandler as shown in FIG. 16, a scissor lift as shown in FIG. 17, and/or a toucan mast boom lift as shown in FIG. 18.

As shown in the exemplary embodiment of FIG. 9-16, the boom lift 3000 includes the camera system 3024. In some embodiments, the camera system 3024 the same or similar to or a component of the sensors 60 of the vehicle 10. In some embodiments, one or more cameras that provide information from semi-autonomous or autonomous driving of the vehicle 10 are also used to provide an input to the monitoring and route generation system 3022. The camera system 3024 is communicably coupled the monitoring and route generation system 3022. The camera system 3024, when activated (e.g., by the operator, etc.) is configured to survey and examine the surrounding area. For example, the camera system 3024 provides a visual input of the worksite around the boom lift 3000. The camera system 3024 is configured to communicate (e.g., via a wireless connection, etc.) the visual input to the monitoring and route generation system 3022.

As shown in the exemplary embodiment of FIG. 9-16, the camera system 3024 includes plurality of cameras (e.g., one or more of a first camera 3030, a second camera 3032, and a third camera 3034, a fourth camera 3036, a fifth camera 3037 etc.). According to this embodiment, the camera system 3024 is coupled to the vehicle 10 (e.g., the boom lift 3000, etc.). As shown in FIGS. 9-16, the first camera 3030, the second camera 3032, the third camera 3034, the fourth camera 3036, and the fifth camera 3037 are positioned at different locations on or coupled to the boom lift 3000. For example, according to the exemplary embodiment in FIG. 21, the first camera 3030 is positioned on the platform assembly 3016 to provide an aerial view of the worksite; the second camera 3032 and the third camera 3034 are positioned on opposite sides of the frame 3002 to provide a 360-degree view of the worksite surround the boom lift 3000; the fourth camera 3036 is positioned on an underside of a platform assembly 3016 and is downward facing towards the ground; and the fifth camera 3037 is coupled to a drone 3039, that is tethered via a tether, cable, or cord, shown as tether 3041, to the platform assembly 3016 In other embodiments, the camera system 3024 may include any number of cameras or any combination of cameras. In yet another embodiment, the camera system 3024 may be positioned a distance away from the boom lift 3000. For example, the camera system 3024 may be a drone that is tethered to the boom lift 3000 that incudes a plurality of cameras, such as the fifth camera 3037 coupled to drone 3039. The drone 3039 is shown coupled to the platform assembly 3016 via a base, charging assembly, storage assembly, etc. shown as drone bay 3043 which receives, stores, and/or charges the drone 3039 and the tether 3041. The drone bay 3043 may be electrically and communicably coupled to the vehicle 10. In some embodiments, the drone 3039 is released from the drone bay 3043 to survey the worksite and receives the drone 3039 for landing. The drone 3039 may be coupled to the vehicle 10 by the tether 3041 such that a separate license is not needed to operate the drone 3039. The drone may be a self-propelled aircraft such as a rotary aircraft with one or more rotors, a motor (e.g., an electric motor) configured to drive the one or more rotors, and in some cases an onboard power supply to power the motor. The drone 3039 may be communicably coupled to the vehicle 10 and the monitoring and route generation system 3022. It is advantageous for the camera system 3024 to include a plurality of cameras such that each camera can capture a different view and/or angle of the area surround the boom lift 3000 and the general worksite.

As shown in FIG. 17, the user interface 62 can include a display such as screen 3038, a speaker 3040 (e.g., an audio portion of the alert system 3026, etc.), a vehicle control input 3042 such as a button or control column, and a camera system control input 3044. The camera system 3024 is communicably coupled to the user interface 62. As such the camera system 3024 is configured to provide a visual input to the user interface 62 and the screen 3038 is configured to display the visual input for the operator to view. In some embodiments, when there is a plurality of cameras (e.g., the first camera 3030, the second camera 3032, and the third camera 3034, etc.) the operator can select the visual input from one of the cameras 3030-3037 to display on the screen 3038. For example, one selecting the visual input from the first camera 3030, the operator can then control the first camera 3030 via the camera system control input 3044. As such the operator can select to zoom or rotate the first camera 3030 to adjust the visual input displayed on the screen 3038. In other embodiments, the operator can select to display the visual input from each of the first camera 3030, the second camera 3032, or the third camera 3034 to display on the screen 3038 (e.g., a split screen visual, etc.). In some embodiments, the user interface 62 further allows a user to view the camera, such as camera 3037, as well as control the operation of the camera 3037 and/or the drone 3039 relative to the boom lift 3000, In yet another embodiment, the controller 3052 can select (e.g., determine, etc.) the input from one of first camera 3030, the second camera 3032, the third camera 3034, the fourth camera 3036, or the fifth camera 3037 to display on the screen 3038 based on the anticipated operation of the vehicle 10. For example, if the operator provides an input for a route to a desired location, the controller 3052 can select the input from one of the first camera 3030, the second camera 3032, the third camera 3034, the fourth camera 3036, or the fifth camera 3037 to display on the screen 3038 based on the best view of the generated route of anticipated travel. The controller 3052 can automatically zoom and/or adjust the selected camera.

According to the embodiments of FIG. 9-18, the controller 3052 is also configured to command (e.g., send a signal to, etc.) the camera system 3024 to survey the area either automatically after a period of time or in response to an operator or a user (e.g., a remote user, etc.) input. As such the camera system 3024 provides a visual input to the controller 3052. By periodically providing a visual input to the controller 3052, the monitoring and route generation system 3022 can determine any changes in the worksite when the boom lift 3000 is in use. For example, workers may bring in materials and/or tools for use in the worksite throughout the workday. Conversely, workers may remove materials and/or tools from the worksite. Thus, obstacles that may affect the operation of the boom lift 3000 in a stationary position (e.g., a position wherein the drivetrain 30 is stationary or not moving, etc.). For example, it may be desirable to not raise or lower the boom 3008 while materials or workers are mobbing in the worksite nearby the boom lift 3000. As such, the monitoring and route generation system 3022 is configured to provide an alert (e.g., a message, a text, etc.) to the operator to check nearby surroundings prior to operating the boom 3008 through the communication interface 62.

Referring now to FIG. 18, the controller 3052 includes an image analyzer 3046, route identifier 3048, and operating parameter identifier 3050. In some embodiments, the monitoring and route generation system 3022 is configured to generate a route. In some embodiments, the controller 3052 includes a Global Positioning System (GPS) as part of the sensors 60. For example, the monitoring and route generation system 3022 is configured to receive a route request (e.g., a request input, etc.) from the operator of the vehicle 10 (e.g., the boom lift 3000, etc.) or a user, such as a remote user (e.g., via the user interface 62 or the communication interface 58). In some embodiments, the operator selects (e.g., via a button input or a touch input, etc.) a desired location from a map (e.g., a worksite map, etc.) displayed on the screen 3038. The controller 3052 then receives a GPS location (e.g., coordinates, etc.) for each of the desired location and the current location of the vehicle 10. In some embodiments, the operator may then provide a confirmation input for the route request.

Still referring to FIG. 18, after the route request has been initiated (e.g., the operator inputs a desired location, a destination, etc.), the camera system 3024 is configured to survey or inspect the surrounding area and provide the images (e.g., image inputs, visual inputs, etc.) to the controller 3052 using one or more of the cameras 3032-3037. As shown in FIG. 18, the controller 3052 includes an image analyzer 3046. The images from the camera system 3024 are provided to the image analyzer 3046 and the image analyzer 3046 (e.g., implemented by the processor 54) is configured to use image recognition and analyze the image or images and identify surface characteristics of the worksite and objects and or obstacles within the worksite. The image analyzer 3046 identifies changes in grade or slope of the ground, such that the image analyzer 3046 marks areas of a higher grade that, for example, may impact the stability of the vehicle 10 (e.g., for example based on preset thresholds stored in the memory 56, etc.) and should be avoided. For example, the image analyzer 3046 can identify that different surfaces of the ground of the worksite that the vehicle 10 may have to traverse. For example, the image analyzer 3046 can identify if the ground is, for example, gravel, or grass, and if the grass is heavily saturated such that it is wet and muddy. The image analyzer 3046 is configured to mark the identified changes in surface area on the image or images. For example, the image analyzer 3046 may store a default ground condition (e.g., in the memory 56), such as “dry grass” and then mark any identified surface condition that is not dry grass, such as mud. The image analyzer 3046 is configured to provide the marked image to the controller 3052 for displaying to the operator and/or user (e.g., on the screen 3038, etc.). The image analyzer 3046 also identifies any obstacles such as column pockets, boulders, or potholes and marks the obstacles on the image or images. The image analyzer 3046 then provides the marked image, showing ground conditions and obstacle to the controller 3052.

As shown in FIG. 18 the controller 3052 includes a route identifier 3048. The route identifier 3048 is configured to receive the marked image from the image analyzer 3046. The route identifier 3048 is configured to first determine if a route from the current location to the desired location or destination is possible based on the marked image including the marked ground conditions and obstacles. For example, the route identifier 3048 can determine that based on the identified grade of the slope of the surface from the image analyzer 3046, that the vehicle 10 cannot travel to the desired location and the route identifier 3048 outputs or communicates to the user that the vehicle 10 cannot travel to the input destination. The route identifier 3048 is configured to determine the route based on the capabilities of the specific vehicle 10 being used (e.g., different vehicles 10 can climb/descend or handle different ground conditions and/or obstacles, etc.) The route identifier 3048 is configured to determine a route from the current location to the desired location or destination based on the identified ground surfaces, including surface grade and conditions like mud, and the identified obstacles, such as rocks or potholes. For example, the route identifier 3048 determines the route from the current location to the destination that avoids the marked obstacles and identified surface conditions, like mud, which may affect or impede motion of the vehicle 10. As such the route identifier 3048 identifies an optimal route for the vehicle 10 to the desired location input from the operator or user. For example, the route identifier 3048 identifies a route that causes the chassis 20 to be in a maximally stable orientation relative to the grad identified by the image analyzer 3046.

As shown in FIG. 18, the controller 3052 also includes an operating parameter identifier 3050. The operating parameter identifier 3050 receives the marked image from the image analyzer 3046. The operating parameter identifier 3050 then determines operating parameters for the vehicle 10 based on the marked surface conditions and obstacles. For example, if the image analyzer 3046 identifies an area of gravel along the route determined by the route identifier 3048, the operating parameter identifier 3050 determines operating parameters, such as a speed or boom height, for traveling over the of gravel along the route. For example, the operating parameter identifier 3050 can suggest reducing the speed of the vehicle 10 over the are of gravel to reduce slippage or suggest lowering the boom 3008 to maximize stability while traveling along the identified route. In some embodiments, the operating parameter identifier 3050 can determine the operating parameter for the vehicle 10 and control the vehicle 10 or one or more components of the vehicle 10 to obtain the operating parameter. For example, when the vehicle 10 is moving along a grade as identified by one or more images by the image analyzer 3046, the operating parameter identifier 3050 can determine lowering a boom height would improve the center of gravity of the vehicle 10 and can control the vehicle 10 accordingly.

### Method of Using a Monitoring and Route Generating System

As shown in FIG. 19-14 are exemplary embodiments of methods of using, the monitoring and route generation system 3022. As shown in generally in FIG. 19, the method 3053 illustrates the general method of use of the monitoring and route generation system 3022.

At step 3054, the controller 3052 receives an input or command indicating a desired location or destination of a vehicle, such as vehicle 10, or boom lift 3000. The input may be received via touch input or button input to the user interface 62. In other embodiments, the input may be a verbal input received by a microphone, such as a microphone speaker complex such as 3040. In yet another embodiment, the input may be provided by a remote user via the communication interface 58.

At step 3056, the worksite is surveyed to identify ground conditions and obstacle. For example, a camera, as in camera system 3024, can survey or view the worksite including the ground conditions of the worksite and capture images to provide to the controller 3052.

At step 3058, the image provided from surveying the worksite is used to identify and mark the ground conditions and obstacles. For example, an analyzer or identifier system, such as the image analyzer 3046, identifies the ground conditions and obstacles from the image provided by the camera system 3024. For example, the image analyzer 3046 has stored instructions (e.g., in the memory 56, etc.) that when executed by the processor (e.g., processor 54, etc.) cause the image analyzer 3046 to identify ground conditions such as a grade of a slope, the ground conditions (e.g., sand, gravel, mud, asphalt, etc.), or the presence of obstacles and feature (e.g., column pockets, boulders, potholes, etc.).

At step 3060, a route from the current location to the destination is determined based on the identified ground conditions and obstacles. For example, a control system, such as the controller 3052 including the route identifier 3048, receives a marked image that identifies the ground conditions and the obstacles and determined a route based on the marked image. The route may be based on both the results of the analyzed image (i.e., from image analyzer 3046) and one or more parameters of the vehicle itself, such as its size, type, capability, etc. The route identifier 3048 then maps out or draws the route on the marked image such that the obstacles and the determined route are shown on the marked image.

At step 3062, the marked image is displayed showing the route and the obstacles from the current location to the destination. For example, the route identifier 3048 provides the marked image to the controller 3052 and the controller 3052 displays the marked image including the route on the screen 3038.

Now referring to FIG. 20 is another method 3064 of using the monitoring and route generation system 3022. As shown in FIG. 20, at step 3066 an external input is received providing worksite boundaries. For example, the user may draw the boundaries on a map displayed on the screen 3038 or the boundaries may be received from a remote user or device via the communication interface 58.

At step 3068 information is received regarding the vehicle 10 and current operating conditions or specifications of the vehicle 10 such as a load. The received operating conditions or specifications of the vehicle 10 are used to determine additional boundaries within the worksite.

At step 3070, image or images of the worksite are received and ground conditions and obstacles are determined from the image. For example, the controller 3052 receives the image from the camera system 3024 and then the image analyzer determines and marks the ground conditions and obstacles on the image.

At step 3072, an image is generated showing the marked boundaries, ground conditions, and obstacles, and the marked image is displayed (e.g., on the screen 3038 of the user interface 62.

At step 3074, input regarding a current location of the vehicle and a desired location of the vehicle or a destination is received. For example, a GPS system may provide the current location, and the operator may provide the destination to the controller 3052.

At step 3076, a route is generated based on the boundaries, ground conditions, and obstacles, and one or more parameters of the vehicle. For example, the route identifier 3048 determines the route, for example, a route that maximizes stability based on the worksite conditions identified by the camera system 3024.

In some instances the method proceeds to step 3078. At step 3078 it is determined that a vehicle may not be able to travel to the destination and a warning is provided. For example, based on current ground conditions or obstacles, the route identifier 3048 may determine that the vehicle 10 cannot travel to the desired location or destination.

At step 3080 operating conditions for traveling along the determined route to the destination are determined and provided. For example, a boom height, or a speed may be specified based on the ground conditions or obstacles.

At step 3082, it is determined if the operating conditions are met. For example, the controller 3052 may receive input from sensors 60 indicating a boom height. At step 3084, it is determined that the operating conditions are not met (e.g., the boom height is not within the specified range, etc.) and a warning is issued (e.g., via the screen 3038). In some embodiments, the controller 3052 is configured to automatically control the vehicle or one or more of its components to obtain the operating condition.

At step 3086, the operating conditions are met and the vehicle proceeds to travel to the destination and the current location of the vehicle is determined and the route map displayed is continuously updated to reflect the current location. For example, the GPS system, the camera system 3024, and sensors 60 provide input and/or data along the route to determine the current location of the vehicle (e.g., vehicle 10, boom lift 3000, etc.) and update the route map.

### User Interface Display

As shown in FIG. 21 is an exemplary embodiment of a marked image 3088 provided by the monitoring and route generation system 3022. The marked image 3088 includes various ground conditions 3090 such as a high gradient, mud, and gravel. The marked image 3088 also illustrates obstacles 3092 such as holes, and boulders. The marked image 3088 illustrate the current location 3094, the destination 3096, and the route 3098. As shown in FIG. 21, the route 3098 includes turns/bends to account for the various ground conditions 3090 and obstacles 3092. As shown in FIG. 21, the route 3098 extends through ground conditions 3090 based on the capabilities of the vehicle (e.g., boom lift 3000, etc.)

As shown in FIG. 21, in some embodiments, the marked image 3088 may include an operational data section 3100. The operational data section 3100 may include operational information relative to the specific vehicle being used. The operational data section 3100 may also highlight recommended operating conditions and indicate whether the recommended operating conditions are met (e.g., acceptable, unacceptable, caution, etc.).

As shown in FIG. 21, the marked image 3088 can also include a warning section 3102 that provides information from the alert system 3026.

### Autonomous Jobsite Control System Overview

Referring generally to the figures, a lift device includes a base assembly, a lift assembly, an implement interface, and an implement assembly. The implement interface facilitates removably coupling the implement assembly to the lift assembly. The implement interface permits communication of data, electrical energy, and pressurized fluids between the base assembly and the implement assembly. The implement interface may have a universal layout, such that different implement assemblies for different applications (e.g., painting, pressure washing, welding, drywall finishing, etc.) may each be connected to the lift device through a common implement interface.

The implement assembly may include an implement controller that controls motion of an implement, and the base assembly may include a base controller that controls operation of the base assembly and the lift assembly. Throughout operation, the implement controller may control movement of the implement as required to complete a desired task. If the implement controller is unable to move the implement to a desired position without operating the lift assembly and/or the base assembly, the implement controller may indicate a desired path for the implement interface to the base controller. The base controller 1040 may translate the desired path into specific actions of the base assembly and/or the lift assembly to reposition the implement interface. This control method greatly simplifies the process of controlling the lift device relative to a system where one controller is required determine how to control each actuator of a lift device individually. An organization that manufactures implement assemblies may utilize a lift device with minimal development devoted toward the lift assembly or the base assembly, freeing up resources to focus on developing an implement assembly for a specific application (e.g., paint spraying, sand blasting, welding, drywall finishing, etc.).

### Lift Device

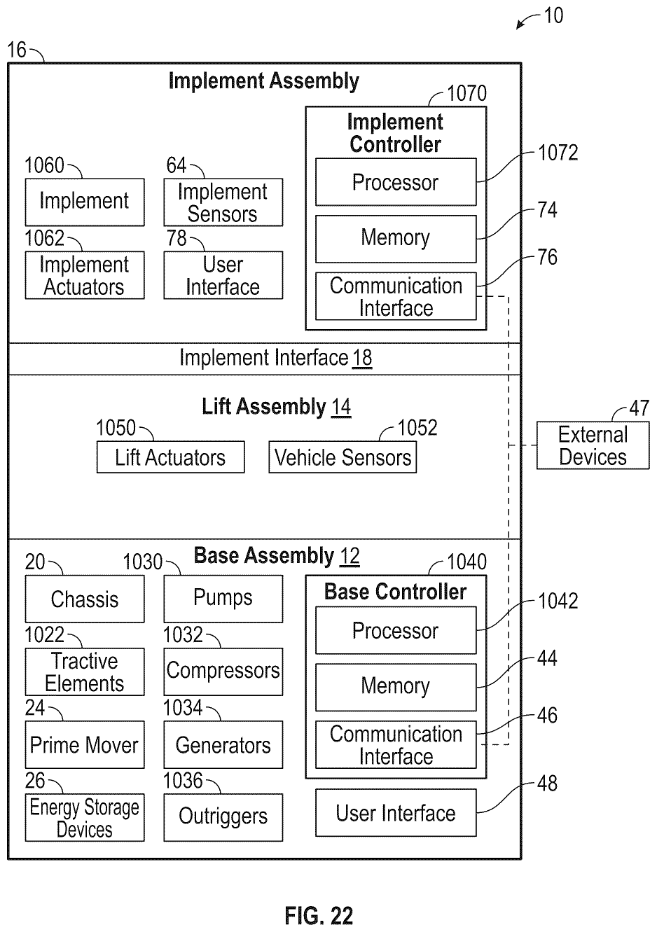

Referring to FIG. 22, a vehicle, work machine, lifting apparatus, or lift device is shown as lift device 10 according to an exemplary embodiment. By way of example, the lift device may be or include a mobile elevating work platform (MEWP), a telehandler, a boom lift, a vertical lift, a scissor lift, a firetruck, or any other type of machine capable of moving (e.g., lifting) material or people to a desired position. The lift device 10 may be human operated, partially autonomous, or completely autonomous.

As shown, the lift device 10 includes a base assembly 12 (e.g., a base, a support assembly, a drivable support assembly, a support structure, a chassis, etc.), a lift assembly 14 (e.g., a boom, a boom lift assembly, a lifting apparatus, an articulated arm, a scissor lift, a ladder, a telescoping assembly, etc.), and an end effector assembly or implement assembly 16 (e.g., a tool, a manipulator, a platform, etc.). A coupler or end effector interface, shown as implement interface 18, couples the implement assembly 16 to the lift assembly 14.

The base assembly 12 is configured to support the other components of the lift device 10 and propel the lift device 10 on the ground. The lift assembly 14 is configured to move (e.g., lift, translate, pivot, rotate, etc.) the implement interface 18 and the corresponding implement assembly 16 relative to the base assembly 12. The implement assembly 16 is configured to perform one or more tasks (e.g., moving material, manipulating material by welding, cutting, etc., supporting one or more operators, etc.).

As shown in FIG. 22, the base assembly 12 includes a frame or chassis, shown as chassis 20, that supports the other components of the base assembly 12. A series of tractive elements (e.g., wheels, tracks, etc.), shown as tractive elements 1022, are coupled to the chassis 20. The tractive elements 1022 engage a support surface (e.g., the ground) to support the lift device 10. One or more actuators, shown as prime mover 24, are configured to drive the tractive elements 1022 to steer and/or propel the lift device 10. By way of example, the prime mover 24 may be or include an electric motor and/or an internal combustion engine (e.g., a gasoline or diesel engine) that receives stored energy and provides rotational mechanical energy to operate various functions of the lift device 10. The base assembly 12 further includes one or more energy storage devices 26 coupled to the chassis 20. The energy storage devices 26 may include batteries, capacitors, fuel tanks, fuel cells, and/or other energy storage devices. The energy storage devices 26 are configured to store energy (e.g., chemically) and provide the stored energy to the prime mover 24 and/or other components of the lift device 10.

Referring still to FIG. 22, the base assembly 12 includes one or more pumps 1030, compressors 1032, and/or generators 1034 coupled to the chassis 20. The pumps 1030 may receive rotational mechanical energy (e.g., from the prime mover 24) and provide a supply of pressurized liquid (e.g., hydraulic oil, water, etc.). The compressors 1032 may receive rotational mechanical energy (e.g., from the prime mover 24) and provide a supply of pressurized gas (e.g., air, refrigerant, etc.). The generators 1034 may receive rotational mechanical energy (e.g., from the prime mover 24) and provide a supply of electrical energy (e.g., to be stored in an energy storage device 26). The pressurized liquid, the pressurized gas, and/or the electrical energy may be supplied to various components of the lift device 10 to facilitate operation of the lift device 10.

The base assembly 12 further includes one or more deployable supports (e.g., outriggers, downriggers, etc.), shown as outriggers 1036, coupled to the chassis 20. The outriggers 1036 may be selectively repositionable between a stored position and a deployed position. In the stored position, the outriggers 1036 are retracted toward the chassis 20 and away from a support surface (e.g., the ground). In the deployed position, the outriggers 1036 extend outward and engage the support surface and support the base assembly 12. The outriggers 1036 may be used to level the chassis 20 and/or increase the stability of the vehicle (e.g., when the lift assembly 14 is extended).

The base assembly 12 further includes a control circuit or processing circuit, shown as base controller 1040, coupled to the chassis 20. The base controller 1040 is operatively coupled to (e.g., in communication with) components of the base assembly 12 and the lift assembly 14. The base controller 1040 may control operation of the components of the base assembly 12 and the lift assembly 14 directly. The base controller 1040 may control operation of the implement assembly 16 indirectly (e.g., through the implement controller 1070). Alternatively, the implement controller 1070 may be omitted, and the base controller 1040 may control operation of the entire lift device 10. The base controller 1040 includes a processor 1042 and a memory device, shown as memory 44. The memory 44 is configured to store instructions thereon that, when executed by the processor 1042, cause the base controller 1040 to perform the various functions described herein.

The base controller 1040 further includes a network interface, shown as communication interface 46. The communication interface 46 is configured to send and receive information (e.g., data, commands, signals, etc.). The communication interface 46 may communicated through a wired connection (e.g., a CAN bus, an ethernet connection, etc.) and/or wirelessly (e.g., using Bluetooth, radio, Wi-Fi, cellular networks, etc.). The communication interface 46 may communicate with the other components of the lift device 10.

The communication interface 46 may communicate with components outside of the lift device 10, shown as external devices 47. By way of example, the communication interface 46 may facilitate wireless communication with the external devices 47 (e.g., direct wireless communication, communication over a cellular network, communication over a wide area network (e.g., the Internet, etc.). The external devices 47 may include user devices such as smartphones or laptops, servers, or other devices. By way of example, the external devices 47 may include one or more devices that operate a vehicle telematics platform that collects, analyzes, and transmits data from multiple lift devices 10 and/or other work machines.

The base assembly 12 further includes an input/output device, shown as user interface 48, coupled to the chassis 20 and operatively coupled to the base controller 1040. The user interface 48 may be positioned to be accessible by a user positioned on the ground and/or on the base assembly 12. The user interface 48 may be configured to receive information (e.g., commands) from the user. By way of example, the user interface may include touch screens, buttons, switches, knobs, or other input devices. The user interface 48 may be configured to provide information (e.g., status information) to the user. By way of example, the user interface may include displays, lights, speakers, or other output devices.

The lift assembly 14 includes one or more actuators, shown as lift actuators 1050. The lift actuators 1050 are configured to apply mechanical energy (e.g., a force, a torque, etc.) to raise, lower, translate, or otherwise control the lift assembly 14 to move the implement interface 18. By way of example, lift actuators 1050 may include hydraulic actuators (e.g., hydraulic motors, hydraulic cylinders, etc.), pneumatic actuators (e.g., pneumatic motors, pneumatic cylinders, etc.), electric actuators (e.g., electric motors, electric linear actuators, etc.), or other types of actuators. The lift actuators 1050 may be powered by the pumps 1030, the compressors 1032, the generators 1034, the energy storage devices 26, and/or other energy sources. Operation of the lift actuators 1050 may be controlled by the base controller 1040.

The lift assembly 14 further includes one or more sensors, shown as vehicle sensors 1052. Although shown as part of the lift assembly 14, the vehicle sensors 1052 may be positioned anywhere throughout the lift device 10. The vehicle sensors 1052 may provide sensor data indicating the position of the base assembly 12, the lift assembly 14, and/or the implement interface 18 relative to other components of the lift device 10 (e.g., the lift assembly 14 relative to the base assembly 12) and/or the surrounding environment. By way of example, the vehicle sensors 1052 may include LIDAR sensors, ultrasonic sensors, contact sensors (e.g., limit switches), potentiometers, optical encoders, or other types of sensors. The sensor data from the vehicle sensors 1052 may be used to facilitate closed-loop control over the position of the lift device 10.

The implement interface 18 is configured to couple the implement assembly 16 to the lift assembly 14. In some embodiments, the implement interface 18 removably couples the implement assembly 16 to the lift assembly 14. In other embodiments, the implement interface 18 permanently couples the implement assembly 16 to the lift assembly 14. The implement interface 18 may fixedly couple the implement assembly 16 to a distal end portion of the lift assembly 14. The implement interface 18 may pass data (e.g., electrical signals), electrical energy, hydraulic fluid, compressed gas, or other signals between (a) the base assembly 12 and the lift assembly 14 and (b) the implement assembly 16 to power or control the implement assembly 16. Similarly, the implement interface 18 may pass signals from the implement assembly 16 to the base assembly 12 and/or the lift assembly 14 to control the base assembly 12 and/or the lift assembly 14.

Referring still to FIG. 22, the implement assembly 16 includes a tool, manipulator, or platform, shown as implement 1060. The implement 1060 may be configured to perform a desired task. In some embodiments, the implement 1060 includes a tool that facilitates moving an object. By way of example, the implement 1060 may include robotic arms, lift forks, buckets, hooks, suction cups, claws, or other manipulators. In some embodiments, the implement 1060 includes a tool that performs a task other than moving material. By way of example, the implement 1060 may include pressure washers, spray nozzles, sand blasters, air guns, paint guns, tape guns, welders, applicators for drywall compound, lights, or other tools. In some embodiments, the implement 1060 includes an inspection tool. By way of example, the implement 1060 may include cameras, temperature sensors, multimeters, contact probes that measure the profile of a surface, or other inspection tools. In some embodiments, the implement includes a work platform (e.g., a basket, an operator platform) that is configured to support one or more operators.

The implement assembly 16 further includes one or more actuators, shown as implement actuators 1062, coupled to the implement 1060. The implement actuators 1062 are configured to reposition (e.g., translate, rotate, raise, lower, etc.) or otherwise move the implement 1060 relative to the implement interface 18. By way of example, the implement actuators 1062 may include hydraulic actuators, pneumatic actuators, electric actuators, or other types of actuators.

The implement assembly 16 further includes one or more sensors, shown as implement sensors 64. The implement sensors 64 may provide sensor data indicating the position of the implement 1060 relative to other components of the lift device 10 (e.g., the implement interface 18) and/or the surrounding environment. By way of example, the implement sensors 64 may include LIDAR sensors, ultrasonic sensors, contact sensors (e.g., limit switches), potentiometers, optical encoders, or other types of sensors. The sensor data from the implement sensors 64 may be used to facilitate closed-loop control over the position of the implement 1060.

The implement assembly 16 further includes a control circuit or processing circuit, shown as implement controller 1070, coupled to the implement interface 18. The implement controller 1070 is operatively coupled to (e.g., in communication with) with the implement 1060, the implement actuators 1062, and the implement sensors 65. The implement controller 1070 may control operation of the components of the implement assembly 16 directly. The implement controller 1070 may control operation of the base assembly 12 and the lift assembly 14 indirectly (e.g., through the base controller 1040). The implement controller 1070 includes a processor 1072 and a memory device, shown as memory 74. The memory 74 is configured to store instructions thereon that, when executed by the processor 1072, cause the implement controller 1070 to perform the various functions described herein.

The implement controller 1070 further includes a communication interface 76. The communication interface 76 may be substantially similar to the communication interface 46, except as otherwise specified herein. The communication interface 76 may communicate with the communication interface 46 of the base controller 1040 and/or the external devices 47.

The implement assembly 16 further includes an input/output device, shown as user interface 78, coupled to the implement interface 18 and operatively coupled to the implement controller 1070. The user interface 78 may be positioned to be accessible by a user positioned on the implement 1060 (e.g., on a platform of the implement 1060). The user interface 78 may perform similar functions to the user interface 48.

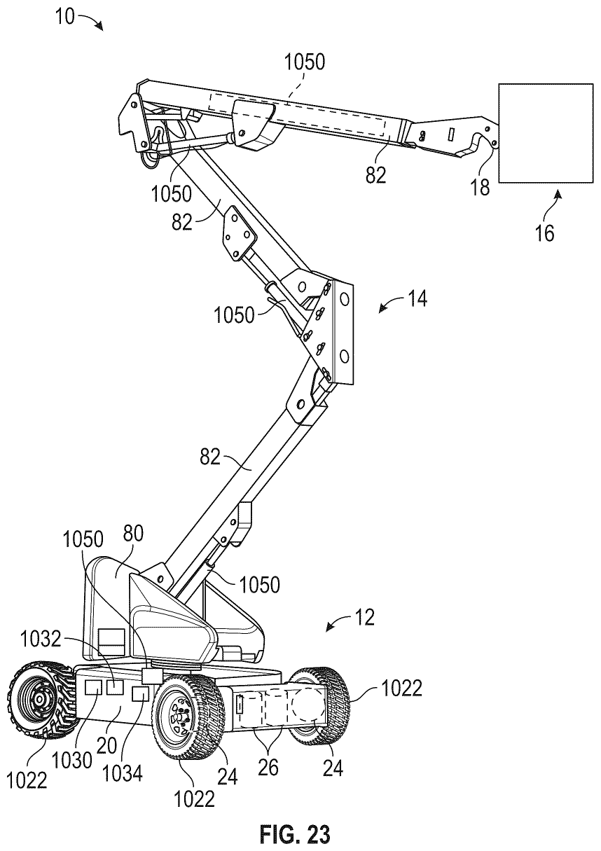

Referring to FIG. 23, the lift device 10 is shown implemented as a boom lift, according to an exemplary embodiment. As shown in FIG. 23, the lift assembly 14 of the lift device 10 includes a rotating portion, shown as turntable 80, and a series of movable portions or boom members, shown as boom sections 82. The turntable 80 is rotatably coupled to the chassis 20. A first lift actuator 1050 (e.g., a turntable actuator) is configured to cause the turntable 80 to rotate relative to the chassis 20 about a substantially vertical axis. The boom sections 82 extend between the turntable 80 and the implement interface 18. A first boom section 82 is pivotally coupled to the turntable 80, and one of the lift actuators 1050 causes the first boom section 82 to rotate relative to the turntable 80. A second boom section 82 is coupled to the implement interface 18. The other boom sections 82 extend between the first and second boom sections 82. The lift actuators 1050 cause the boom sections 82 to rotate and/or translate (e.g., telescope) relative to one another to reposition the implement interface 18 relative to the turntable 80.

### Implement Interface

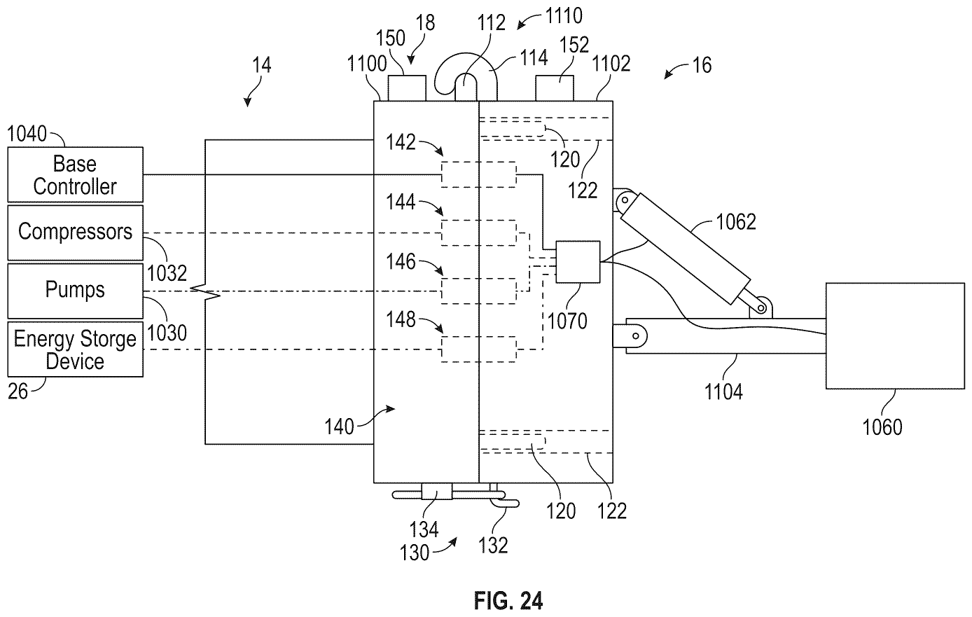

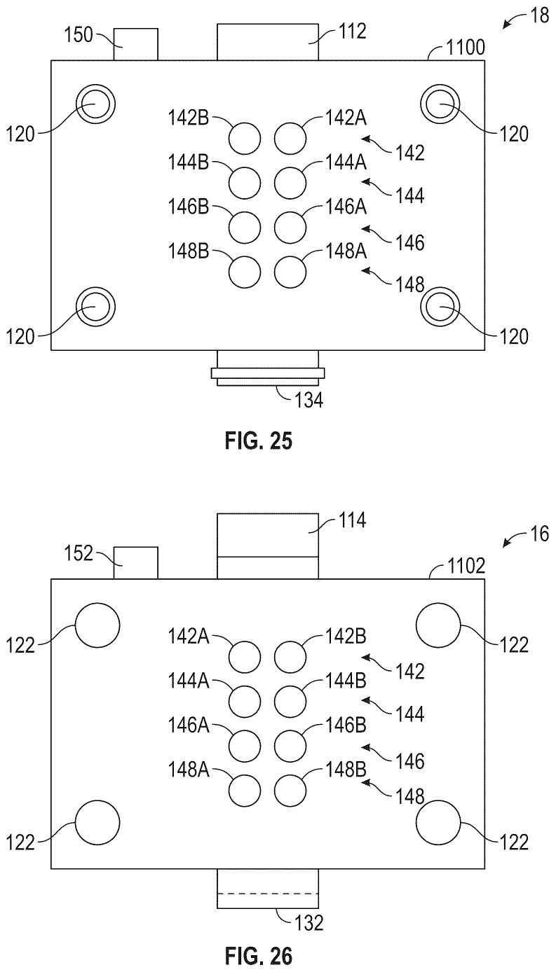

Referring to FIG. 24-26, the implement assembly 16 and the implement interface 18 are shown according to an exemplary embodiment. Specifically, FIG. 24 illustrates the implement assembly 16 assembled with the implement interface 18, FIG. 25 illustrates a portion of the implement interface 18 that engages the implement assembly 16, and FIG. 26 illustrates a portion of the implement assembly 16 that engages the implement interface 18. The implement interface 18 and the implement assembly 16 include various structures and components that facilitate removably coupling the implement assembly 16 to the lift device 10 and permitting transfer of electrical energy (e.g., power), data (e.g., sensor data, commands, etc.), and fluid to and from the implement assembly 16.

The implement interface 18 includes a structure, chassis, frame, fixture, or mount, shown as mounting plate 1100. The mounting plate 1100 is coupled to a distal end of the lift assembly 14. The mounting plate 1100 may serve as a primary structure to support other components of the implement interface 18. Similarly, the implement assembly 16 includes a structure, chassis, frame, fixture, or mount, shown as mounting plate 1102. Various components of the implement assembly 16 may be coupled to the mounting plate 1102, such that the mounting plate 1102 serves as a base of the implement assembly 16. When the implement assembly 16 is coupled to the implement interface 18, the mounting plate 1102 may abut (e.g., extend substantially parallel to) the mounting plate 1102.

As shown, the mounting plate 1100 and the mounting plate 1102 extend in generally vertical planes. The lift assembly 14 extends substantially perpendicular to the mounting plate 1100 in a rearward direction. The implement assembly 16 extends substantially perpendicular to the mounting plate 1102 in a forward direction. In other configurations and/or other embodiments, the mounting plate 1100 and/or the mounting plate 1102 are otherwise arranged. By way of example, the orientation of the mounting plate 1100 may be varied by the lift assembly 14 throughout operation (e.g., as controlled by the base controller 1070 using the lift actuators 1050).

The implement 1060 is movably coupled to mounting plate 1102 by a fixture or coupler, shown as implement arm 1104. As shown, the implement arm 1104 pivotally couples the implement 1060 to the mounting plate 1102. In other embodiments, the implement arm 1104 otherwise movably couples the implement 1060 to the mounting plate 1102. An implement actuator 1062 is coupled (e.g., pivotally coupled) to the mounting plate 1102 and the implement arm 1104 and configured to control movement of the implement 1060 and the implement arm 1104 relative to the mounting plate 1102.

As shown, the implement controller 1070 is coupled to the mounting plate 1102. The implement controller 1070 may be fixedly coupled to the mounting plate 1102, such that the implement controller 1070 is movable with the mounting plate 1102 (e.g., when the implement assembly 16 is removed from the implement interface 18).

The implement assembly 16 and the implement interface 18 further include a coupler, mount, or hanger assembly, shown as hook assembly 1110. The hook assembly 1110 includes a first engagement element or protrusion, shown as hook seat 112, and a second engagement element or receiver, shown as hook 114. As shown, the hook seat 112 is fixedly coupled to the mounting plate 1100, and the hook 114 is fixedly coupled to the mounting plate 1102. When the implement assembly 16 coupled to the implement interface 18, the hook 114 engages the hook seat 112 to support the implement assembly 16. Specifically, the hook seat 112 is received within the hook 114 to limit both (a) downward movement of the mounting plate 1102 relative to the mounting plate 1100 and (b) longitudinal movement of the mounting plate 1102 away from the mounting plate 1100. Accordingly, the hook assembly 1110 facilitates coupling the implement assembly 16 to the implement interface 18 and supporting (e.g., hanging) the implement assembly 16 with the implement interface 18.

As shown in FIG. 24-26, the implement interface 18 includes a series of slides, protrusions, or alignment members, shown as alignment rods 120. The alignment rods 120 are fixedly coupled to the mounting plate 1100 and spaced vertically and/or laterally from one another in a rectangular pattern. As shown, an alignment rod 120 is positioned near each corner of the mounting plate 1100. The alignment rods 120 extend substantially perpendicular to the mounting plate 1100 and substantially parallel to one another. In some embodiments, the distal ends of the alignment rods 120 are chamfered, radiused, or otherwise tapered to facilitate insertion.

The mounting plate 1102 of the implement assembly 16 defines a series of apertures, passages, or recesses, shown as alignment passages 122. The alignment passages 122 extend into the mounting plate 1102 from a face of the mounting plate 1102 that faces the mounting plate 1102. The alignment passages 122 may extend partway through the mounting plate 1102 (e.g., may be blind holes) or completely through the mounting plate 1102 (e.g., may be through holes). The alignment passages 122 are laid out in a similar pattern to the alignment rods 120, such that the alignment rods 120 each align with a corresponding alignment passage 122 when the mounting plate 1102 faces the mounting plate 1100. In other embodiments, one or more of the alignment rods 120 are coupled to the mounting plate 1102, and the mounting plate 1100 defines one or more of the alignment passages 122.

When the implement assembly 16 is assembled with the implement interface 18, the alignment rods 120 extend into the alignment passages 122. The alignment rods 120 engage the walls of the alignment passages 122 to limit movement of the mounting plate 1102 relative to the mounting plate 1102. Specifically, the alignment rods 120 limit lateral and vertical movement of the mounting plate 1102 relative to the mounting plate 1100. Accordingly, the alignment rods 120 facilitate coupling the implement assembly 16 to the implement interface 18 and supporting (e.g., hanging) the implement assembly 16 with the implement interface 18.

The implement assembly 16 and the implement interface 18 further include a coupler, mount, or lock assembly, shown as latch assembly 130. The latch assembly 130 includes a first engagement element or protrusion, shown as catch 132, and a second engagement element or receiver, shown as latch 134. As shown, the catch 132 is fixedly coupled to the mounting plate 1102, and the latch 134 is fixedly coupled to the mounting plate 1100. In other embodiments, the catch 132 is fixedly coupled to the mounting plate 1100, and the latch 134 is fixedly coupled to the mounting plate 1102. In some embodiments, the latch assembly 130 or the alignment rods 120 are omitted.

The latch 134 is configured to engage the catch 132 to selectively limit longitudinal movement of the mounting plate 1102 away from the mounting plate 1100. The latch 134 is selectively reconfigurable between a latched or locked configuration and an unlatched or unlocked configuration. In the unlocked configuration, the latch 134 is movable, permitting movement of the catch 132 away from the mounting plate 1100. In the unlocked configuration, the latch 134 is tightened, limiting (e.g., preventing) movement of the catch 132 away from the mounting plate 1100. By way of example, the latch 134 may hold the mounting plate 1102 firmly against the mounting plate 1100.

In some embodiments, the latch 134 is controlled by the implement controller 1070. By way of example, the latch 134 may include an electric actuator (e.g., a solenoid) and/or a hydraulic actuator (e.g., a hydraulic cylinder) that reconfigures the latch 134 between the locked configuration and the unlocked configuration. In some embodiments, the latch 134 is manually operated. By way of example, an operator may manually configure the latch 134 into the unlocked configuration or the locked configuration by moving a lever of the latch 134.

Referring still to FIG. 24-26, the implement assembly 16 and the implement interface 18 further include a series of fluid, electrical, and data connections, shown as connector assembly 140. A first portion of the connector assembly 140 is coupled to the mounting plate 1100, and a second portion of the connector assembly 140 is coupled to the mounting plate 1102. When the implement assembly 16 is assembled with the implement interface 18, the first and second portions of the connector assembly 140 engage one another to transfer signals (e.g., data, pressurized fluid such as gas or liquid, electrical signals, etc.) and communicatively couple the implement assembly 16 with the implement interface 18. When the implement assembly 16 is removed from the implement interface 18, the first and second portions of the connector assembly 140 separate from one another to disconnect the implement assembly 16 from the base assembly 12.

The connector assembly 140 includes a first series of signal connectors, shown as data connectors 142. As shown, the data connectors 142 include a pair of supply connectors 142A and a pair of return connectors 142B. A first supply connector 142A and return connector 142B are coupled to the mounting plate 1100 and communicatively (e.g., electrically) coupled to the base controller 1040. A second supply connector 142A and return connector 142B are coupled to the mounting plate 1102 and communicatively (e.g., electrically) coupled to the implement controller 1070. The data connectors 142 are positioned such that the supply connectors 142A engage one another and the return connectors 142B engage one another when the implement assembly 16 is coupled with the implement interface 18, forming a closed circuit between the base controller 1040 and the implement controller 1070. Accordingly, the data connectors 142 facilitate the transfer of information (e.g., data, electrical signals, etc.) between the base controller 1040 and the implement controller 1070. In other embodiments, the connector assembly 140 includes more or fewer data connectors 142.

The connector assembly 140 includes a second series of signal connectors, shown as gas connectors 144. As shown, the gas connectors 144 include a pair of supply connectors 144A and a pair of return connectors 144B. A first supply connector 144A and return connector 144B are coupled to the mounting plate 1100 and communicatively (e.g., fluidly) coupled to one the base assembly 12 (e.g., to the compressors 1032). A second supply connector 144A and return connector 144B are coupled to the mounting plate 1102 and communicatively (e.g., fluidly) coupled to the implement controller 1070. The implement controller 1070 may deliver compressed gas from the supply connector 144A to the implement 1060 and/or the implement actuator 1062. The implement controller 1070 may return compressed gas from the implement 1060 and/or the implement actuator 1062 to the base assembly 12 through the return connectors 144B. Alternatively, the implement controller 1070 may permit compressed gas to vent directly to the surrounding atmosphere.

The gas connectors 144 are positioned such that the supply connectors 144A engage one another and the return connectors 144B engage one another when the implement assembly 16 is coupled with the implement interface 18, forming fluid-tight connections between the base assembly 12 and the implement controller 1070. Accordingly, the gas connectors 144 facilitate the transfer of compressed gas (e.g., air, nitrogen, etc.) between the base assembly 12 and the implement controller 1070. When the mounting plate 1100 and the mounting plate 1102 separate from one another, the gas connectors 144 may disconnect from one another and disrupt the flow of gas. In some embodiments, the gas connectors 144 are quick disconnect connectors including check valves that automatically close when the gas connectors 144 are disconnected to prevent leakage of gas. In other embodiments, the connector assembly 140 includes more or fewer gas connectors 144.

The connector assembly 140 includes a third series of signal connectors, shown as liquid connectors 146. As shown, the liquid connectors 146 include a pair of supply connectors 146A and a pair of return connectors 146B. A first supply connector 146A and return connector 146B are coupled to the mounting plate 1100 and communicatively (e.g., fluidly) coupled to one the base assembly 12 (e.g., to the pumps 1030). A second supply connector 146A and return connector 146B are coupled to the mounting plate 1102 and communicatively (e.g., fluidly) coupled to the implement controller 1070. The implement controller 1070 may deliver pressurized liquid from the supply connector 146A to the implement 1060 and/or the implement actuator 1062. The implement controller 1070 may return liquid from the implement 1060 and/or the implement actuator 1062 to the base assembly 12 through the return connectors 146B.

The liquid connectors 146 are positioned such that the supply connectors 146A engage one another and the return connectors 146B engage one another when the implement assembly 16 is coupled with the implement interface 18, forming fluid-tight connections between the base assembly 12 and the implement controller 1070. Accordingly, the liquid connectors 146 facilitate the transfer of pressurized liquid (e.g., hydraulic oil, water, etc.) between the base assembly 12 and the implement controller 1070. When the mounting plate 1100 and the mounting plate 1102 separate from one another, the liquid connectors 146 may disconnect from one another and disrupt the flow of liquid. In some embodiments, the liquid connectors 146 are quick disconnect connectors including check valves that automatically close when the liquid connectors 146 are disconnected to prevent leakage of liquid. In other embodiments, the connector assembly 140 includes more or fewer liquid connectors 146.

The connector assembly 140 includes a fourth series of signal connectors, shown as power connectors 148. As shown, the power connectors 148 include a pair of supply connectors 148A and a pair of return connectors 148B. A first supply connector 148A and return connector 148B are coupled to the mounting plate 1100 and communicatively (e.g., electrically) coupled to the generators 1034 and/or the energy storage devices 26. A second supply connector 148A and return connector 148B are coupled to the mounting plate 1102 and communicatively (e.g., electrically) coupled to the implement controller 1070. The power connectors 148 are positioned such that the supply connectors 148A engage one another and the return connectors 148B engage one another when the implement assembly 16 is coupled with the implement interface 18, forming a closed circuit between the base assembly and the implement controller 1070. Accordingly, the power connectors 148 facilitate the transfer of electrical energy (e.g., AC power, DC power, etc.) between the base assembly 12 and the implement controller 1070. The implement controller 1070 may then direct the electrical energy to the implement 1060 and/or the implement actuator 1062 to power operation of the implement assembly 16. In other embodiments, the electrical energy bypasses the implement controller 1070 and passes directly to the implement 1060 and/or the implement actuator 1062. In other embodiments, the connector assembly 140 includes more or fewer power connectors 148.

Referring still to FIG. 24-26, the lift assembly 14 includes a sensor (e.g., an implement sensor, an implement locator, etc.), shown as implement sensor 150. As shown, the implement sensor 150 is coupled to the mounting plate 1100 and operatively coupled to the base controller 1040. The implement sensor 150 is configured to provide sensor data regarding the implement assembly 16. The base controller 1040 may utilize the sensor data to determine how or whether to interact with the implement assembly 16.

In some embodiments, the implement assembly 16 includes an indicator, tag, or registration mark, shown as implement tag 152. As shown, the implement tag 152 is coupled to the mounting plate 1102. The implement tag 152 may have one or more predetermined features (e.g., a shape and size, a color, a reflectivity (e.g., due to a retroreflective coating, etc.), a bar code or two-dimensional code, etc.). In other embodiments, the implement sensor 150 is onboard the implement assembly 16, and the implement tag 152 is onboard the implement interface 18.

In some embodiments, the sensor data indicates the position and/or orientation (e.g., pose) of the implement assembly 16 relative to the implement interface 18. By way of example, the implement sensor 150 may include a camera, an ultrasonic sensor, a LIDAR sensor, or other type of sensor configured to provide image data indicating a pose of the implement assembly 16. By analyzing the sensor data, the base controller 1040 may determine a distance and/or orientation of the implement assembly 16 relative to the implement sensor 150. By way of example, the base controller 1040 may analyze image data provided by a camera. The size of the implement assembly 16 in the image data may indicate a distance to the implement assembly 16, and the shape of the implement assembly 16 in the image data may indicate the orientation of the implement assembly 16. The position of the implement sensor 150 on the lift device 10 may be predetermined and stored in the memory 44. Accordingly, by analyzing the sensor data, the base controller 1040 may determine the pose (e.g., position and orientation) of the implement assembly 16 relative to the implement interface 18.

The implement tag 152 may facilitate identifying the position and/or orientation of the implement assembly 16. By way of example, the implement tag 152 may include a series of protrusions set at a fixed distance relative to one another that may be observed with a camera of the implement sensor 150. The apparent distance between the protrusions (e.g., a number of pixels between the protrusions in image data captured by the camera) may indicate the distance between the implement assembly 16 and the camera. Similarly, the relative orientations of the protrusions

In some embodiments, the sensor data includes implement identification data. The implement identification data may indicate a type of the implement assembly 16 (e.g., a category that the implement assembly 16 belongs to, a task that the implement assembly 16 is intended to perform or capable of performing, etc.). The implement identification data may include an identifier that uniquely identifies an implement assembly 16 (e.g., a serial number, an owner of the implement, etc.). By way of example, the implement sensor 150 may gather the implement identification data based on a shape of the implement assembly 16 (e.g., a pressure washer assembly having a different shape than a bucket or welding arm). By way of another example, the implement tag 152 may contain the identification data in a format that can be read or otherwise retrieved by the implement sensor 150 (e.g., as text, as a barcode, as two-dimensional code, as an RFID or NFC tag, etc.).

The implement interface 18 may facilitate the use of multiple different implement assemblies 16 with the same lift device 10 by permitting the implement assemblies 16 to be interchanged as desired. By way of example, a single lift device 10 may be provided with multiple different implement assemblies 16, each suitable for a different task or situation. The implement interface 18 includes certain features that interact with corresponding features generic to some or all of the implement assemblies 16, thereby facilitating interchanging the implement assemblies 16 without having to modify the implement interface 18.

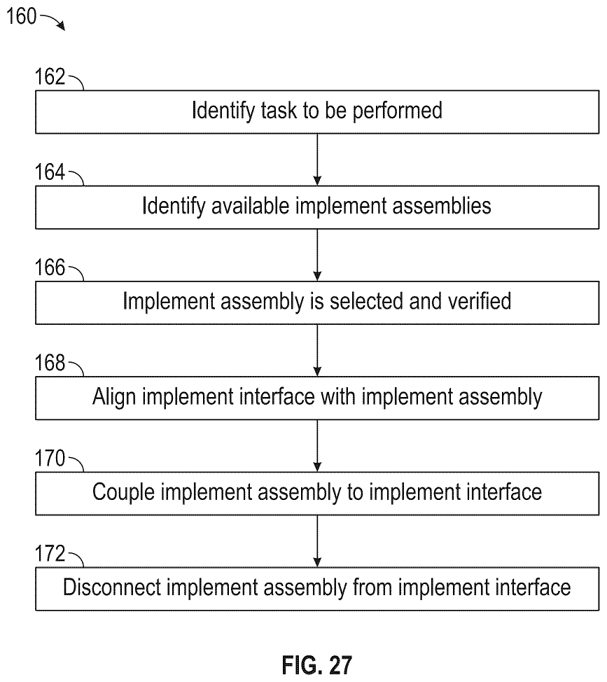

Referring to FIG. 27, a method 160 of operating the lift device 10 utilizing an implement assembly 16 is shown according to an exemplary embodiment. The method 160 includes a step 162 in which a task to be performed is identified. Specifically, the task may be identified by the base controller 1040. By way of example, a user may indicate the task to be performed through the user interface 48. By way of another example, the base controller 1040 may receive an indication of the task to be performed from an external device 47, such as a server or a user device, through the communication interface 46. The indication of the task to be performed may include capabilities required by an implement assembly 16 that performs the task. By way of example, if the task includes cleaning the exterior of a plane, the indication may require that the implement assembly 16 has the ability to spray water and/or soap. By way of example, if the task includes removing paint from a ship hull, the indication may require that the implement assembly 16 has the ability to spray an abrasive medium that is capable of removing the paint from the ship hull. By way of another example, if the task includes moving a pallet of material, the indication may require that the implement includes forks of sufficient size to support the pallet.

In step 164 of the method 160, one or more available implement assemblies are identified. Specifically, the base controller 1040 identifies implement assemblies 16 available to the lift device 10. By way of example, the base controller 1040 may use the implement identification data retrieved using the implement sensor 150 to determine which implement assemblies 16 are available. By way of another example, the base controller 1040 may receive a listing of available implement assemblies 16 from an external device 47 (e.g., a user device or server). By way of another example, the base controller 1040 may communicate wirelessly with the implement controllers 1070 of nearby implement assemblies 16 to determine which implement assemblies are available.

In step 166 of the method 160, one of the implement assemblies 16 is selected from the available implement assemblies 16 and verified. The implement assembly 16 may be verified after selection, or all of the available implement assemblies 16 may be verified, and the successfully verified implement assembly 16 may be presented for selection. The selection may be performed manually by a user (from a list provided through an external device 47 or a user interface 48) or automatically (e.g., by the base controller 1040). If multiple implement assemblies 16 are available and successfully verified (e.g., capable of performing the task), the base controller 1040 may automatically select the implement assembly 16 closest to the lift device 10.

The verification may confirm whether or not an implement assembly 16 is capable of and/or authorized to perform the task to be performed (e.g., a desired action). The verification may be performed by the base controller 1040, by an implement controller 1070 of one of the available implement assemblies 16, by an external device 47, or by some combination thereof. By way of example, the implement controllers 1070 of the available implement assemblies 16 may provide implement identification data to the base controller 1040, and the base controller 1040 may send that implement identification data to an external device 47 for verification.

In some embodiments, capabilities of a particular implement assembly 16 are predetermined and stored as a list of specifications. The list of specifications may be stored locally (e.g., in the memory 74 of the implement controller 1070, in the memory 44 of the base controller 1040, etc.). Additionally or alternatively, the list of specifications may be stored on an external device 47 (e.g., on a server). By way of example, the implement controller 1070 may transmit implement identification data (e.g., a serial number identifying an implement assembly 16) to the external device 47, and the external device 47 may return a list of specifications for the implement assembly 16.

The specifications my indicate the type of actions that can be performed (e.g., welding, spray painting, sand blasting, pressure washing, etc.) by a given implement assembly 16. The specifications may include additional information describing the capabilities of the implement assembly 16 (e.g., a thickness range of material that can be welded by the implement 1060, a type of material that can be welded by the implement 1060, the current paint color loaded into the implement 1060, a flow rate of fluid that the implement 1060 can provide, etc.).

The desired action may be compared with the list of specifications for the implement assembly 16 to determine if the desired action is within the capabilities of the implement assembly 16. By way of example, this comparison may be handled locally (e.g., by the implement controller 1070 or the base controller 1040) or remotely (e.g., by an external device 47). In response to a determination that the implement assembly 16 is capable of performing the desired action, the implement assembly 16 may be verified successfully. In response to a determination that the desired action falls outside of the capabilities of the implement assembly 16, the implement assembly 16 may not be verified successfully.

In some embodiments, the verification includes determining whether the implement assembly 16 is authorized for use with the lift device 10. The lift device 10 may be authorized for use with a predetermined group of implement assemblies 16. By way of example, a fleet management system of an external device 47 may store a list of authorized implement assemblies 16 for use with each lift device 10.

The authorization may be based on the capabilities of the lift device 10 to use the implement assembly 16. By way of example, each implement assembly 16 may have certain energy electrical requirements (e.g., current, voltage, AC vs DC, etc.), fluid flow requirements (e.g., type of fluid, flow rate, etc.), whether the implement assembly 16 has a layout that can engage the implement interface 18, etc. By way of another example, the authorization may be based on ownership of the implement assembly 16 and/or the lift device 10. In one such example, the lift device 10 is only authorized to use implement assemblies 16 that are owned by the same entity as the lift device 10. Such a configuration may prevent mixing of equipment between two companies at a jobsite.

In response to a determination that the implement assembly 16 is authorized for use with the lift device 10, the implement assembly 16 may be verified successfully. In response to a determination that the implement assembly 16 is not authorized for use with the lift device 10, the implement assembly 16 may not be verified successfully. In order to be verified, an implement assembly 16 may require (a) a determination that the implement assembly 16 is capable of performing a desired action, (b) a determination that the implement assembly 16 is authorized for use with the lift device 10, or (c) both a determination that the implement assembly 16 is capable of performing a desired action and a determination that the implement assembly 16 is authorized for use with the lift device 10.

In step 168 of the method 160, the implement interface 18 is aligned with the implement assembly 16. As shown in FIG. 24-26, the implement interface 18 may be aligned with the implement assembly 16 when the alignment rods 120 are aligned with the alignment passages 122. In some embodiments, the base controller 1040 controls operation of the base assembly 12 and/or the lift assembly 14 to place the implement interface 18 into alignment with the implement assembly 16. In some such embodiments, the base controller 1040 utilizes sensor data from the implement sensor 150 to provide position feedback and facilitate the alignment.

In step 170 of the method 160, the implement assembly 16 is coupled to the implement interface 18. As shown in FIG. 24-26, the implement interface 18 is pressed against the implement assembly 16 to seat the alignment rods 120 into the alignment passages 122. The alignment rods 120 engage the walls of the alignment passages 122 to maintain alignment, limiting lateral and vertical movement of the implement interface 18 relative to the implement assembly 16. Additionally or alternatively, the hook 114 may be engaged with the hook seat 112 to support the implement assembly 16. The latch assembly 130 may then be engaged (e.g., manually or by the base controller 1040) to fixedly couple the implement assembly 16 to the implement interface 18 and press the mounting plate 1100 against the mounting plate 1102.

With the mounting plates 1100 and 1102 pressed against one another, the corresponding connectors of the connector assembly 140 are forced into engagement with one another, forming their respective data, fluid, and/or electrical connections. Accordingly, the implement assembly 16 is fixedly and communicatively coupled to the implement interface 18.

In step 172 of the method 160, the implement assembly 16 is disconnected from the implement interface 18. By way of example, the latch assembly 130 may be disengaged, and the implement interface 18 may be pulled away from the implement assembly 16 to disconnect the implement assembly 16. In response, the connector assemblies 140 may automatically seal to prevent leakage of fluid. Step 172 may be performed, for example, when the task requiring a particular implement assembly 16 has been completed. Steps 162, 164, 166, 168, and 170 may again be performed to connect another implement assembly 16 suitable for a different task.

The arrangement of the alignment passages 122, the connector assembly 140, the hook assembly 1110, and the latch assembly 130 may be common across multiple of the implement assemblies 16, such that the implement interface 18 is compatible with all of the implement assemblies 16. By placing these features in common positions across multiple of the implement assemblies 16, the implement interface 18 may quickly switch between engagement with different implement assemblies 16 (e.g., suitable for different tasks) without having to modify the implement interface 18.

If one of the implements does not require one or more of (a) signal, (b) electrical energy, (c) compressed gas, or (d) pressurized liquid, the corresponding connector(s) of the implement assembly 16 may be omitted and replaced with a plug. The base controller 1040 may determine which of these are not required (e.g., based on implement identification data) and shut off the corresponding functions of the lift device 10. By way of example, the base controller 1040 may open contactors to halt transfer of electrical energy, may close a valve to halt the flow of compressed gas or pressurized liquid, and/or may turn off a pump or compressor.

Beneficially, the lift device 10 may be utilized with a variety of different implement assemblies 16. The implement interface 18 may provide a universal mounting solution that facilitates supporting an implement assembly 16 and transmitting signals, electrical energy, compressed gas, and pressurized liquid. By using a common implement interface 18, multiple implement assemblies 16 may be designed that rely on the same features of the implement interface 18 and are interchangeable with one another depending upon a desired application of the lift device 10.

### Implement Control Over Lift Device

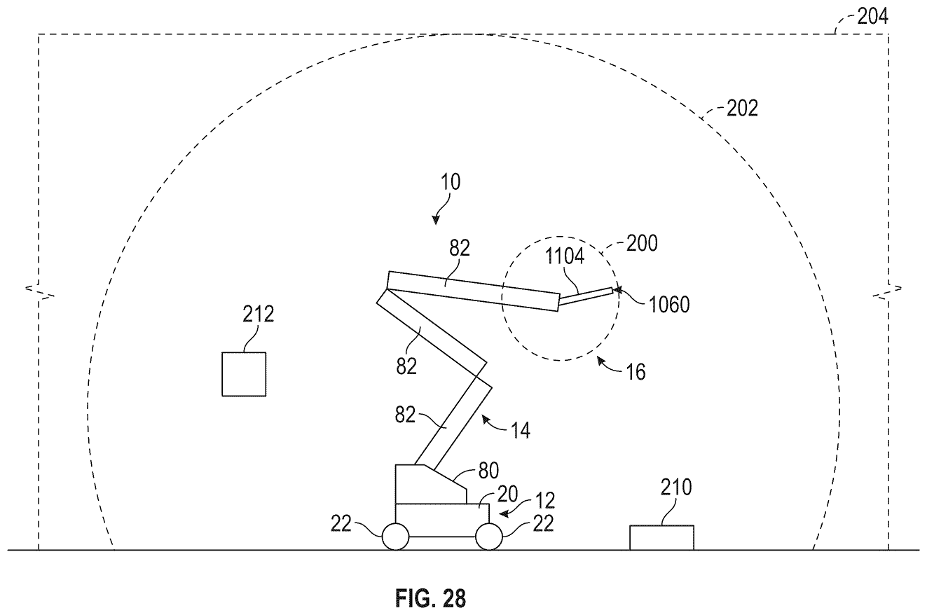

Referring to FIGS. 22 and 28, the base controller 1040 and the implement controller 1070 may cooperate to control operation of the lift device 10. For example, the implement controller 1070 may be configured to control the implement assembly 16 to perform a task (e.g., painting, pressure washing, sand blasting, welding, etc.). If the implement controller 1070 were to operate without communicating to the base controller 1040, the implement assembly 16 may be held in a substantially constant (e.g., unmoving) position by the lift assembly 14, limiting the operating range of the implement assembly 16 to a relatively small area (e.g., limited by how far the implement actuators 1062 are capable of moving the implement 1060 relative to the mounting plate 1102). However, the implement controller 1070 may beneficially cooperate with the base controller 1040 to cause the base assembly 12 and/or the lift assembly 14 to reposition the implement assembly 16 as necessary or desired throughout operation, providing for a much larger (e.g., unlimited) range of operation for the implement assembly 16. An example of this is illustrated in detail in FIG. 28.

FIG. 28 illustrates various operating ranges of the lift device 10, according to an exemplary embodiment. A zone or area 200 represents a range of locations that can be accessed by the implement 1060 by controlling the implement assembly 16 without moving the base assembly 12 or the lift assembly 14. As shown, the area 200 is generally centered about a distal end of the lift assembly 14 and is relatively small. The size and shape of the area 200 may be defined by the construction of the implement assembly 16 (e.g., the size and movement of the implement arm 1104 and the implement actuator 1062). In some embodiments, the area 200 is substantially spherical.

Using sensor data from the implement sensors 64, the implement controller 1070 may determine a strategy to control the implement actuator 1062 to achieve any desired position of the implement 1060 within the area 200. By way of example, the implement controller 1070 may receive a desired position of the implement 1060. The implement controller 1070 may determine a current position of the implement 1060 based on sensor data from the implement sensors 64 and/or a position of the implement interface 18 (e.g., provided by the base controller 1040). Using predetermined relationships (e.g., determined experimentally or geometrically) between the actions of each implement actuator 1062 and the resultant movements of the implement 1060, the implement controller 1070 may determine a set of actions to be performed by the implement actuator 1062 to reach the desired position of the implement 1060.

A zone or area 202 represents a range of locations that can be accessed by the implement 1060 by controlling the implement assembly 16 and the lift assembly 14 without moving the base assembly 12. As shown, the area 202 is generally centered about a proximal end of the lift assembly 14 (e.g., the turntable 80). In some embodiments, the area 200 is substantially spherical. The size and shape of the area 202 may be defined by the construction of the lift assembly 14 (e.g., the size and movement of the turntable 80, the boom sections 82, and the lift actuators 1050). As shown, the area 202 is larger than the area 200 and contains the area 200. Accordingly, the use of the lift assembly 14 to reposition the lift assembly 16 significantly increases the size of the operating range of the lift assembly 16.

Using sensor data from vehicle sensors 1052 and/or the implement sensors 64, the base controller 1040 and/or implement controller 1070 may determine a strategy to control the implement actuator 1062 and the lift actuators 1050 to achieve any desired position of the implement 1060 within the area 202. By way of example, the implement controller 1070 may receive a desired position of the implement 1060. The base controller 1040 and/or the implement controller 1070 may determine a current position of the implement 1060 based on sensor data from the vehicle sensors 1052 and/or the implement sensors 64. By way of example, the base controller 1040 may use the vehicle sensors 1052 to determine the position of the implement interface 18, and the implement controller 1070 may use the implement actuator 1062 to determine the current position of the implement 1060 relative to the implement interface 18. Using predetermined relationships between the actions of the lift actuators 1050 and the resultant movement of the implement interface 18, and between the actions of the implement actuators 1062 and the resultant movements of the implement 1060, the base controller 1040 and/or the implement controller 1070 may determine a set of actions to be performed by the lift actuators 1050 and the implement actuators 1062 to reach the desired position of the implement 1060. By way of example, the base controller 1040 may determine actions of the lift actuators 1050 to move the implement interface 18 into a desired position, and the implement controller 1070 may determine actions of the implement actuators 1062 to move the implement 1060 to the desired position when the implement interface 18 is in the corresponding desired position.

A zone or area 204 represents a range of locations that can be accessed by the implement 1060 by controlling the base assembly 12, the lift assembly 14, and the implement assembly 16. As shown, the area 204 is approximately the same height as the area 202 and extends infinitely horizontally. In some embodiments, the area 204 has a consistent thickness above the support surface (e.g., the ground). Accordingly, if the support surface is non-planar (e.g., curved), the shape of the area 204 may follow the shape of the support surface. The horizontal dimensions (e.g., the width and length) of the area 204 may be extend until the base assembly 12 encounters an obstacle that would prevent further movement of the base assembly 12 in that direction. The area 204 is wider and longer than the area 202 and contains the area 200 and the area 202. Accordingly, the use of the base assembly 12 to reposition the lift assembly 14 and the implement assembly 16 further increases the size of the operating range of the implement assembly 16.

Using sensor data from vehicle sensors 1052 and/or the implement sensors 64, the base controller 1040 and/or implement controller 1070 may determine a strategy to control the implement actuator 1062, the lift actuators 1050, and the prime mover 24 to achieve any desired position of the implement 1060 within the area 204. By way of example, the implement controller 1070 may receive a desired position of the implement 1060. The base controller 1040 and/or the implement controller 1070 may determine a current position of the implement 1060 based on sensor data from the vehicle sensors 1052 and/or the implement sensors 64. By way of example, the base controller 1040 may use the vehicle sensors 1052 to determine the position of the implement interface 18, and the implement controller 1070 may use the implement actuator 1062 to determine the current position of the implement 1060 relative to the implement interface 18. Using predetermined relationships between the actions of the lift actuators 1050 and the prime mover 24 and the resultant movement of the implement interface 18, and between the actions of the implement actuators 1062 and the resultant movements of the implement 1060, the base controller 1040 and/or the implement controller 1070 may determine a set of actions to be performed by the lift actuators 1050, the prime mover 24, and the implement actuators 1062 to reach the desired position of the implement 1060. By way of example, the base controller 1040 may determine actions of the lift actuators 1050 and the prime mover 24 to move the implement interface 18 into a desired position, and the implement controller 1070 may determine actions of the implement actuators 1062 to move the implement 1060 to the desired position when the implement interface 18 is in the corresponding desired position.

FIG. 28 further includes a pair of objects, obstructions, or obstacles, shown as base obstacle 210 and lift obstacle 212. The base obstacle 210 is positioned to engage the base assembly 12 (e.g., on the ground) and obstructs a path of the base assembly 12. When in contact with the base assembly 12, the base obstacle 210 may prevent further movement of the base assembly 12 in a corresponding direction. Accordingly, the base obstacle 210 may limit the shape and/or size of the area 204. The lift obstacle 212 is positioned to engage the lift assembly 14 (e.g., above the ground) and obstructs a path of the lift assembly 14. When in contact with the lift assembly 14, the lift obstacle 212 may prevent further movement of the lift assembly 14 in a corresponding direction. Accordingly, the lift obstacle 212 may limit the shape and/or size of the area 202 and the area 204.

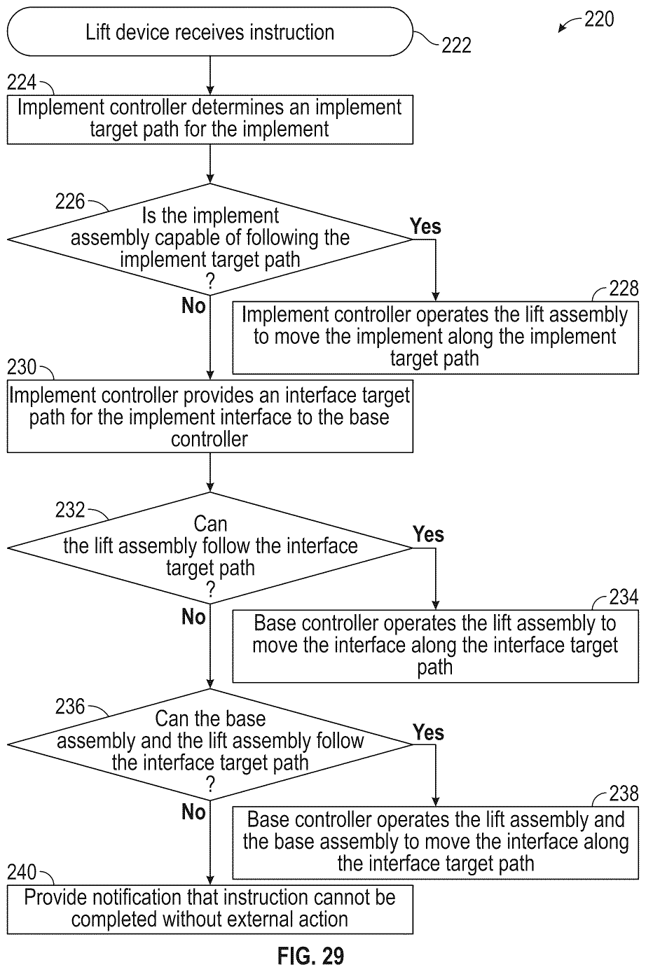

Referring to FIG. 29, a method 220 for operating the lift device 10 is shown according to an exemplary embodiment. The method 220 may include repositioning or otherwise moving the implement 1060 to facilitate performing a task. The method 220 may be performed autonomously (e.g., without direct operator input) and/or based on a user input.

In step 222, the lift device 10 receives an instruction. The instruction may request a specific action of the lift device 10. By way of example, the instruction may indicate a requested movement of the implement 1060. By way of another example, the instruction may indicate a requested action to be performed by the implement 1060.

In some embodiments, the instruction is provided by a user or operator of the lift device 10. By way of example, the user may provide the instruction through the user interface 48 and/or the user interface 78. In some embodiments, the instruction is provided by an external device 47. By way of example, the user may provide the instruction through a user device (e.g., a smartphone, a tablet, etc.). By way of another example, a remote server may generate the instruction (e.g., based on operation of a jobsite management system).

In some embodiments, the instruction requests a specific movement of the implement 1060. By way of example, the instruction may provide a requested speed and direction of movement for the implement 1060. In one such example, the implement 1060 is a platform for supporting an operator, and the operator indicates a desired direction of motion. An operator may provide such an instruction, for example, by pressing a joystick of the user interface 78 toward the desired direction.

By way of another example, the instruction may provide a target location or path for the implement 1060. In one such example, a list of desired positions for the implement 1060 is provided by a user (e.g., through the user interface 78). In another such example, the implement controller 1070 identifies a list of desired positions for the implement 1060. The implement controller 1070 may utilize sensor data from the vehicle sensors 1052 and/or the implement sensors 64 to determine a target path around an object in the surrounding environment. By way of example, the implement controller 1070 may use the sensor data to identify a position of an obstacle and generate a target path that avoids the obstacle. By way of another example, the implement controller 1070 may use sensor data to identify a nearby surface (e.g., a window, a wall, a ship hull, an aircraft fuselage, etc.) and generate a target path that maintains a constant, predetermined distance between the implement 1060 and the surface. By way of another example, the implement controller 1070 may receive a model of a surface (e.g., a computer aided design (CAD) model of a building or structure including a surface) and generate a target path that follows the surface.

The instruction may indicate a speed and/or dwell time for one or more target locations. By way of example, the instruction may indicate a speed with which the implement 1060 should travel between two target locations. By way of another example, the instruction may indicate a speed that the implement 1060 should be traveling at when the implement 1060 reaches a target location. By way of another example, the instruction may indicate an amount of time that the implement should remain at a target location (e.g., a dwell time for the target location). In this way, the instruction may indicate the target path of the implement 1060, as well as the timing of the implement 1060 moving along the target path. When controlling for a dwell time at a target location, the implement controller 1070 may control the lift device 10 to maintain the implement 1060 at the desired location, even in response to external forces that attempt to move the implement 1060. By way of example, the implement controller 1070 may control the lift device 10 to counteract deflection from wind, from blowback forces when the implement 1060 is spraying, etc.

In some embodiments, the instruction includes a requested action to be performed by the implement 1060. The implement controller 1070 may determine a target location or path for the implement 1060 based on the requested action to be performed. The determined target location or target path may facilitate completion of the requested action.

By way of example, the instruction may include a request for pressure washing an area of a surface (e.g., a plane fuselage, a window, a wall, etc.), and the implement 1060 may include a pressure washing nozzle. In such an example, the implement controller 1070 may generate a target path for the implement 1060 that permits the pressure washing nozzle to clean the indicated area. For example, the implement controller 1070 may generate a target path that moves the implement 1060 in an oscillating or zig-zag pattern across the area. The speed of the implement 1060, the distance between adjacent oscillations of the target path, the distance between the target path of the implement 1060 and the surface, and/or other characteristics of the target path may be determined based on predetermined characteristics of the pressure washing nozzle (e.g., a spray angle, an optimal spray distance, etc.).

By way of another example, the instruction may include a request for placing a weld along a component, and the implement 1060 may include a welder. In such an example, the implement controller 1070 may generate a target path for the implement 1060 that causes a distal portion of the welder to move along a desired path for the weld identified in the instruction. The speed of the implement 1060, the orientation of the implement 1060, the distance between the target path of the implement 1060 and the desired path for the weld, and/or other characteristics of the target path may be determined based on predetermined characteristics of the welder (e.g., a feed rate of the welding wire, etc.).

In step 224 of the method 220, the implement controller 1070 determines a target path of the implement 1060 (i.e., an implement target path). Specifically, the implement controller 1070 determines the implement target path based on the instruction for the lift device 10 received in step 222. In some embodiments, the instruction for the lift device 10 provides the implement target path directly. In other embodiments, the implement controller 1070 analyzes the instruction to determine the implement target path. By way of example, the instruction may provide a target location, and the implement controller 1070 may generate an implement target path that brings the implement to the target location. By way of another example, the instruction may indicate a desired action for the implement 1060, and the implement controller 1070 may generate an implement target path that facilitates or permits completion of the desired action.

In step 226 of the method 220, the implement controller 1070 determines whether the implement assembly 16 is capable of following the implement target path. Specifically, the implement controller 1070 may analyze the implement target path and determine whether a range of motion the implement assembly 16 (e.g., the area 200) is capable of following the implement target path without moving the lift assembly 14 or the base assembly 12. If the implement assembly 16 is capable of following the implement target path without moving the lift assembly 14 or the base assembly 12, the implement controller 1070 may control the implement assembly 16 to follow the implement target path without communicating with (e.g., providing commands to) the base controller 1040.

In some embodiments, the implement controller 1070 determines whether the implement assembly 16 is capable of following the implement target path based on a range of motion of the implement assembly 16. By way of example, the range of motion of the implement assembly 16 may be the area 200. The range of motion of the implement assembly 16 may be predetermined and stored in the memory 74. By way of example, the implement controller 1070 may determine that the implement assembly 16 is not capable of following the target path without moving the lift assembly 14 or the base assembly 12 in response to a determination that the implement target path extends outside of the area 200.

In some embodiments, the implement controller 1070 determines whether the implement assembly 16 is capable of following the implement target path based on detection of an obstacle. By way of example, the sensor data from the vehicle sensors 1052 and/or the implement sensors 64 may be used to detect a base obstacle 210 or a lift obstacle 212 positioned to limit movement of the implement assembly 16. For example, the sensor data may indicate a lift obstacle 212 within the area 200 that prevents the implement assembly 16 from reaching a portion of the area 200. The implement controller 1070 may determine that the implement assembly 16 is not capable of following the implement target path without moving the lift assembly 14 or the base assembly 12 in response to a determination that the target path extends into the portion of the area 200 that is blocked by the lift obstacle 212.

If the implement controller 1070 determines that the implement assembly 16 is capable of following the implement target path, the implement controller 1070 determines “yes” in step 226 and proceeds to step 228 of the method 220. In step 228 of the method, the implement controller 1070 operates the lift assembly 16 to move the implement 1060 along the implement target path. This may include navigating the lift assembly 14 to avoid any base obstacles 210 and/or lift obstacles 212 nearby (e.g., as detected using the vehicle sensors 1052 and/or the implement sensors 64). The specific actions of the lift assembly 14 required to avoid the obstacles may be identified by the base controller 1040 (e.g., without a determination being made by the implement controller 1070). Because the target path falls entirely within the range of motion of the implement assembly 16, the implement controller 1070 is capable of controlling the implement assembly 16 to move along the implement target path without requesting movement of the base assembly 12 and/or the lift assembly 14 by the base controller 1040.

If the implement controller 1070 determines that the implement assembly 16 is incapable of following the implement target path, the implement controller 1070 determines “no” in step 226 and proceeds to step 230 of the method 220. In step 230 of the method, the implement controller 1070 provides a command to the base controller 1040 including a target path for a distal end portion of the lift assembly 14 (e.g., the implement interface 18). For clarity, this target path is referred to as an “interface target path.” Because the implement target path for the implement 1060 extends outside of the range of motion of the implement assembly 16, movement of the base assembly 12 and/or the lift assembly 14 by the base controller 1040 may be required to complete the movement of the implement 1060 along the implement target path.

In step 232 of the method 220, the base controller 1040 determines whether the lift assembly 14 is capable of following the interface target path provided by the implement controller 1070 without the use of the base assembly 12. Specifically, the base controller 1040 may analyze the interface target path and determine whether a range of motion the lift assembly 14 (e.g., the area 202) is capable of following the interface target path without moving the base assembly 12. If the lift assembly 14 is capable of following the interface target path without moving the base assembly 12, the base controller 1040 may control the lift assembly 14 to follow the interface target path based on the command.

In some embodiments, the base controller 1040 determines whether the lift assembly 14 is capable of following the interface target path without the use of the base assembly 12 based on a range of motion of the lift assembly 14. By way of example, the range of motion of the lift assembly 14 may be the area 202. The range of motion of the lift assembly 14 may be predetermined and stored in the memory 44. By way of example, the base controller 1040 may determine that the lift assembly 14 is not capable of following the interface target path without moving the base assembly 12 in response to a determination that the target path extends outside of the area 202.

In some embodiments, the base controller 1040 determines whether the lift assembly 14 is capable of following the interface target path without use of the base assembly 12 based on detection of an obstacle. By way of example, sensor data from the vehicle sensors 1052 and/or the implement sensors 64 may detect a base obstacle 210 or a lift obstacle 212 positioned to limit movement of the lift assembly 14. For example, the sensor data may indicate a lift obstacle 212 within the area 202 that prevents the lift assembly 14 from reaching a portion of the area 202. The base controller 1040 may determine that the lift assembly 14 is not capable of following the interface target path without moving the base assembly 12 in response to a determination that the interface target path extends into the portion of the area 202 that is blocked by the lift obstacle 212.

If the base controller 1040 determines that the lift assembly 14 is capable of following the interface target path, the base controller 1040 determines “yes” in step 232 and proceeds to step 234 of the method 220. In step 234 of the method, the base controller 1040 operates the lift assembly 14 to move the implement interface 18 along the interface target path. Because the interface target path falls entirely within the range of motion of the lift assembly 14, the base controller 1040 is capable of controlling the lift assembly 14 to move along the target path without moving the base assembly 12. Throughout this process, the base controller 1040 may provide positional feedback (e.g., from the vehicle sensors 1052) to the implement controller 1070. This feedback may facilitate the implement assembly 16 locating itself in space and may thereby facilitate the implement assembly 16 moving the implement 1060 along the implement target path.

If the base controller 1040 determines that the lift assembly 14 is incapable of following the interface target path without use of the base assembly 12, the base controller 1040 determines “no” in step 232 and proceeds to step 236 of the method 220. Because the interface target path extends outside of the range of motion of the lift assembly 14, movement of the base assembly 12 may be required to complete the movement of the lift assembly 14 along the target path.

In step 236 of the method 220, the base controller 1040 determines whether the lift assembly 14 and the base assembly 12 together are capable of following the interface target path provided by the implement controller 1070. Specifically, the base controller 1040 may analyze the interface target path and determine whether a range of motion the base assembly 12 and the lift assembly 14 (e.g., the area 204) is capable of following the interface target path. If the base assembly 12 and the lift assembly 14 are capable of following the interface target path, the base controller 1040 may control the base assembly 12 and the lift assembly 14 to follow the interface target path based on the command.

In some embodiments, the base controller 1040 determines whether the base assembly 12 and the lift assembly 14 are capable of following the interface target path based on a range of motion of the base assembly 12 and the lift assembly 14. By way of example, the range of motion of the base assembly 12 and the lift assembly 14 may be the area 204. The range of motion of the base assembly 12 and the lift assembly 14 may be predetermined and stored in the memory 44. By way of example, the base controller 1040 may determine that the base assembly 12 and the lift assembly 14 are not capable of following the interface target path in response to a determination that the target path extends outside of the area 204.

In some embodiments, the base controller 1040 determines whether the base assembly 12 and the lift assembly 14 are capable of following the interface target path based on detection of an obstacle. By way of example, sensor data from the vehicle sensors 1052 and/or the implement sensors 64 may detect a base obstacle 210 or a lift obstacle 212 positioned to limit movement of the base assembly 12 or the lift assembly 14. For example, the sensor data may indicate a base obstacle 210 within the area 204 that prevents the base assembly 12 from reaching a portion of the area 204. The base controller 1040 may determine that the base assembly 12 is not capable of following the interface target path in response to a determination that the interface target path extends into the portion of the area 204 that is blocked by the base obstacle 210.

If the base controller 1040 determines that the base assembly 12 and the lift assembly 14 are capable of following the interface target path, the base controller 1040 determines “yes” in step 236 and proceeds to step 238 of the method 220. In step 238 of the method, the base controller 1040 operates the base assembly 12 and the lift assembly 14 to move the implement interface 18 along the interface target path. Because the interface target path falls entirely within the range of motion of the base assembly 12 and the lift assembly 14, the base controller 1040 is capable of controlling the base assembly 12 and the lift assembly 14 to move along the interface target path. This may include navigating the base assembly and/or the lift assembly 14 to avoid any base obstacles 210 and/or lift obstacles 212 (e.g., as detected using the vehicle sensors 1052 and/or the implement sensors 64). The specific actions of the base assembly 12 and/or the lift assembly 14 required to avoid the obstacles may be identified by the base controller 1040 (e.g., without a determination being made by the implement controller 1070). Throughout this process, the base controller 1040 may provide positional feedback (e.g., from the vehicle sensors 1052) to the implement controller 1070. This feedback may facilitate the implement assembly 16 locating itself in space and may thereby facilitate the implement assembly 16 moving the implement 1060 along the implement target path.

If the base controller 1040 determines that the base assembly 12 and the lift assembly 14 are incapable of following the interface target path, the base controller 1040 determines “no” in step 236 and proceeds to step 240 of the method 220. In step 240, the lift device 10 (e.g., the base controller 1040 and/or the implement controller 1070) provide a notification that the instruction received in step 222 cannot be completed without external action. The notification may be provided to the implement controller 1070. Additionally or alternatively, the notification may be provided through an external device 47, through a user interface 48, or through another interface. By way of example, the notification may include a text message on a use device. By way of another example, the notification may be a status update to a fleet management system (e.g., on a server) indicating that the lift device 10 is stuck and cannot complete the instruction.

In some embodiments, the notification includes a suggested action that may be performed to facilitate completing the instruction. By way of example, the notification may include a request for an operator or other personnel to remove a base obstacle 210 or a lift obstacle 212. By way of another example, the notification may include alternative suggested path that would avoid a base obstacle 210 or a lift obstacle 212. In response to receiving the notification, the method 220 may return to step 230 and generate another interface target path for the base controller 1040 that avoids the base obstacle 210 and/or the 212.

Beneficially, the lift device 10 may be utilized with a variety of different implement assemblies 16. The implement interface 18 may provide a universal mounting solution that facilitates communication between the different implement assemblies 16 and the lift device 10. Throughout operation, the implement controller 1070 may simply indicate a desired path for the implement interface 18 to the base controller 1040, and the base controller 1040 may translate the desired path into specific actions of the base assembly 12 and/or the lift assembly 14. The base controller 1040 may continuously provide positional feedback to the implement controller 1070 and indicate if a desired movement (e.g., an interface target path) cannot be followed due to an obstacle. The method 220 greatly simplifies the process of controlling the lift device 10 relative to a system where one controller is required determine how to control each actuator of a lift device individually. An organization that manufactures implement assemblies 16 may utilize a lift device 10 with minimal development devoted toward the lift assembly 14 or the base assembly 12, freeing up resources to focus on developing an implement assembly 16 for a specific application (e.g., paint spraying, sand blasting, welding, drywall finishing, etc.).

### Autonomous Jobsite Control

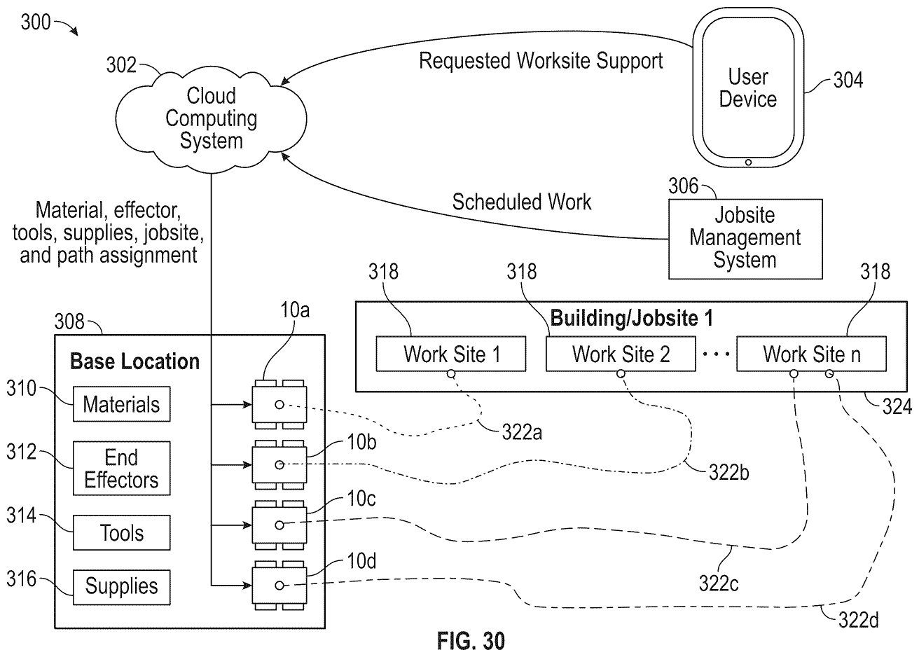

Referring to FIG. 30-35, the lift devices 10 can be implemented in an autonomous jobsite control system 300. The autonomous jobsite control system 300 is configured to plan and deploy worksite support for various technicians, contractors, etc., at a construction site. For example, the construction site may be a building construction site. During the construction phase of buildings or other structures, various materials (e.g., electrical cables, conduit, pipes, steel structural members, etc.), various tools (e.g., welders, plumbing tools, saws, etc.) and supplies (e.g., fasteners, plumbing cement, welding wire or sticks, etc.) are required on-site (e.g., at various worksites throughout the jobsite or building). Technicians (e.g., welders, carpenters, electricians, plumbers, drywallers, roofers, etc.) use the materials, tools, and supplies in order to perform various tasks or phases of construction of the building. Accordingly, it is advantageous to have the needed materials, tools, and supplies on-location in advance of the arrival of the technicians so that the construction of the building or structure is optimized without requiring the technicians to spend time moving materials, equipment, and supplies to the worksites.

The autonomous jobsite control system 300 implements the lift devices 10 as a fleet of autonomous mobile robots (“AMRs”) in order to autonomously prepare worksites in advance of the arrival of technicians. The autonomous jobsite control system 300 includes a cloud computing system 302, a user device 304, a jobsite management system 306, and a base location 308. The cloud computing system 302 is configured to receive requested jobsite/worksite support from the user device 304, and to receive scheduled jobsite/worksite support from the jobsite management system 306. The jobsite management system 306 can be implemented on the cloud computing system 302 and may be a jobsite system that includes various plans and phases of the construction, with a schedule of required jobs and crews of workers at various locations in the jobsite or building. The user device 304 can run a mobile application and allows a worker to provide manual requests for additional support or to provide manual requests for worksite support that is not included in the schedule of the jobsite management system 306.

In some embodiments, certain types of jobs (e.g., welding jobs at heights, installing electrical wiring at heights, etc.) may require different lift devices or implements (e.g., different end effectors). In preparation for the work at a worksite, the autonomous jobsite control system 300 (e.g., the cloud computing system 302) can also determine an end effector and lift device 10 to place at the worksite for use by the workers to complete their work.

The cloud computing system 302 is configured to obtain the requested worksite support from the user device 304 and determine materials, one or more end effectors, one or more tools, and supplies to be provided to the worksite for which the support is requested. The cloud computing system 302 can also determine a route (e.g., a path) for a selected one of the lift devices 10 to travel about the base location 308 to collect the needed materials, end effectors, tools, and supplies. The cloud computing system 302 also determines a route or path for the selected one of the lift devices 10 to travel from the base location 308 to an assigned worksite 318 at the jobsite 324. The jobsite 324 can be a building, construction project, work area, etc. The jobsite 324 includes various worksites 318 positioned throughout the jobsite 324. For example, the worksites 318 can be different rooms in a building that is under construction, different locations along a foundation of a building, different locations on an exterior of a building, different rooms on various floors of a building, etc. The cloud computing system 302 can store a map of the jobsite 324 and can determine the path or route through the jobsite 324 to the assigned worksite 318 for the lift device 10. The cloud computing system 302 performs the same functions (e.g., determining needed materials, end effectors, tools, supplies, path/route, etc.) for scheduled work obtained from the jobsite management system 306 and provides the needed materials, end effectors, tools, supplies, assigned worksite 318, and path/route to collect and deliver to the assigned worksite 318 to assigned lift devices 10. The map stored in the cloud computing system 302 can be determined or updated by the cloud computing system 302 using global positioning data obtained from the lift devices 10 and image data obtained from the lift devices 10. For example, the cloud computing system 302 can obtain a plan of the jobsite and can generate a three-dimensional map of the jobsite 324 based on the image data and global positioning data obtained from the lift devices 10. The cloud computing system 302 can then determine the paths for the lift devices 10 to the worksites 318 using the map in order to provide navigation and obstacle avoidance for the lift devices 10 to transport to the assigned worksites 318.

For example, as shown in FIG. 30, a first one of the lift devices 10a is assigned to a first worksite 318, and is provided an assigned path 322a in order to transport to the first worksite 318. Similarly, a second one of the lift devices 10b is assigned to a second worksite 318 and is provided an assigned path 322b to transport to the second worksite 318. A third and fourth of the lift devices 10c, and 10d, are assigned to an nth worksite 318 and are provided an assigned path 322c and an assigned path 322d. The lift devices 10 use the assigned paths 322 and transport along the paths 322 from the base location 308 to the assigned worksites 318.

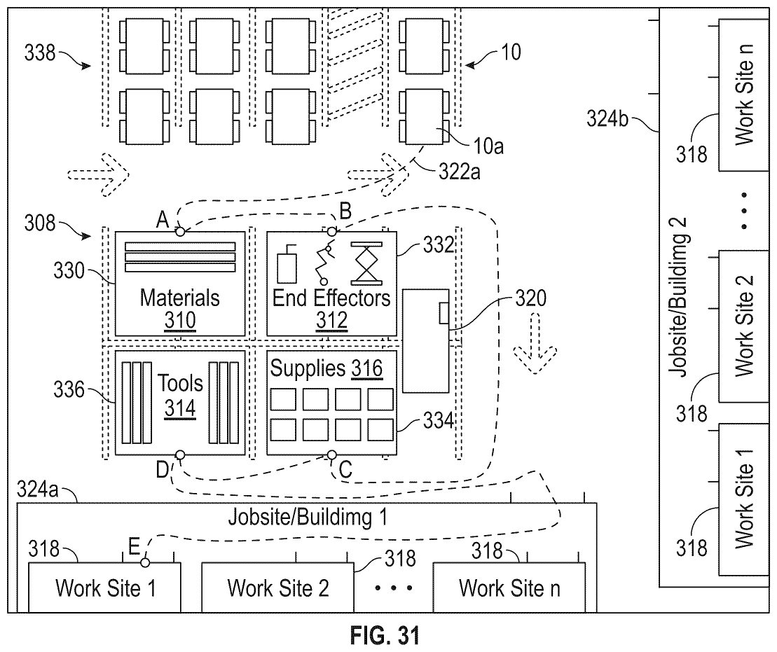

Referring to FIG. 31, the base location 308 can be a staging site for the lift devices 10 in a parking lot or other area nearby one or more jobsites. For example, as shown in FIG. 31, the base location 308 is disposed in a parking lot proximate a first jobsite or building construction 324a, and a second jobsite or building construction 324b, each of which includes multiple worksites 318. The base location 308 includes a storage area 338 for the lift devices 10 (e.g., the AMRs). The lift devices 10 can hibernate at the storage area 338 while waiting deployment by the cloud computing system 302. The base location 308 also includes a storage area 330 for the materials 310 (e.g., raw construction materials such as wire, conduit, steel, bricks, pipes, etc.), a storage area 332 for the end effectors 312 (e.g., implement assemblies 16 such as robotic claws, lift assemblies, welders, generators, etc.), a storage area 336 for tools 314 (e.g., nail guns, generators, power tools, hand tools, etc.), and a storage area 334 for supplies 316 (e.g., nails, screws, fasteners, welding wire, plumbing cement, concrete, etc.). The cloud computing system 302 is configured to determine the path for the lift devices 10 to transport to each of the storage areas 330-336 and then transport to the assigned or end location (e.g., the worksite within the jobsite 324).

For example, as shown in FIG. 31, the first lift device 10a is assigned the path 322a. The path 322a includes multiple segments or sections. For example, the path 322a includes a first section from a current location of the lift device 10a to a point A at the first storage area 330 where the materials 310 are stored. The lift device 10a can be loaded automatically by local robotic implements at the first storage area 330 or can be loaded by workers at the first storage area 330. The path 322a includes a second section from the point A at the first storage area 330 to a point B at the second storage area 332 where the end effectors 312 are stored. The lift device 10 can automatically detect and attach to one of the end effectors 312 as needed for the work at the worksite 318 at the second storage area 332. In some embodiments, the lift device 10 is configured to transport to the second storage area 332 first in order to obtain an end effector and be capable of automatically loading the materials 310 onto the lift device 10.

The path 322a also includes a third section from the point B to a point C at the storage area 334 where the supplies 316 are located. The lift device 10 can transport to the storage area 334 where the supplies 316 are located and obtain supplies 316 needed for the work at the worksite (e.g., autonomously using an implement to load the supplies 316, or loaded manually by workers). The path 322a also includes a fourth section from the point C to a point D at the storage area 336 where the tools 314 are located. The lift device 10a can transport to the storage area 336 at the point D where the tools 314 are located, obtain the tools needed for the work, and transport along the path 322a from the point D to a point E at the assigned worksite 318.

In some embodiments, the path 322a is split into multiple paths from the worksite 318 to the base location 308. For example, if the lift device 10a does not have sufficient storage capacity to carry all the materials 310, supplies 316, and tools 314 required for the work at the worksite 318, the lift device 10a may make multiple trips back and forth from the worksite 318 to the base location 308 to deliver all of the materials 310, supplies 316, and tools 314 to the worksite 318. In some embodiments, the cloud computing system 302 can dispatch multiple lift devices 10 to deliver materials 310, tools 314, and supplies 316 to the worksite 318.

Referring still to FIG. 31, the base location 308 can include a charging station 320. The cloud computing system 302 can track charge levels of batteries of the lift devices 10 and can dispatch the lift devices 10 to the charging station 320 as needed. In some embodiments, the charging station 320 is a stop along the path 322a to the worksite 318 so that the lift devices 10 arrive at the worksites 318 with as full a charge as possible. In some embodiments, during the course of work at the worksite 318, as the lift device 10 at the worksite 318 decreases in charge level, the cloud computing system 302 is configured to dispatch a fully charged lift device 10 to the worksite 318 so that the workers at the worksite 318 can use the fully charged lift device 10 and the lift device 10 at the worksite 318 decreasing in charge level returns to the charging station 320 for charging.

It should be understood that the dispatch and path 322a of the lift device 10a is shown for illustrative purposes. The cloud computing system 302 is configured to determine paths 322, needed materials 310, end effectors 312, tools 314, and supplies 316 for each lift device 10 as required by worksite. In this way, the cloud computing system 302 can coordinate the dispatch and preparation of worksites 318 at one or more jobsites 324 such that when workers arrive to complete their tasks, the site is prepared and all required materials 310, tools 314, supplies 316, and lift devices 10 with required end effectors 312 are on-site and ready for use.

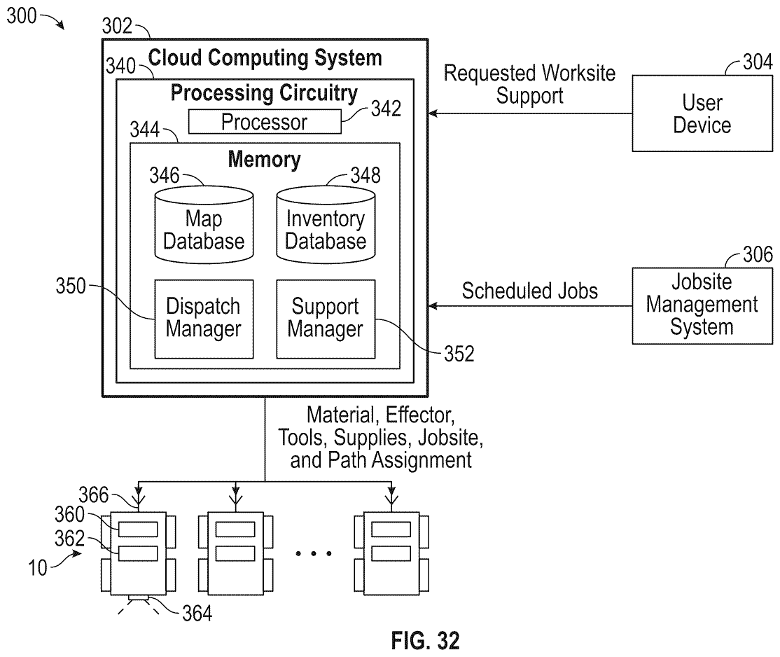

Referring to FIG. 32, the autonomous jobsite control system 300 is shown in greater detail, according to some embodiments. The cloud computing system 302 includes processing circuitry 340 including a processor 342 and memory 344. The processing circuitry 340 can be communicably connected with a communications interface of the cloud computing system 302 (e.g., a telemetry or transceiver, etc.) such that the processing circuitry 340 and the various components thereof can send and receive data via the communications interface. The processor 342 can be implemented as a general purpose processor, an application specific integrated circuit (ASIC), one or more field programmable gate arrays (FPGAs), a group of processing components, or other suitable electronic processing components.

The memory 344 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 344 can be or include volatile memory or non-volatile memory. The memory 344 can include database components, object code components, script components, or any other type of information structure for supporting the various activities and information structures described in the present application. According to some embodiments, the memory 344 is communicably connected to the processor 342 via the processing circuitry 340 and includes computer code for executing (e.g., by at least one of processing circuitry 340 or processor 342) one or more processes described herein.

The cloud computing system 302 includes a map database 346, an inventory database 348, a dispatch manager 350, and a support manager 352. The inventory database 348 stores inventory data regarding the type and quantity of materials 310 at the storage area 330, the type and quantity of end effectors 312 at the storage area 332, the type and quantity of tools 314 at the storage area 336, and the type and quantity of supplies 316 at the storage area 334. The map database 346 can store plans of the jobsites 324 including walls, travel paths, vertical heights of ceilings, etc., and locations of the worksites 318 within the jobsites 324. The support manager 352 is configured to use the requested worksite support from the user device 304 or the scheduled jobs from the jobsite management system 306 and the available inventory as indicated by the inventory database 348 to determine materials, end effectors, tools, and supplies required for work at a particular worksite. The dispatch manager 350 is configured to use results of the support manager 352 (e.g., the materials, end effectors, tools, and supplies) and determine which of the lift devices 10 to dispatch for each worksite. The dispatch manager 350 is also configured to determine the paths for each of the lift devices 10 based on the map database 346.

The support manager 352 is configured to obtain the requested worksite support from the user device 304 and/or the scheduled jobs from the jobsite management system 306. The scheduled jobs can include various work tasks or work projects and associated locations in the jobsite 324 (e.g., various worksites 318). The requested worksite support can include a list of requested materials, end effectors, tools, and supplies needed to complete work at the particular worksite 318. If the support manager 352 receives the requested worksite support from the user device 304, the support manager 352 can query the inventory database 348 to determine if the requested materials, end effectors, tools, and supplies are available. The support manager 352 can assign inventory from the inventory database 348 and provide the assigned inventory to the dispatch manager 350.

If the support manager 352 receives the scheduled jobs from the jobsite management system 306, the support manager 352 can determine, based on the scheduled jobs, the required materials, end effectors, tools, and supplies for associated worksites 318. In some embodiments, the support manager 352 is configured to determine a type and scope of the scheduled job or work at the worksites 318 (e.g., carpentry, plumbing, installation of structural steel, electrical, etc.) and determine, based on the type and scope of the scheduled job or work, the required materials, end effectors, tools, and supplies. For example, installing electrical wire in a ceiling or installing lighting devices in a ceiling may require a lift device 10 having an end effector capable of lifting a worker or supplies to a required vertical height and the support manager 352 can select the end effector(s) based on the required vertical height. The support manager 352 can query the inventory database 348 and assign various of the materials, end effectors, tools, and supplies. In some embodiments, the inventory database 348 is updated in response to materials, end effectors, tools, and supplies being assigned to a particular worksite 318. Similarly, the inventory database 348 can be updated in response to delivery of materials, end effectors, tools, and supplies at the base location 308.

Once the support manager 352 has provided the required materials, end effectors, tools, and supplies for the worksites 318 to the dispatch manager 350, the dispatch manager 350 is configured to determine one or more lift devices 10 (e.g., AMRs) to which the materials, end effector(s), tools, and supplies are assigned. The dispatch manager 350 can use available inventory of the lift devices 10 as provided and tracked by the inventory database 348 to select and schedule deployment of the lift devices 10 to deliver the materials, end effector(s), tools, and supplies to each worksite 318 as needed by scheduled times (e.g., by arrival time of workers). In some embodiments, the dispatch manager 350 is also configured to determine the path 322 for each of the lift devices 10 to transport along in order to obtain the materials 310, end effector(s) 312, tools 314, and supplies 316, and to transport through the jobsite 324 to the assigned worksite 318. The dispatch manager 350 is configured to use the map database 346 of the jobsites 324, the worksites 318 in the jobsites 324, and the base location 308 to determine the paths 322 for the lift devices 10. In some embodiments, the dispatch manager 350 is also configured to use a current location of the lift devices 10 as reported by the lift devices 10 (e.g., via a GPS).

The dispatch manager 350 provides the assigned materials, end effector(s), tools, supplies, and path to each of the lift devices 10 in order to deliver the needed materials, end effectors, tools, and supplies to each worksite 318 to complete the scheduled jobs or the work for the requested support. The dispatch manager 350 can also provide a deployment time for each of the lift devices 10. Once the lift devices 10 are dispatched, the lift devices 10 transport along the path to collect the materials 310, end effector 312, tools 314, and supplies 316, and then transport to the assigned worksite 318.

The lift devices 10 can include a local controller 360 configured to communicate with the cloud computing system 302 via a telematics unit 366 (e.g., a cellular dongle, a transceiver, etc.). The local controller 360 can implement autonomous control of the lift device 10 in order to travel along the path assigned by the cloud computing system 302 to the worksite 318. The local controller 360 can use feedback from a camera 364 that obtains image data of the surroundings. In some embodiments, the controller 360 is configured to provide image data obtained by the camera 364 to the cloud computing system 302. In some embodiments, the cloud computing system 302 is configured to operate the lift device 10 to transport along the path. In some embodiments, the lift devices 10 include a global positioning system sensor 362 that is configured to transmit, to the cloud computing system 302, a current location. The cloud computing system 302 can track the location of the lift devices 10 based on the current location provided by the global positioning system sensor 362 of the lift device 10.

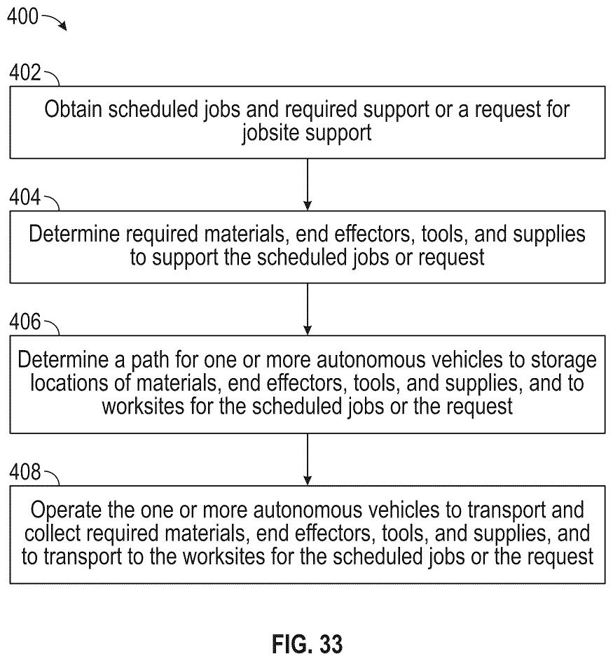

Referring to FIG. 33, a flow diagram of a method 400 for automatically dispatching AMRs (e.g., lift devices 10 or the chassis thereof) to prepare various worksites in a jobsite includes steps 402-408, according to some embodiments. The method 400 can be performed by the autonomous jobsite control system 300 or, more specifically, by the cloud computing system 302 and the AMRs 10.

The method 400 includes obtaining scheduled jobs and required support or a request for jobsite support (step 402), according to some embodiments. In some embodiments, step 402 includes obtaining a specific request from a user device that indicates required materials, tools, supplies, and end effectors. In some embodiments, step 402 includes obtaining, from a jobsite management system, a schedule of work to be completed at various locations of one or more jobsites.

The method 400 includes determining required materials, end effectors, tools, and supplies to support the scheduled jobs or request (step 404), according to some embodiments. In some embodiments, step 404 is performed by the cloud computing system 302. In some embodiments, step 404 is performed by the support manager 352. The support manager 352 can determine, based on the type and scope of the job, the required materials, end effectors, tools, and supplies. The support manager 352 can query an inventory database to identify available materials, end effectors, tools, and supplies that are available at the base location 308 (e.g., a staging area).

The method 400 includes determining a path for one or more autonomous vehicles to storage locations of materials, end effectors, tools, and supplies, and to worksites for the scheduled jobs or the request (step 406), according to some embodiments. In some embodiments, step 406 is performed by the dispatch manager 350. Step 406 can include using a map or database of imagery of various jobsites or construction sites with tagged work locations. In some embodiments, the AMRs (e.g., the lift devices 10) include cameras configured to obtain image data that is relayed to the cloud computing system 302. The cloud computing system 302 can use the image data to construct a digital representation or map of the jobsites/construction sites. The step 406 includes determining a route or path for each of the AMRs from their current location (e.g., a storage area) to various storage locations of the materials 310, the end effectors 312, the tools 314, and the supplies 316. The route or path can also include a path through various rooms of the jobsite 324 (e.g., where to enter the jobsite 324, how far to travel down a first hall, which room to enter, which wall of the room to stop for delivery, etc.). The step 406 can also include a time at which each of the AMRs should begin transporting along the path in order to reach the assigned worksite 318 by a specific time.

The method 400 includes operating the one or more autonomous vehicles to transport and collect required materials, end effectors, tools, and supplies, and to transport to the worksites for the scheduled jobs or the request (step 408), according to some embodiments. In some embodiments, step 408 includes providing the assigned path and materials, end effectors, tools, and supplies. The step 408 can include autonomously operating the AMRs 10 to transport using local control. For example, the path can be provided to the AMRs 10 and the AMRs 10 can use local controllers to transport along the path to the assigned worksite 318. In some embodiments, the step 408 can include automatically operating the implement interface 18 to couple the implement assembly 16 (e.g., the end effector 312) to the lift device 10.

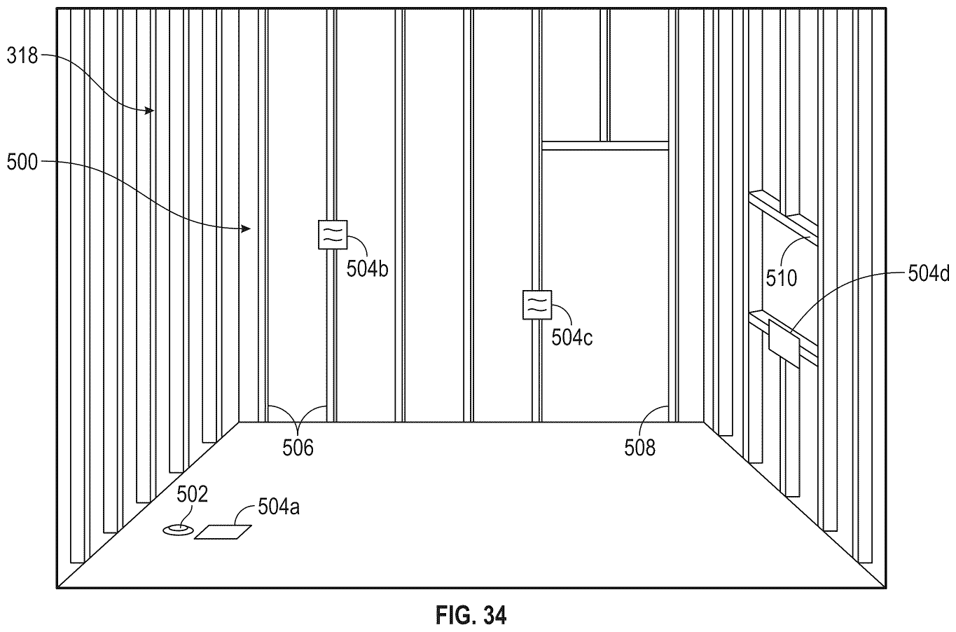

Referring to FIG. 34, a diagram 500 of one of the worksites 318 includes various visual identifiers 504. The visual identifiers 504 can be quick response codes, text, bar codes, images, icons, etc. The visual identifiers 504 are disposed at various locations throughout the worksite 318. The visual identifier 504 can be physically placed at various locations in the worksite 318. In some embodiments, the visual identifiers 504 are positioned proximate specific tasks or work to be completed. The visual identifiers 504 can be printed and positioned manually by a jobsite manager or foreman. In some embodiments, the visual identifiers 504 are automatically placed by one of the lift devices 10 (e.g., an AMR) at the worksite 318.

The visual identifiers 504 include information regarding the needed materials 310, the end effectors 312, the tools 314, and the supplies 316. The visual identifiers 504 are each positioned proximate a corresponding task to be completed. For example, FIG. 34 shows a first visual identifier 504a positioned proximate a plumbing hookup 502, a second visual identifier 504b positioned proximate studs 506 of a wall, a third visual identifier 504c positioned proximate a door frame 508, and a fourth visual identifier 504d positioned proximate a window frame 510. The first visual identifier 504a can include an indication of what supplies, materials, tools, end effectors, etc., are needed for a plumbing installation at the plumbing hookup 502 (e.g., a toilet installation, or other plumbing fixture installation). The second visual identifier 504b can include an indication of what supplies, materials, tools, end effectors, etc., are needed for rough electrical wiring through the studs 506 in the room. The third visual identifier 504c can include an indication of what supplies, materials, tools, end effectors, etc., are needed for a door installation at the door frame 508. The fourth visual identifier 504d can include an indication of what supplies, materials, tools, etc., are needed for a window installation at the window frame 510. In this way, the visual identifiers 504 can indicate required materials, supplies, etc., for the work to be completed at each location.

When work crews arrive to the jobsite 324, the work crews can use their smartphones (e.g., the user device 304) to scan the visual identifiers 504 of the jobs they will perform that day. In response to scanning the visual identifiers 504, the user device 304 can transmit a request to the cloud computing system 302 in order to dispatch one of the lift devices 10 to prepare and deliver the materials 310, end effectors 312, tools 314, and supplies 316 that are indicated by the visual identifiers 504. In this way, the visual identifiers 504 can enable the determination of what supplies, materials, effectors, and tools will be needed for work ahead of time so that when work crews arrive to begin the work, the cloud computing system 302 can dispatch delivery of one of the lift devices 10 equipped with required end effector 312, materials 310, tools 314, and supplies 316.

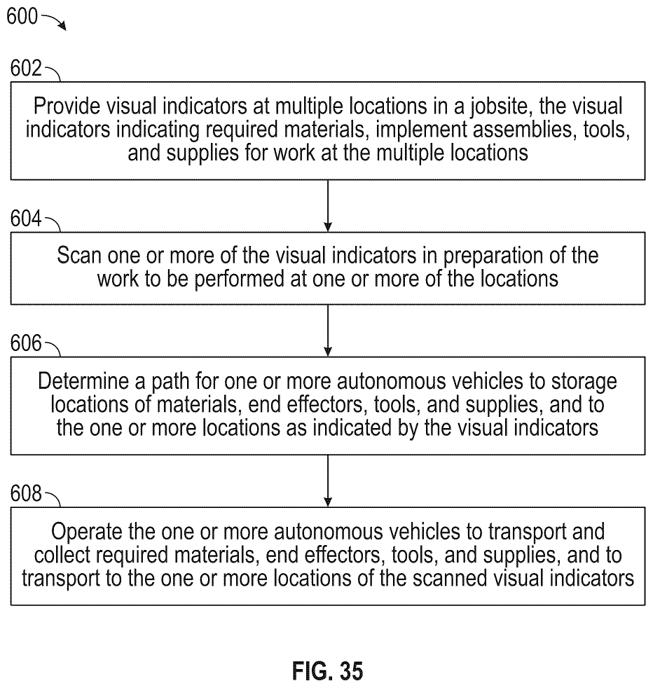

Referring to FIG. 35, a flow diagram of a method 600 for planning and preparing a worksite for work crews includes steps 602-608. The method 600 can be performed by the cloud computing system 302 and the user device 304. The method 600 facilitates allowing a worksite manager to determine what supplies, materials, etc., will be needed for individual work tasks and enabling the work crew to request the determined supplies, materials, etc., when arriving to perform the work tasks.

The method 600 includes providing visual indicators at multiple locations in a jobsite, the visual indicators indicating required materials, implement assemblies, tools, and supplies for work at the multiple locations (step 602), according to some embodiments. In some embodiments, step 602 is performed autonomously by one of the lift devices 10 or another AMR that is configured to print labels (e.g., the visual indicators) and attach them physically to the multiple locations in the worksite. In some embodiments, step 602 is performed by an administrator or manager using the user device 304 or a similar user device with a label printer. The visual indicators can include a quick response code, a bar code, textual information, etc., that includes or indicates the required materials, implement assemblies, tools, and supplies for specific work tasks. The visual indicators can also include an indication of a position in the jobsite or construction where the work task is to be performed and therefore where the required materials, implement assemblies, tools, and supplies are to be delivered.

The method 600 also includes scanning one or more of the visual indicators in preparation of the work to be performed at one or more of the locations (step 604), according to some embodiments. In some embodiments, step 604 is performed by an individual on a work crew when the work crew arrives to perform one or more of the work tasks. The step 604 can be performed by the individual using the user device 304 and a camera on the user device 304. For example, the individual can point the user device 304 at one or more of the visual indicators corresponding to the work tasks that the work crew will complete and scan the visual indicators. Scanning the visual indicators causes the user device 304 to send a notification to the cloud computing system 302 to notify the cloud computing system 302 to dispatch one of the lift devices 10 with the required materials, implement assemblies, tools, and supplies as indicated by the visual indicators. For example, the user device 304 can provide the information contained in the visual indicator to the cloud computing system 302 upon scanning the visual indicator.

The method 600 includes determining a path for one or more autonomous vehicles to storage location of materials, end effectors, tools, and supplies, and to the one or more of the locations (step 606), according to some embodiments. In some embodiments, step 606 is similar to the step 406 of the method 400 but performed based on the data of the visual identifiers 504. In this way, scanning the visual identifiers 504 can automatically provide a request for worksite support to the cloud computing system 302 with the details thereof pre-defined at the creation of the visual identifiers 504.

The method 600 includes operating the one or more of the autonomous vehicles to transport and collect required materials, end effectors, tools, and supplies, and to transport to the one or more locations of the scanned visual indicators (step 608), according to some embodiments. In some embodiments, step 608 is the same as or similar to step 408 of method 400 but in order to transport the AMRs (e.g., the lift devices 10) to the locations of the scanned visual indicators (e.g., the visual identifiers 504).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the vehicle support module 2000 as shown in the various exemplary embodiments is illustrative only. Additionally, any element disclosed in one embodiment may be incorporated or utilized with any other embodiment disclosed herein. For example, the vehicle support module 2000 of the exemplary embodiment shown in at least FIG. 5 may be incorporated in the vehicle support module 2000 of the exemplary embodiment shown in at least FIG. 6. Although only one example of an element from one embodiment that can be incorporated or utilized in another embodiment has been described above, it should be appreciated that other elements of the various embodiments may be incorporated or utilized with any of the other embodiments disclosed herein. CLAIMS:

1. A system comprising:
one or more processing circuits comprising one or more memory devices coupled to one or more processors, the one or more memory devices configured to store instructions thereon that, when executed by the one or more processors, cause the one or more processors to:
receive an input from a camera, the camera configured to facilitate surveying a work site;
receive an external input indicating a desired location of a work machine on the work site;
determine ground conditions of the work site based on at least the input from the camera, the ground conditions indicating at least one of a surface condition or an obstacle;
determine a vehicle route from a current location of the work machine to the desired location based on the ground conditions; and
generate a route map of the vehicle route defining the vehicle route and the ground conditions.

2. The system of claim 1, wherein the vehicle route is determined based on stability thresholds of the work machine relative to the ground conditions.

3. The system of claim 1, wherein the route map displays real time input from the camera that is modified to define the ground conditions.

4. The system of claim 1, wherein the camera is mounted to the work machine.

5. The system of claim 1, wherein determining the ground conditions comprises:
determining global positioning system coordinates of each of the ground conditions; and
modifying the route map to highlight the ground conditions based on the global positioning system coordinates.

6. The system of claim 1, wherein the instructions cause the one or more processors to:
determine a work machine load based at least in part on an input received from a sensor of the work machine, and
determine operating conditions of the work machine along the vehicle route based on at least the ground conditions and the work machine load.

7. The system of claim 6, wherein the operating conditions comprise at least one of a boom height relative to a grade of the vehicle route or a work machine speed.

8. The system of claim 1, further comprising a drone communicably coupled to the one or more processing circuits, wherein the drone comprises the camera.

9. The system of claim 8, wherein the drone is configured to selectively coupled to the work machine.

10. The system of claim 8, further comprising the work machine, wherein the drone is coupled to the work machine via a tether.

11. The system of claim 10, wherein the tether is configured to provide at least one of power or data to the drone.

12. The system of claim 8, wherein the drone is a first drone, the camera is a first camera, and the input is a first input, further comprising a second drone comprising a second camera, wherein the instructions cause one or more processors to determine the ground conditions of the work site based on at least the first input from the first camera and a second input from the second camera.

13. The system of claim 8, further comprising the work machine wherein the work machine comprises a drone bay configured to selectively secure the drone, and wherein the drone is configured to launch from the drone bay of the work machine to survey the work site and to land in the drone bay of the work machine.

14. The system of claim 8, wherein the camera is a downward facing camera.

15. The system of claim 1, further comprising the work machine and the camera, wherein the work machine comprises a boom assembly, and wherein the camera is coupled to the boom assembly.

16. A work machine comprising:
a chassis;
a prime mover coupled to the chassis;
an implement coupled to the chassis and driven by the prime mover;
a sensor array structured to provide information indicative of operating conditions of a work machine; and
a user interface including a display and one or more processing circuits comprising one or more memory devices coupled to one or more processors, the one or more memory devices configured to store instructions thereon that, when executed by the one or more processors, cause the one or more processors to:
receive an input from a camera, the camera configured to facilitate surveying a work site;
receive an external input indicating a desired location of the work machine on the work site;
determine ground conditions of the work site based on at least the input from the camera, the ground conditions indicating at least one of a surface condition or an obstacle;
determine a vehicle route from a current location of the work machine to the desired location based on the ground conditions, and
generate a route map of the vehicle route defining the vehicle route and the ground conditions.

17. The work machine of claim 16, further comprising:
a drone communicably coupled to the one or more processing circuits, the drone comprising the camera; and
a tether configured to couple the drone to the chassis.

18. The work machine of claim 17, wherein the drone comprises:
a motor; and
one or more rotors, wherein the motor is configured to drive the one or more rotors to propel the drone.

19. The work machine of claim 18, wherein the user interface is configured to provide a command to the drone, the command indicative of a control of at least one of the motor or the one or more rotors.

20. A work machine comprising:
a chassis;
a prime mover coupled to the chassis;
an implement coupled to the chassis and driven by the prime mover;
a sensor array structured to provide information indicative of operating conditions of a work machine;
at least one camera coupled to one of the chassis or a drone; and
a user interface including a display and one or more processing circuits comprising one or more memory devices coupled to one or more processors, the one or more memory devices configured to store instructions thereon that, when executed by the one or more processors, cause the one or more processors to:
receive an input from the at least one camera, the at least one camera configured to facilitate surveying a work site,
receive an external input indicating a desired location of the work machine on the work site,
receive a sensor input from the sensor array,
determine ground conditions of the work site based on at least one of the input from the at least one camera and the sensor input from the sensor array, the ground conditions indicating at least one of a surface condition or an obstacle,
determine a vehicle route from a current location of the work machine to the desired location based on the ground conditions, and
generate a route map of the vehicle route defining the vehicle route and the ground conditions.
